(19) United States
(12) Patent Application Publication
(10) Pub. No.: US 2020/0231873 A1
(43) Pub. Date: Jul. 23, 2020

(54) LIQUID CRYSTAL DISPLAY ELEMENT AND LIQUID CRYSTAL COMPOSITION

(71) Applicants: JNC CORPORATION, Tokyo (JP); JNC PETROCHEMICAL CORPORATION, Tokyo (JP)

(72) Inventors: YOSHIHARU HIRAI, Chiba (JP); Kazuhiro OGITA, Chiba (JP); Fumitaka KONDO, Chiba (JP); Tomohiro YANO, Chiba (JP); HIROSHI ENDOU, Chiba (JP)

(73) Assignees: JNC CORPORATION, Tokyo (JP); JNC PETROCHEMICAL CORPORATION, Tokyo (JP)

(21) Appl. No.: 16/486,834

(22) PCT Filed: Feb. 16, 2018
(86) PCT No.: PCT/JP2018/005407

§ 371 Date: Aug. 18, 2019

(30) Foreign Application Priority Data
Feb. 24, 2017 (JP) 2017-032803

(51) Int. Cl. C09K 19/34; C09K 19/56; C09K 19/54; C09K 19/30; C09K 19/02; G02F 1/1339; G02F 1/1337

(52) U.S. Cl. CPC C09K 19/3402; C09K 19/56; C09K 19/542; C09K 19/3066; C09K 19/3068; C09K 2019/0466; C09K 19/0208; C09K 19/0216; G02F 1/1339; G02F 1/133788; C09K 2019/548; C09K 19/3001

(57) ABSTRACT

The purpose of the invention is to control, by using a colorless alignment control monomer, the alignment of liquid crystal molecules of a liquid crystal display element that does not include an alignment film, and to provide a liquid crystal composition with which the colorless alignment control monomer exhibits excellent compatibility. The invention uses a liquid crystal display element that comprises an alignment control monomer including an aromatic ester that undergoes photo-Fries rearrangement by light irradiation, and that employs a liquid crystal composition having a positive dielectric anisotropy. The invention also uses the liquid crystal composition.

### TECHNICAL FIELD

The present invention relates to a liquid crystal display element containing a liquid crystal composition having positive dielectric anisotropy and a liquid crystal composition, and particularly, to a liquid crystal display element using a liquid crystal composition which contains an alignment control monomer including an aromatic ester that causes photo-Fries rearrangement due to light exposure and in which the alignment of liquid crystal molecules can be achieved by the action of the compound without using an alignment film of such as a polyimide.

### BACKGROUND ART

Based on the operation mode of liquid crystal molecules, liquid crystal display elements are classified into a phase change (PC) mode, a twisted nematic (TN) mode, a super twisted nematic (STN) mode, an electrically controlled birefringence (ECB) mode, an optically compensated bend (OCB) mode, an in-plane switching (IPS) mode, a vertical alignment (VA) mode, a fringe field switching (FFS) mode, a field-induced photo-reactive alignment (FPA) mode and the like. Elements are classified into a passive matrix (PM) method and an active matrix (AM) method based on the drive method. PM methods are classified into a static method and a multiplex method, and AM methods are classified into a thin film transistor (TFT) method and a metal insulator metal (MIM) method. TFTs are classified into an amorphous silicon TFT and a polycrystal silicon TFT. The latter is classified into a high temperature type and a low temperature type according to a production process. Elements are classified into a reflective type using natural light, a transmissive type using backlight, and a semi-transmissive type using both natural light and backlight based on the light source.

The liquid crystal display element contains a liquid crystal composition having a nematic phase. The composition has appropriate characteristics. It is possible to obtain an AM element having favorable characteristics by improving characteristics of the composition. The association between these two characteristics is summarized in the following Table 1. Characteristics of the composition will be further described based on commercially available AM elements. The temperature range of the nematic phase is related to a temperature range in which an element can be used. A preferable upper limit temperature of the nematic phase is about 70° C. or higher and a preferable lower limit temperature of the nematic phase is about −10° C. or lower. The viscosity of the composition is related to a response time of the element. A short response time is preferable in order to display a video on the element. A response time shorter than 1 millisecond is desirable. Therefore, low viscosity in the composition is preferable. Low viscosity at a low temperature is more preferable. The elastic constant of the composition is related to the contrast of the element. In order to increase the contrast in the element, a large elastic constant in the composition is more preferable.

TABLE 1
Characteristics of compositions and AM elements

| Number | Characteristics of composition | Characteristics of AM element |
|---|---|---|
| 1 | Wide temperature range of a | Wide temperature range in which |
| | nematic phase | the element can be used |
| 2 | Low viscosity | Short response time |
| 3 | Appropriate optical anisotropy | Large contrast ratio |
| 4 | Large positive or negative | Low threshold voltage, low |
| | dielectric anisotropy | power consumption, and large |
| | | contrast ratio |
| 5 | Large specific resistance | High voltage holding ratio |
| | | and large contrast ratio |
| 6 | Stable with respect to | Long lifetime |
| | UV light and heat | |
| 7 | Large elastic constant | Large contrast ratio and short |
| | | response time |

The optical anisotropy of the composition is related to a contrast ratio of the element. Depending on the mode of the element, large optical anisotropy or small optical anisotropy, that is, appropriate optical anisotropy, is necessary. A product (Δn×d) of the optical anisotropy (Δn) of the composition and the cell gap (d) of the element is designed so that the contrast ratio becomes a maximum. An appropriate product value depends on the type of the operation mode. This value is in a range of about 0.30 Lm to about 0.40 Lm in a VA mode element, and in a range of about 0.20 Lm to about 0.30 Lm in an IPS mode or FFS mode element. In such a case, a composition having large optical anisotropy is preferable for an element with a small cell gap. Large dielectric anisotropy in the composition contributes to a low threshold voltage, small power consumption, and a large contrast ratio in elements. Therefore, large dielectric anisotropy is preferable. A high specific resistance in the composition contributes to a high voltage holding ratio and a large contrast ratio in elements. Therefore, a composition having a high specific resistance in an initial stage is preferable. A composition having a high specific resistance after use for a long time is preferable. The stability of the composition with respect to UV light and heat is related to the lifetime of the element. When the stability is high, the lifetime of the element is prolonged. Such characteristics are preferable for an AM element used for a liquid crystal monitor, a liquid crystal television, and the like.

In an AM element having a TN mode, a composition having positive dielectric anisotropy is used. In an AM element having a VA mode, a composition having negative dielectric anisotropy is used. In an AM element having an IPS mode or an FFS mode, a composition having positive or negative dielectric anisotropy is used. In a polymer sustained alignment (PSA) type AM element, a composition having positive or negative dielectric anisotropy is used. In a polymer sustained alignment (PSA) type liquid crystal display element, a liquid crystal composition containing a polymer is used. First, a composition in which a small amount of a polymerizable compound is added is injected into an element. Next, while a voltage is applied between substrates of the element, UV light is exposed to the composition. The polymerizable compound is polymerized to form a polymer network structure in the composition. In the composition, since the alignment of liquid crystal molecules can be controlled by the polymer, a response time of the element is shortened and image burning is ameliorated. Such effects of the polymer can be expected for elements having modes such as TN, ECB, OCB, IPS, VA, FFS, and FPA.

A method in which the alignment of liquid crystals is controlled using a low-molecular-weight compound having a cinnamate group, a polyvinyl cinnamate, a low-molecular-weight compound having a chalcone structure, a low-molecular-weight compound having an azobenzene structure, or a dendrimer in place of an alignment film of such as a polyimide has been reported (Patent Literature 1). In the method of Patent Literature 1, first, the low-molecular-weight compound or polymer as an additive is dissolved in a liquid crystal composition. Next, the additive is phase-separated to form a thin film made of the low-molecular-weight compound or polymer on a substrate. Finally, linearly polarized light is exposed to the substrate at a temperature higher than an upper limit temperature of the liquid crystal composition. When the low-molecular-weight compound or polymer is dimerized or isomerized with the linearly polarized light, the molecules are arranged in a certain direction. In this method, when the type of the low-molecular-weight compound or polymer is selected, it is possible to produce an element in a horizontal alignment mode such as IPS or FFS and an element in a vertical alignment mode such as VA. In this method, it is important that the low-molecular-weight compound or polymer be easily dissolved at a temperature higher than the upper limit temperature of the liquid crystal composition, and when the temperature is returned to room temperature, the compound be easily phase-separated from the liquid crystal composition. However, it is difficult to secure compatibility between the low-molecular-weight compound or polymer and the liquid crystal composition.

In the methods of Patent Literature 2 and 3, a dendrimer having azobenzene as a partial structure is dissolved as an additive in a liquid crystal composition. Next, the compound is phase-separated so that a thin film of the compound is formed on a substrate. In this case, the liquid crystal composition is aligned perpendicular to the substrate. Next, linearly polarized light is exposed without heating the substrate. When the dendrimer is dimerized or isomerized with the linearly polarized light, the molecules are arranged in a direction horizontal to the substrate. It is possible to produce an element in a horizontal alignment mode such as IPS or FFS. In this method, it is necessary to appropriately combine the dendrimer and the liquid crystal composition so that the dendrimer is easily dissolved and phase-separated. When a dendrimer having azobenzene as a partial structure is used, there is a problem that there is coloration derived from azobenzene. In addition, in Patent Literature 4, a combination of a liquid crystal compound having positive dielectric anisotropy and a polymerizable compound is disclosed. Here, it is disclosed that, when a polymerizable compound contained in a liquid crystal medium is polymerized while applying a voltage, a pretilt angle is provided and a response time and electro-optical characteristics of a liquid crystal cell are improved. In this method, it is difficult to obtain horizontal alignment of a liquid crystal compound with polarized light exposure even if the disclosed polymerizable compound is used. In addition, there is no suggestion or description that a specific polymerizable compound can control horizontal alignment of the liquid crystal compound with polarized light exposure.

### CITATION LIST

### Patent Literature

### [Patent Literature 1]

PCT International Publication No. WO 2015/146369

### [Patent Literature 2]

Japanese Unexamined Patent Application Publication No. 2015-64465

### [Patent Literature 3]

Japanese Unexamined Patent Application Publication No. 2015-125151

### [Patent Literature 4]

PCT International Publication No. WO 2009/156118

### SUMMARY OF INVENTION

### Technical Subject

An object to be achieved by the present invention is to provide a liquid crystal composition in which the alignment of liquid crystal molecules of a liquid crystal display element having no alignment film is controlled using a colorless alignment control monomer and the colorless alignment control monomer exhibits favorable compatibility.

### Solution to Problem

In the present invention, a liquid crystal display element using a liquid crystal composition which contains an alignment control monomer including an aromatic ester that causes photo-Fries rearrangement due to light exposure and has positive dielectric anisotropy, and a liquid crystal composition are used.

### Advantageous Effects of Invention

When the liquid crystal composition containing an alignment control monomer of the present invention is used, since a process of forming an alignment film is unnecessary, it is possible to obtain a liquid crystal display element with reduced production costs.

In addition, a liquid crystal composition having favorable compatibility with an alignment control monomer and having positive dielectric anisotropy is obtained.

### DESCRIPTION OF EMBODIMENTS

The terms used herein are used as follows. The terms “liquid crystal composition” and “liquid crystal display element” may be abbreviated as a “composition” and an “element.” A “liquid crystal display element” generally refers to a liquid crystal display panel or a liquid crystal display module. A “liquid crystalline compound” generally refers to a compound having a liquid crystal phase such as a nematic phase or a smectic phase and a compound which does not have a liquid crystal phase and is added to a composition in order to adjust characteristics such as a nematic phase temperature range, viscosity, and dielectric anisotropy. For example, this compound has a six-membered ring such as 1,4-cyclohexylene or 1,4-phenylene, and has a rod-like molecular structure. A “polymerizable compound” is a compound that is added to form a polymer in the composition. A liquid crystalline compound having an alkenyl group is not polymerizable in that sense.

The liquid crystal composition is prepared by mixing a plurality of liquid crystalline compounds. Additives such as an optically active compound, an antioxidant, a UV absorber, a dye, an antifoaming agent, a polymerizable compound, a polymerization initiator, a polymerization inhibitor, and a polar compound are added to the composition as necessary. Also, when additives are added, a proportion of a liquid crystalline compound is expressed as a weight percentage (weight %) based on the weight of a liquid crystal composition containing no additives. A proportion of additives is expressed as a weight percentage (parts by weight) based on the weight of a liquid crystal composition containing no additives. That is, proportions of a liquid crystalline compound and additives are calculated based on the total weight of the liquid crystalline compound. Parts per million (ppm) by weight may be used. Proportions of a polymerization initiator and a polymerization inhibitor are exceptionally expressed based on the weight of the polymerizable compound.

An “upper limit temperature of a nematic phase” may be abbreviated as an “upper limit temperature.” A “lower limit temperature of a nematic phase” may be abbreviated as a “lower limit temperature.” The expression “a specific resistance is high” means that a composition has a high specific resistance in an initial stage and after being used for a long time, it has a high specific resistance. The expression “a voltage holding ratio is high” means that an element has a high voltage holding ratio not only at room temperature in an initial stage but also a temperature close to the upper limit temperature, and after the element is used for a long time, it has a high voltage holding ratio not only at room temperature but also a temperature close to the upper limit temperature. An aging test may be used to examine characteristics of compositions and elements. The expression “increase dielectric anisotropy” means that a value increases positively when a composition has positive dielectric anisotropy and means that a value increases negatively when a composition has negative dielectric anisotropy.

The compound represented by Formula (1) may be abbreviated as Compound (1). At least one compound selected from the group of compounds represented by Formula (1) may be abbreviated as Compound (1). “Compound (1)” refers to one compound represented by Formula (1), a mixture of two compounds, or a mixture of three or more compounds. These rules apply to compounds represented by other formulae. The expression “at least one ‘A’” means that the number of ‘A’ is arbitrary. The expression “at least one ‘A’ is optionally substituted with ‘B’” means that, when the number of ‘A’ is 1, the position on ‘A’ is arbitrary, and when the number of ‘A’ is two or more, the positions thereon can be selected without limitation. These rules also apply to the expression “at least one ‘A’ is substituted with ‘B’”.

The expression “at least one —CH₂— is optionally substituted with —O—” is used in this specification. In this case, —CH₂—CH₂—CH₂— may be converted into —O—CH₂—O— when non-adjacent —CH₂— are substituted with —O—. However, adjacent —CH₂— may not be converted to —O—. This is because, in this substitution, —O—O—CH₂-(peroxide) is formed. That is, the expression means both “one —CH₂— is optionally substituted with —O—” and “at least two non-adjacent —CH₂— are optionally substituted with —O—.” These rules apply not only to substitution with —O— but also substitution with a divalent group such as —CH═CH— and —COO—.

In chemical formulae of component compounds, the symbol of a terminal group R¹ is used for a plurality of compounds. In these compounds, two groups represented by any two R¹ may be the same as or different from each other. For example, there may be a case in which R¹ of Compound (1-1) is an ethyl group and R¹ of Compound (1-2) is an ethyl group. There may also be a case in which R¹ of Compound (1-1) is an ethyl group and R¹ of Compound (1-2) is a propyl group. These rules also apply to symbols of other terminal groups. In Formula (1), when the suffix ‘a’ is 2, there are two rings A. In the compound, two rings represented by two rings A may be the same as or different from each other. These rules also apply to any two rings A when the suffix ‘a’ is larger than 2. These rules also apply to symbols such as Z¹ and the ring D.

Symbols such as A, B, C, and D surrounded by a hexagon correspond to rings such as a ring A, a ring B, a ring C, and a ring D, and indicate a ring such as a six-membered ring or a condensed ring. In Formula (A-1) to Formula (A-3), an oblique line crossing one side of the hexagon indicates that any hydrogen atom on the ring is optionally substituted with a group such as L¹⁰. A suffix such as ‘n¹¹’ indicates the number of groups substituted. When the suffix ‘n¹¹’ is 0 (zero), there is no such substitution. When the suffix ‘n¹¹’ is 2 or more, there are a plurality of L¹⁰ on the ring. The plurality of groups represented by L¹⁰ may be the same as or different from each other.

2-Fluoro-1,4-phenylene refers to the following two divalent groups. In the chemical formulae, fluorine may be leftward (L) or rightward (R). These rules also apply to an asymmetric divalent group that is formed by removing two hydrogen atoms from a ring such as tetrahydropyran-2,5-diyl. These rules also apply to a divalent linking group such as a carbonyloxy (—COO— or —OCO—) group.

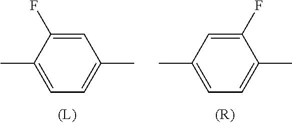

An alkyl group of the liquid crystalline compound is linear or branched, and does not contain a cyclic alkyl group. A linear alkyl group is preferable to a branched alkyl group. This similarly applies to terminal groups such as an alkoxy group and an alkenyl group. Regarding the configuration of 1,4-cyclohexylene, the trans type is preferable to the cis type in order to increase the upper limit temperature.

The present invention includes the following items.

[1] A liquid crystal display element in which a liquid crystal layer is interposed between a pair of substrates that are arranged to face each other and adhered using a sealing agent,

wherein an alignment control layer for controlling the alignment of liquid crystal molecules is provided between the pair of substrates and the liquid crystal layer,

wherein the liquid crystal layer is composed of a liquid crystal composition having positive dielectric anisotropy,

wherein the liquid crystal composition contains, as a first additive, at least one alignment control monomer represented by Formula (A) including an aromatic ester that causes photo-Fries rearrangement due to light exposure, and a liquid crystalline compound, and

wherein the alignment control layer is composed of a polymer that is formed by polymerizing a compound represented by Formula (A) as an alignment control monomer:

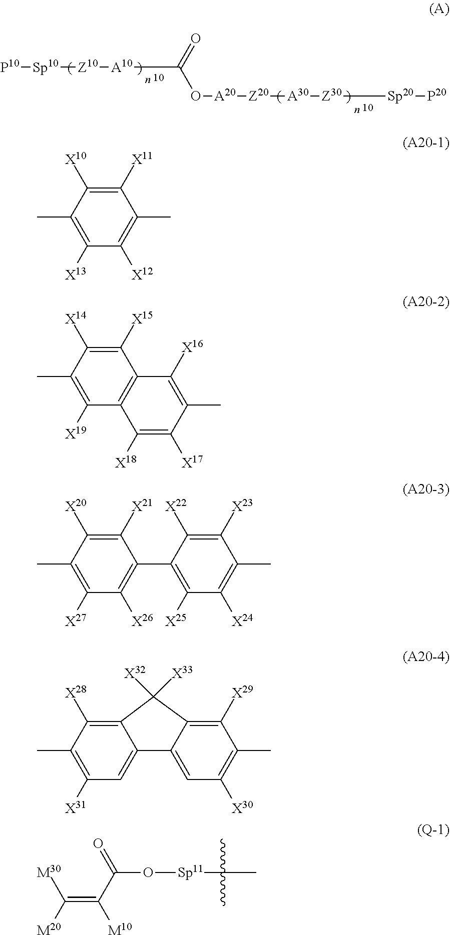

### in Formula (A),

P¹⁰ and P²⁰ independently represent a polymerizable group;

Sp¹⁰ and Sp²⁰ independently represent a single bond or an alkylene group having 1 to 12 carbon atoms, and at least one hydrogen atom in the alkylene group is optionally substituted with a fluorine atom or a hydroxy group, at least one —CH₂— is optionally substituted with —O—, —COO—, —OCO— or Formula (Q-1), and at least one —CH₂—CH₂— is optionally substituted with —CH═CH— or —C≡C—;

in Formula (Q-1), M¹⁰, M²⁰, and M³⁰ independently represent a hydrogen atom, a fluorine atom, an alkyl group having 1 to 5 carbon atoms, or an alkyl group having 1 to 5 carbon atoms in which at least one hydrogen atom is substituted with a fluorine atom or a chlorine atom; Sp¹¹ is a single bond or an alkylene group having 1 to 12 carbon atoms, at least one hydrogen atom in the alkylene group is optionally substituted with a fluorine atom or a hydroxy group, at least one —CH₂— is optionally substituted with —O—, —COO—, or —OCO—, and at least one —CH₂—CH₂— is optionally substituted with —CH═CH— or —C≡C—;

Z¹⁰, Z²⁰ and Z³⁰ independently represent a single bond, —COO—, —OCO—, —OCOO—, —OCO—CH₂CH₂—, —CH₂CH₂—COO—, —CH₂O—, —OCH₂—, —CF₂O—, —OCF₂—, —C≡C—, —CONH—, —NHCO—, —(CH₂)₄—, —CH₂CH₂— or —CF₂CF₂—;

A¹⁰ and A³⁰ independently represent 1,4-phenylene, 1,4-cyclohexylene, pyridine-2,5-diyl, pyrimidine-2,5-diyl, naphthalene-2,6-diyl, naphthalene-1,5-diyl, tetrahydronaphthalene-2,6-diyl, fluorene-2,7-diyl, biphenylene-4,4′-diyl or 1,3-dioxane-2,5-diyl, and in 1,4-phenylene, any hydrogen atom is optionally substituted with a fluorine atom, a chlorine atom, a cyano group, a hydroxy group, a formyl group, an acetoxy group, an acetyl group, a trifluoroacetyl group, a difluoromethyl group, a trifluoromethyl group, an alkyl group having 1 to 5 carbon atoms, an alkoxy having 1 to 5 carbon atoms, or P¹⁰—Sp¹⁰—Z¹⁰—, and in fluorene-2,7-diyl, any hydrogen atom is optionally substituted with a fluorine atom, or an alkyl group having 1 to 5 carbon atoms, and

in biphenylene-4,4′-diyl, any hydrogen atom is optionally substituted with a fluorine atom, a difluoromethyl group, a trifluoromethyl group, an alkyl group having 1 to 5 carbon atoms, or an alkoxy having 1 to 5 carbon atoms;

A²⁰ represents 1,4-phenylene represented by Formula (A20-1), pyridine-2,5-diyl, or pyrimidine-2,5-diyl, naphthalene-2,6-diyl represented by Formula (A20-2), or naphthalene-1,5-diyl, biphenylene-4,4′-diyl represented by Formula (A20-3), or fluorene-2,7-diyl represented by Formula (A20-4),

in 1,4-phenylene represented by Formula (A20-1), X¹⁰, X¹¹, X¹² and X¹³ each are independently optionally substituted with a hydrogen atom, a fluorine atom, a chlorine atom, a cyano group, a hydroxy group, a formyl group, an acetoxy group, an acetyl group, a trifluoroacetyl group, a difluoromethyl group, a trifluoromethyl group, an alkyl group having 1 to 5 carbon atoms, or an alkoxy having 1 to 5 carbon atoms, and at least one of X¹⁰ and X¹¹ is a hydrogen atom,

in naphthalene-2,6-diyl represented by Formula (A20-2), X¹⁴, X¹⁵, X¹⁶, X¹⁷, X¹⁸ and X¹⁹ are each independently optionally substituted with a hydrogen atom, a fluorine atom, an alkyl group having 1 to 5 carbon atoms, or an alkoxy having 1 to 5 carbon atoms, and at least one of X¹⁴ and X¹⁹ is a hydrogen atom,

in biphenylene-4,4′-diyl represented by Formula (A20-3), X²⁰, X²¹, X²², X²³, X²⁴, X²⁵, X²⁶ and X²⁷ each are independently optionally substituted with a hydrogen atom, a fluorine atom, a difluoromethyl group, a trifluoromethyl group, an alkyl group having 1 to 5 carbon atoms, or an alkoxy having 1 to 5 carbon atoms, and at least one of X²⁰ and X²⁷ is a hydrogen atom, in fluorene-2,7-diyl represented by Formula (A20-4), X²⁸, X²⁹, X³⁰, X³¹, X³² and X³³ each are independently optionally substituted with a hydrogen atom, a fluorine atom, or an alkyl group having 1 to 5 carbon atoms, and at least one of X²⁸ and X³¹ is a hydrogen atom; and

n¹⁰ is independently an integer of 0 to 3.

[2] The liquid crystal display element according to [1],

wherein, in Formula (A),

P¹⁰ and P²⁰ independently represent an acryloyloxy group, a methacryloyloxy group, an α-fluoro acrylate group, a trifluoromethyl acrylate group, a vinyl group, a vinyloxy group, or an epoxy group;

Sp¹⁰ and Sp²⁰ independently represent a single bond or an alkylene group having 1 to 12 carbon atoms, at least one hydrogen atom in the alkylene group is optionally substituted with a fluorine atom or a hydroxy group, at least one —CH₂— is optionally substituted with —O—, —COO—, or —OCO—, and at least one —CH₂—CH₂— is optionally substituted with —CH═CH— or —C≡C;

Z¹⁰, Z²⁰, and Z³⁰ independently represent a single bond, —COO—, —OCO—, —OCOO—, —OCO—CH₂CH₂—, —CH₂CH₂—COO—, —CH₂O—, —OCH₂—, —CF₂O—, —OCF₂—, —C≡C—, —CONH—, —NHCO—, —(CH₂)₄—, —CH₂CH₂—, or —CF₂CF₂—;

A¹⁰ and A³⁰ independently represent 1,4-phenylene, 1,4-cyclohexylene, naphthalene-2,6-diyl, naphthalene-1,5-diyl, fluorene-2,7-diyl, or biphenylene-4,4′-diyl, and in 1,4-phenylene, any hydrogen atom is optionally substituted with a fluorine atom, a cyano group, a hydroxy group, an acetoxy group, an acetyl group, a trifluoroacetyl group, a difluoromethyl group, a trifluoromethyl group, an alkyl group having 1 to 5 carbon atoms, an alkoxy having 1 to 5 carbon atoms, or P¹⁰—Sp¹⁰—Z¹⁰—, and in fluorene-2,7-diyl, any hydrogen atom is optionally substituted with a fluorine atom or an alkyl group having 1 to 5 carbon atoms, and in biphenylene-4,4′-diyl, any hydrogen atom is optionally substituted with a fluorine atom, a difluoromethyl group, a trifluoromethyl group, an alkyl group having 1 to 5 carbon atoms, or an alkoxy having 1 to 5 carbon atoms;

A²⁰ represents 1,4-phenylene represented by Formula (A20-1), naphthalene-2,6-diyl represented by Formula (A20-2), biphenylene-4,4′-diyl represented by Formula (A20-3) or fluorene-2,7-diyl represented by Formula (A20-4),

in 1,4-phenylene represented by Formula (A20-1), X¹⁰, X¹¹, X¹² and X¹³ each are independently optionally substituted with a hydrogen atom, a fluorine atom, a chlorine atom, a cyano group, a hydroxy group, a formyl group, an acetoxy group, an acetyl group, a trifluoroacetyl group, a difluoromethyl group, a trifluoromethyl group, an alkyl group having 1 to 5 carbon atoms, or an alkoxy having 1 to 5 carbon atoms, and at least one of X¹⁰ and X¹¹ is a hydrogen atom,

in naphthalene-2,6-diyl represented by Formula (A20-2), X¹⁴, X¹⁵, X¹⁶, X¹⁷, X¹⁸ and X¹⁹ are each independently optionally substituted with a hydrogen atom, a fluorine atom, an alkyl group having 1 to 5 carbon atoms, or an alkoxy having 1 to 5 carbon atoms, and at least one of X¹⁴ and X¹⁹ is a hydrogen atom,

in biphenylene-4,4′-diyl represented by Formula (A20-3), X²⁰, X²¹, X²², X²³, X²⁴, X²⁵, X²⁶ and X²⁷ each are independently optionally substituted with a hydrogen atom, a fluorine atom, a difluoromethyl group, a trifluoromethyl group, an alkyl group having 1 to 5 carbon atoms, or an alkoxy having 1 to 5 carbon atoms, and at least one of X²⁰ and X²⁷ is a hydrogen atom,

in fluorene-2,7-diyl represented by Formula (A20-4), X²⁸, X²⁹, X³⁰, X³¹, X³² and X³³ each are independently optionally substituted with a hydrogen atom, a fluorine atom, or an alkyl group having 1 to 5 carbon atoms, and at least one of X²⁸ and X³¹ is a hydrogen atom; and

n¹⁰ is independently an integer of 0 to 3.

[3] The liquid crystal display element according to [1] or [2],

wherein a compound represented by Formula (A-1) to Formula (A-3) is used as the alignment control monomer:

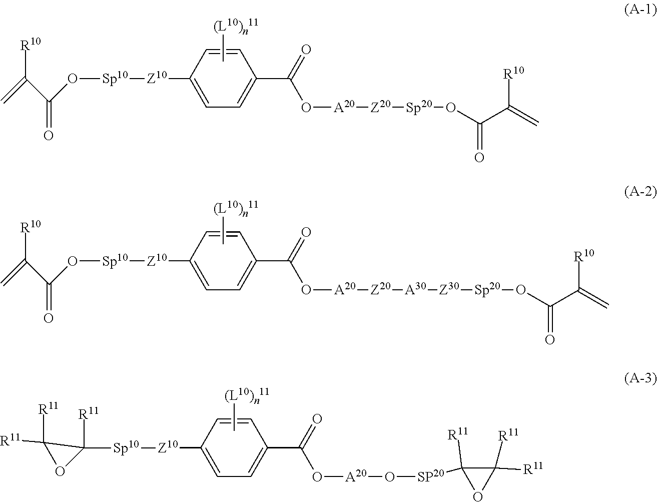

in Formula (A-1) to Formula (A-3),

R¹⁰ independently represent a hydrogen atom, a fluorine atom, a methyl group or a trifluoromethyl group;

R¹¹ independently represent a hydrogen atom or a methyl group;

Sp¹⁰ and Sp²⁰ independently represent a single bond or an alkylene group having 1 to 12 carbon atoms, at least one hydrogen atom in the alkylene group is optionally substituted with a fluorine atom or a hydroxy group, at least one —CH₂— is optionally substituted with —O—, —COO—, or —OCO—, and at least one —CH₂—CH₂— is optionally substituted with —CH═CH— or —C≡C;

Z¹⁰, Z²⁰, and Z³⁰ independently represent a single bond, —COO—, —OCO—, —OCOO—, —OCO—CH₂CH₂—, —CH₂CH₂—COO—, —CH₂O—, —OCH₂—, —CF₂O—, —OCF₂—, —C≡C—, —CONH—, —NHCO—, —(CH₂)₄—, —CH₂CH₂—, or —CF₂CF₂—;

A²⁰ independently represent 1,4-phenylene represented by Formula (A20-1), biphenylene-4,4′-diyl represented by Formula (A20-3), or fluorene-2,7-diyl represented by Formula (A20-4),

in 1,4-phenylene represented by Formula (A20-1), X¹⁰, X¹¹, X¹² and X¹³ each are independently optionally substituted with a hydrogen atom, a fluorine atom, a hydroxy group, a difluoromethyl group, a trifluoromethyl group, an alkyl group having 1 to 5 carbon atoms, or an alkoxy having 1 to 5 carbon atoms, and at least one of X¹⁰ and X¹¹ is a hydrogen atom,

in biphenylene-4,4′-diyl represented by Formula (A20-3), X²⁰, X²¹, X²², X²³, X²⁴, X²⁵, X²⁶ and X²⁷ each are independently optionally substituted with a hydrogen atom, a fluorine atom, a difluoromethyl group, a trifluoromethyl group, an alkyl group having 1 to 5 carbon atoms, or an alkoxy having 1 to 5 carbon atoms, and at least one of X²⁰ and X²⁷ is a hydrogen atom,

in fluorene-2,7-diyl represented by Formula (A20-4), X²⁸, X²⁹, X³⁰, X³¹, X³² and X³³ each are independently optionally substituted with a hydrogen atom, a fluorine atom, or an alkyl group having 1 to 5 carbon atoms, and at least one of X²⁸ and X³¹ is a hydrogen atom;

A³⁰ independently represent 1,4-phenylene, naphthalene-2,6-diyl, naphthalene-1,5-diyl, fluorene-2,7-diyl, or biphenylene-4,4′-diyl, and in 1,4-phenylene, any hydrogen atom is optionally substituted with a fluorine atom, a hydroxy group, a difluoromethyl group, a trifluoromethyl group, an alkyl group having 1 to 5 carbon atoms, or an alkoxy having 1 to 5 carbon atoms, and in fluorene-2,7-diyl, any hydrogen atom is optionally substituted with a fluorine atom or an alkyl group having 1 to 5 carbon atoms, and in biphenylene-4,4′-diyl, any hydrogen atom is optionally substituted with a fluorine atom, a difluoromethyl group, a trifluoromethyl group, an alkyl group having 1 to 5 carbon atoms, or an alkoxy having 1 to 5 carbon atoms;

L¹⁰ independently represent a hydrogen atom, a fluorine atom, a difluoromethyl group, a trifluoromethyl group, an alkyl group having 1 to 5 carbon atoms, an alkoxy having 1 to 5 carbon atoms or P¹⁰—Sp¹⁰—Z¹⁰—; and

n¹¹ independently represent an integer of 0 to 4.

[4] The liquid crystal display element according to any one of [1] to [3],

wherein a proportion of the alignment control monomer is in a range of 0.1 parts by weight to 10 parts by weight when a total amount of the liquid crystalline compound is 100 parts by weight.

[5] The liquid crystal display element according to any one of [1] to [4],

wherein at least one liquid crystalline compound selected from the group of compounds represented by Formula (1) is contained as a first component:

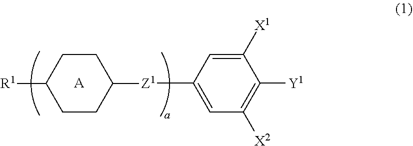

in Formula (1), R¹ represents an alkyl group having 1 to 12 carbon atoms, an alkoxy group having 1 to 12 carbon atoms, or an alkenyl group having 2 to 12 carbon atoms; the ring A represents 1,4-cyclohexylene, 1,4-phenylene, 2-fluoro-1,4-phenylene, 2,3-difluoro-1,4-phenylene, 2,6-difluoro-1,4-phenylene, pyrimidine-2,5-diyl, 1,3-dioxane-2,5-diyl, or tetrahydropyran-2,5-diyl; Z¹ represents a single bond, an ethylene group, a carbonyloxy group, —CH═CF—, —CF═CF—, a difluoromethyleneoxy group, —CH═CF—CF₂O— or —CF═CF—CF₂O—; X¹ and X² independently represent a hydrogen atom or a fluorine atom; Y¹ represents a fluorine atom, a chlorine atom, an alkyl group having 1 to 12 carbon atoms in which at least one hydrogen atom is substituted with a fluorine atom or a chlorine atom, an alkoxy group having 1 to 12 carbon atoms in which at least one hydrogen atom is substituted with a fluorine atom or a chlorine atom, or an alkenyloxy group having 2 to 12 carbon atoms in which at least one hydrogen atom is substituted with a fluorine atom or a chlorine atom; and a is 1, 2, 3, or 4.

[6] The liquid crystal display element according to any one of [1] to [5],

wherein at least one compound selected from the group of compounds represented by Formula (1-1) to Formula (1-39) is contained as a first component:

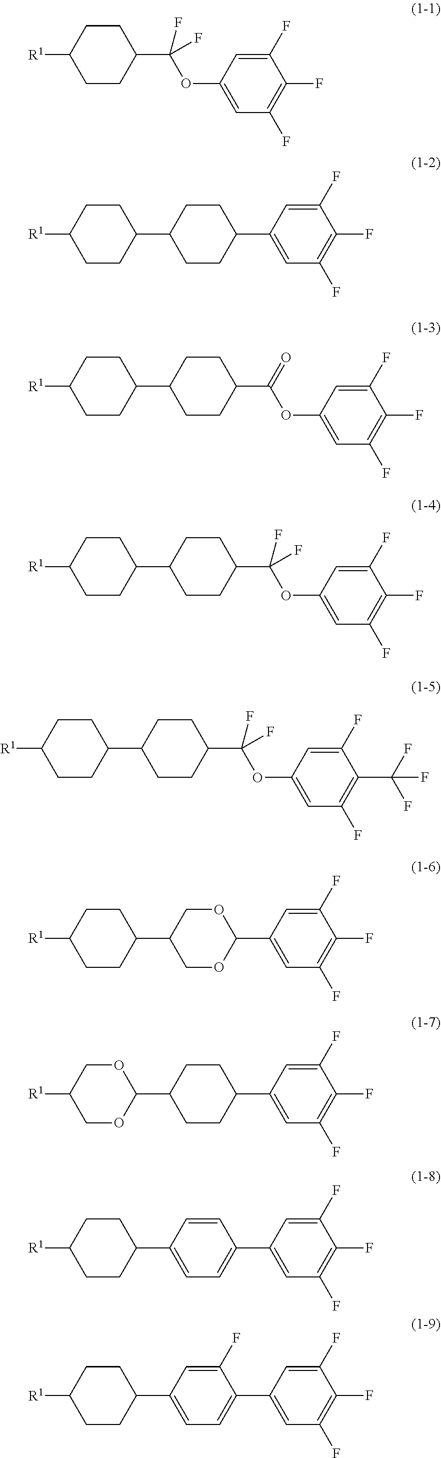

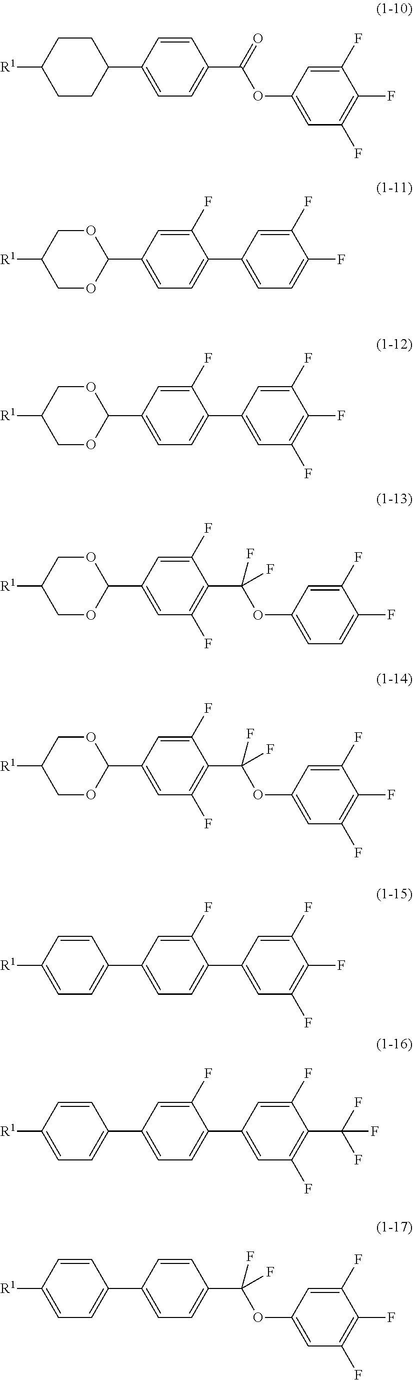

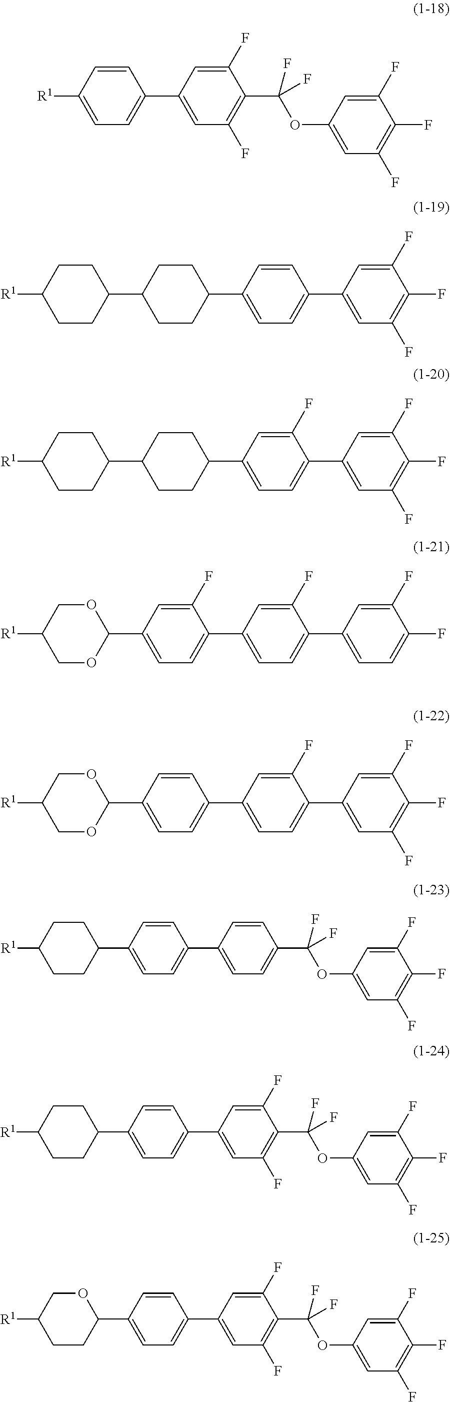

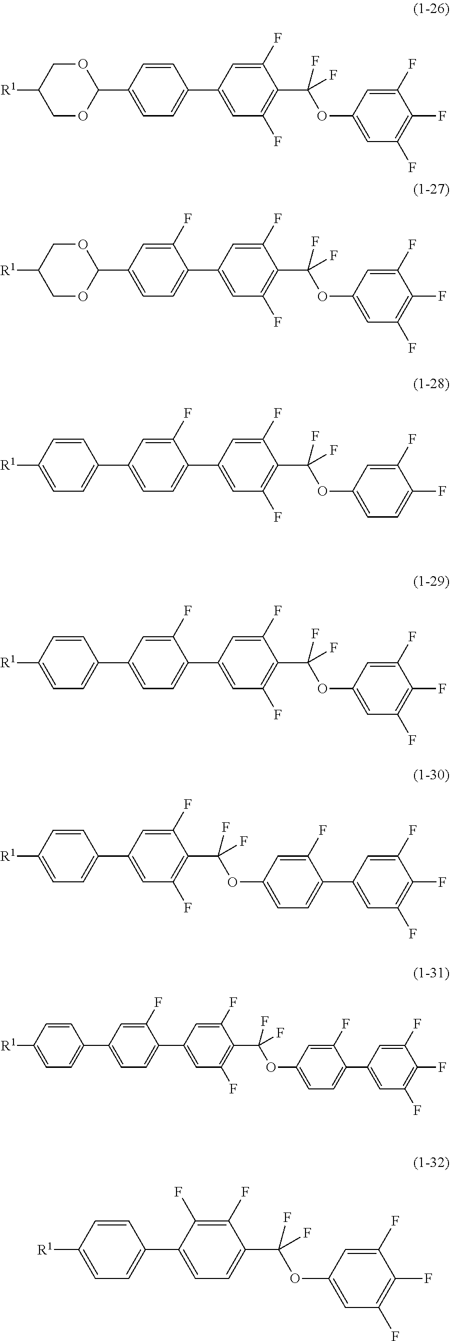

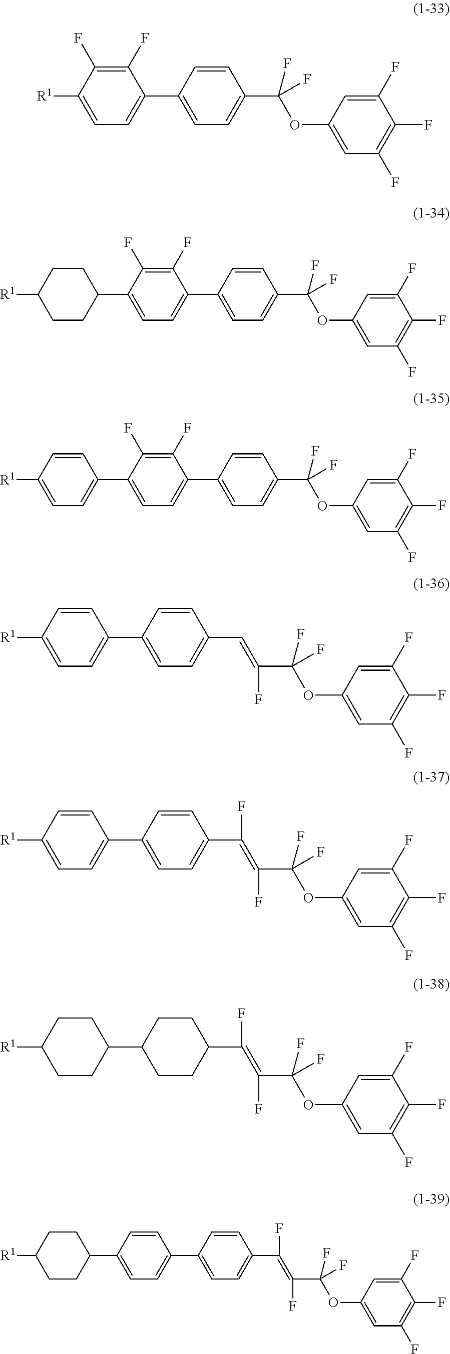

in Formula (1-1) to Formula (1-39), R¹ is an alkyl group having 1 to 12 carbon atoms, an alkoxy group having 1 to 12 carbon atoms, or an alkenyl group having 2 to 12 carbon atoms.

[7] The liquid crystal display element according to [5] or [6], wherein a proportion of the first component is in a range of 10 weight % to 85 weight % with respect to a total amount of the liquid crystalline compound.
[8] The liquid crystal display element according to any one of [1] to [7],

wherein at least one liquid crystalline compound selected from the group of compounds represented by Formula (2) is contained as a second component:

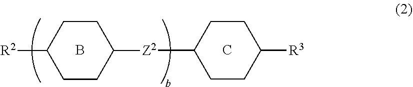

in Formula (2), R² and R³ independently represent an alkyl group having 1 to 12 carbon atoms, an alkoxy group having 1 to 12 carbon atoms, an alkenyl group having 2 to 12 carbon atoms, or an alkenyl group having 2 to 12 carbon atoms in which at least one hydrogen atom is substituted with a fluorine atom or a chlorine atom; the ring B and the ring C independently represent 1,4-cyclohexylene, 1,4-phenylene, 2-fluoro-1,4-phenylene, or 2,5-difluoro-1,4-phenylene; Z² represents a single bond, an ethylene group, or a carbonyloxy group; and b is 1, 2, or 3.

[9] The liquid crystal display element according to any one of [1] to [8],

wherein at least one compound selected from the group of compounds represented by Formula (2-1) to Formula (2-13) is contained as a second component:

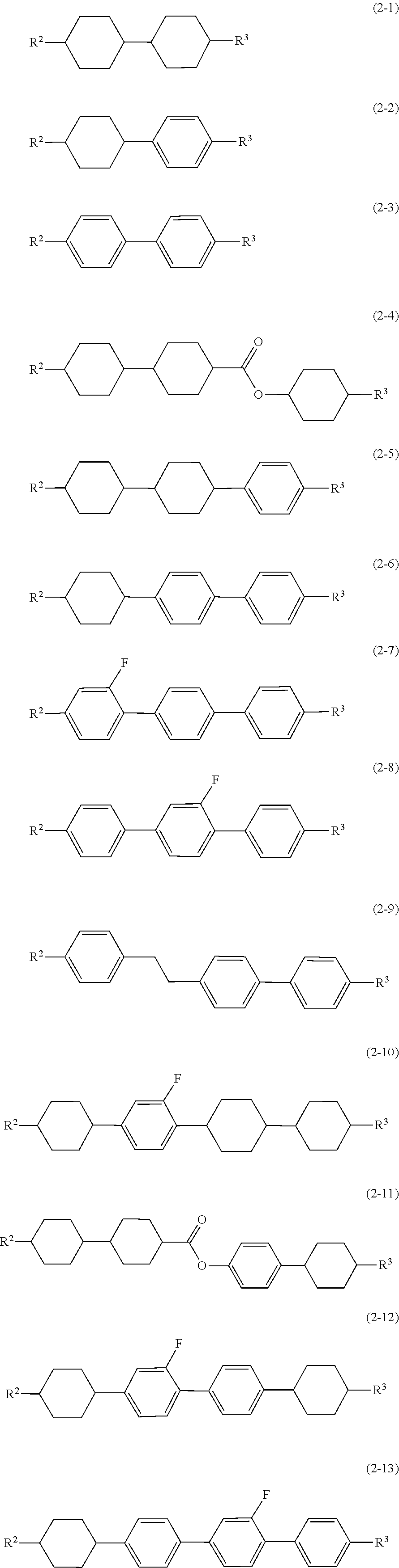

in Formula (2-1) to Formula (2-13), R² and R³ independently represent an alkyl group having 1 to 12 carbon atoms, an alkoxy group having 1 to 12 carbon atoms, an alkenyl group having 2 to 12 carbon atoms, or an alkenyl group having 2 to 12 carbon atoms in which at least one hydrogen atom is substituted with a fluorine atom or a chlorine atom.

[10] The liquid crystal display element according to [8] or [9],

wherein a proportion of the second component is in a range of 10 weight % to 85 weight % with respect to a total amount of the liquid crystalline compound.

[11] The liquid crystal display element according to any one of [1] to [10],

wherein at least one liquid crystalline compound selected from the group of compounds represented by Formula (3) is contained as a third component:

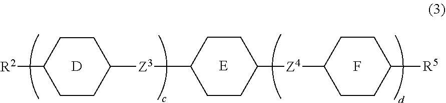

in Formula (3), R⁴ and R⁵ independently represent an alkyl group having 1 to 12 carbon atoms, an alkoxy group having 1 to 12 carbon atoms, an alkenyl group having 2 to 12 carbon atoms, or an alkenyloxy group having 2 to 12 carbon atoms; the ring D and the ring F independently represent 1,4-cyclohexylene, 1,4-cyclohexenylene, tetrahydropyran-2,5-diyl, 1,4-phenylene, 1,4-phenylene in which at least one hydrogen atom is substituted with a fluorine atom or a chlorine atom, naphthalene-2,6-diyl, naphthalene-2,6-diyl in which at least one hydrogen atom is substituted with a fluorine atom or a chlorine atom, chroman-2,6-diyl, or chroman-2,6-diyl in which at least one hydrogen atom is substituted with a fluorine atom or a chlorine atom; the ring E represents 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl, or 7,8-difluorochroman-2,6-diyl; Z³ and Z⁴ independently represent a single bond, an ethylene group, a carbonyloxy group, or a methyleneoxy group; c is 1, 2, or 3, d is 0 or 1; and a sum of c and d is 3 or less.

[12] The liquid crystal display element according to any one of [1] to [11],

wherein at least one compound selected from the group of compounds represented by Formula (3-1) to Formula (3-22) is contained as a third component:

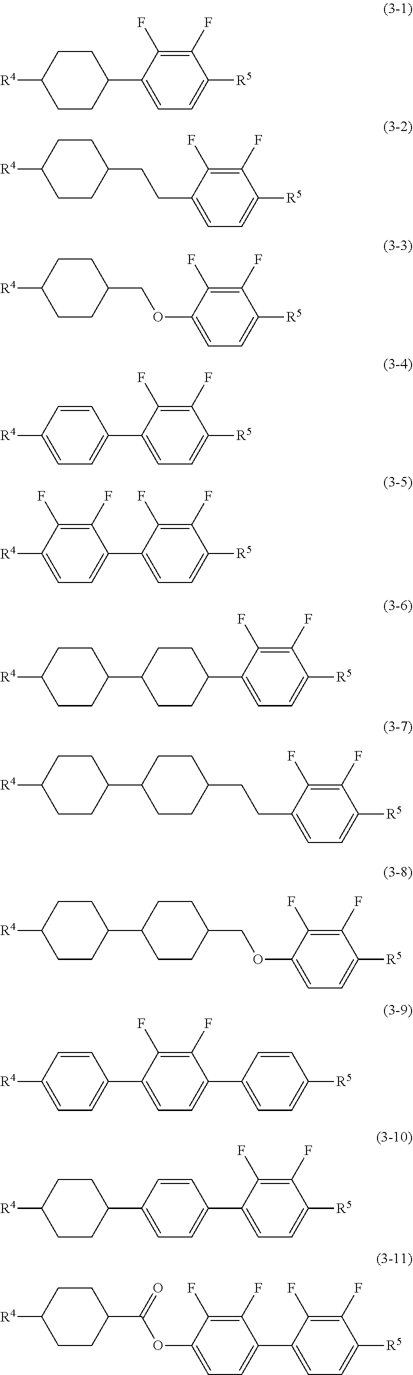

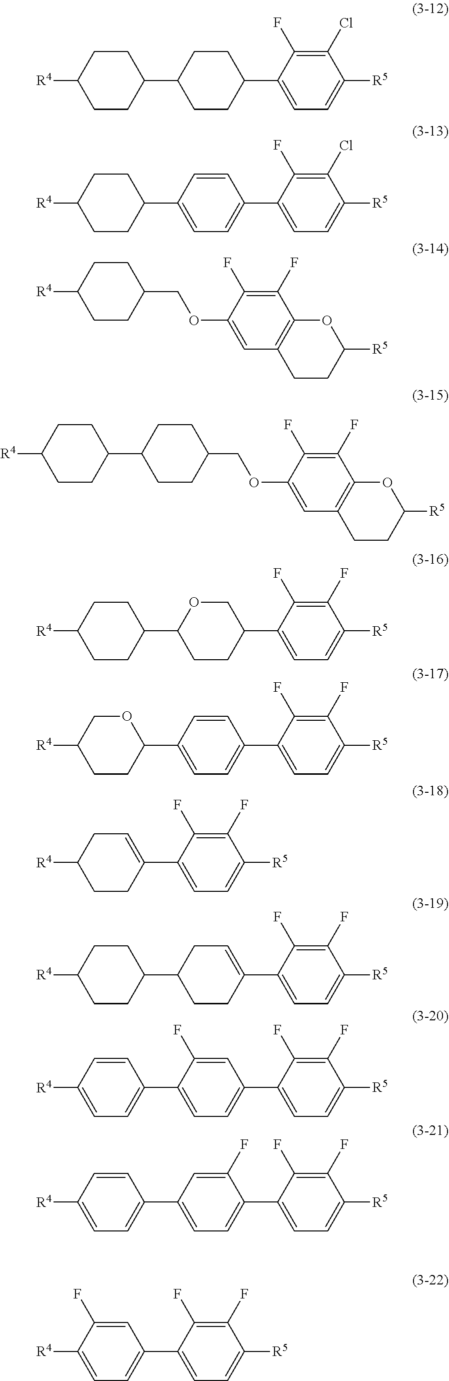

in Formula (3-1) to Formula (3-22), R⁴ and R⁵ independently represent an alkyl group having 1 to 12 carbon atoms, an alkoxy group having 1 to 12 carbon atoms, an alkenyl group having 2 to 12 carbon atoms, or an alkenyloxy group having 2 to 12 carbon atoms.

[13] The liquid crystal display element according to [11] or [12],

wherein a proportion of the third component is in a range of 3 weight % to 25 weight % with respect to a total amount of the liquid crystalline compound.

[14] The liquid crystal display element according to any one of [1] to [13],

wherein an upper limit temperature of a nematic phase is 70° C. or higher, the optical anisotropy (measured at 25° C.) at a wavelength of 589 nm is 0.07 or more, and the dielectric anisotropy (measured at 25° C.) at a frequency of 1 kHz is 2 or more.

[15] The liquid crystal display element according to any one of [1] to [14],

wherein the liquid crystal composition further contains, as a second additive, at least one compound selected from the group of polymerizable compounds represented by Formula (4):

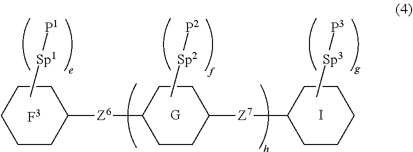

in Formula (4), the ring F³ and the ring I independently represent cyclohexyl, cyclohexenyl, phenyl, 1-naphthyl, 2-naphthyl, tetrahydropyran-2-yl, 1,3-dioxane-2-yl, pyrimidin-2-yl, or pyridin-2-yl, and in these rings, at least one hydrogen atom is optionally substituted with a fluorine atom, a chlorine atom, an alkyl group having 1 to 12 carbon atoms, an alkoxy group having 1 to 12 carbon atoms, or an alkyl group having 1 to 12 carbon atoms in which at least one hydrogen atom is substituted with a fluorine atom or a chlorine atom; the ring G represents 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl, or pyridine-2,5-diyl, and in these rings, at least one hydrogen atom is optionally substituted with a fluorine atom, a chlorine atom, an alkyl group having 1 to 12 carbon atoms, an alkoxy group having 1 to 12 carbon atoms, or an alkyl group having 1 to 12 carbon atoms in which at least one hydrogen atom is substituted with a fluorine atom or a chlorine atom; Z⁶ and Z⁷ independently represent a single bond or an alkylene group having 1 to 10 carbon atoms, and in the alkylene group, at least one —CH₂— is optionally substituted with —O—, —CO—, —COO—, or —OCO—, and at least one —CH₂CH₂— is optionally substituted with —CH═CH—, —C(CH₃)═CH—, —CH═C(CH₃)—, or —C(CH₃)═C(CH₃)—, and in these groups, at least one hydrogen atom is optionally substituted with a fluorine atom or a chlorine atom; P¹, P², and P³ represent a polymerizable group; Sp¹, Sp², and Sp³ independently represent a single bond or an alkylene group having 1 to 10 carbon atoms, and in the alkylene group, at least one —CH₂— is optionally substituted with —O—, —COO—, —OCO—, or —OCOO—, and at least one —CH₂CH₂— is optionally substituted with —CH═CH— or —C≡C—, and in these groups, at least one hydrogen atom is optionally substituted with a fluorine atom or a chlorine atom; h is 0, 1, or 2; e, f, and g are independently 0, 1, 2, 3, or 4, and a sum of e, f, and g is 1 or more.

[16] The liquid crystal display element according to [15],

wherein, in Formula (4) in the liquid crystal composition, P¹, P², and P³ are independently a group selected from the group of polymerizable groups represented by Formula (P-1) to Formula (P-5):

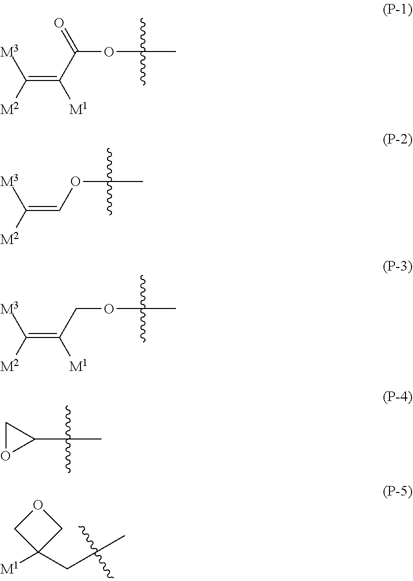

in Formula (P-1) to Formula (P-5), M¹, M², and M³ independently represent a hydrogen atom, a fluorine atom, an alkyl group having 1 to 5 carbon atoms, or an alkyl group having 1 to 5 carbon atoms in which at least one hydrogen atom is substituted with a fluorine atom or a chlorine atom.

[17] The liquid crystal display element according to any one of [1] to [16],

wherein at least one compound selected from the group of polymerizable compounds represented by Formula (4-1) to Formula (4-27) is contained as a second additive in the liquid crystal composition:

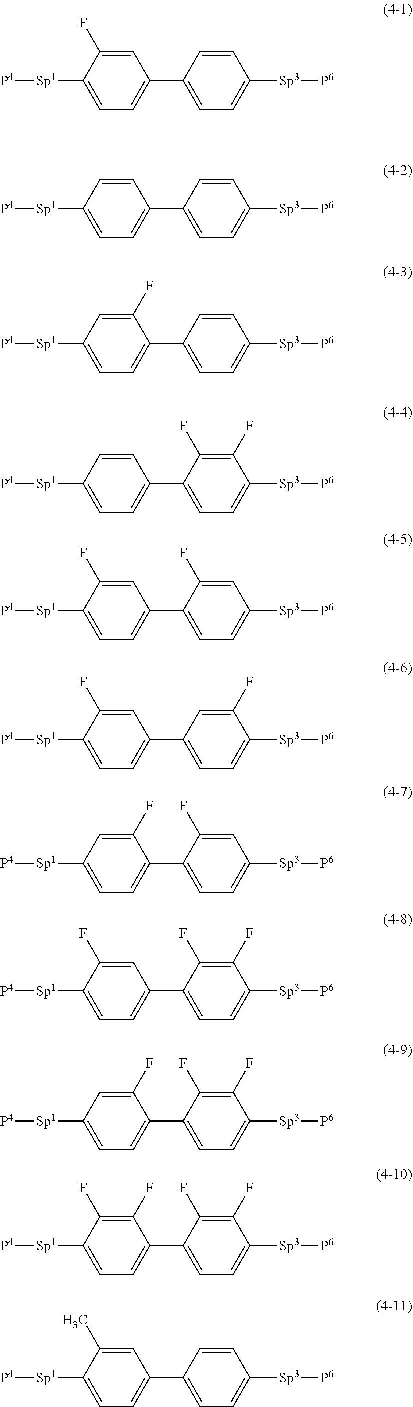

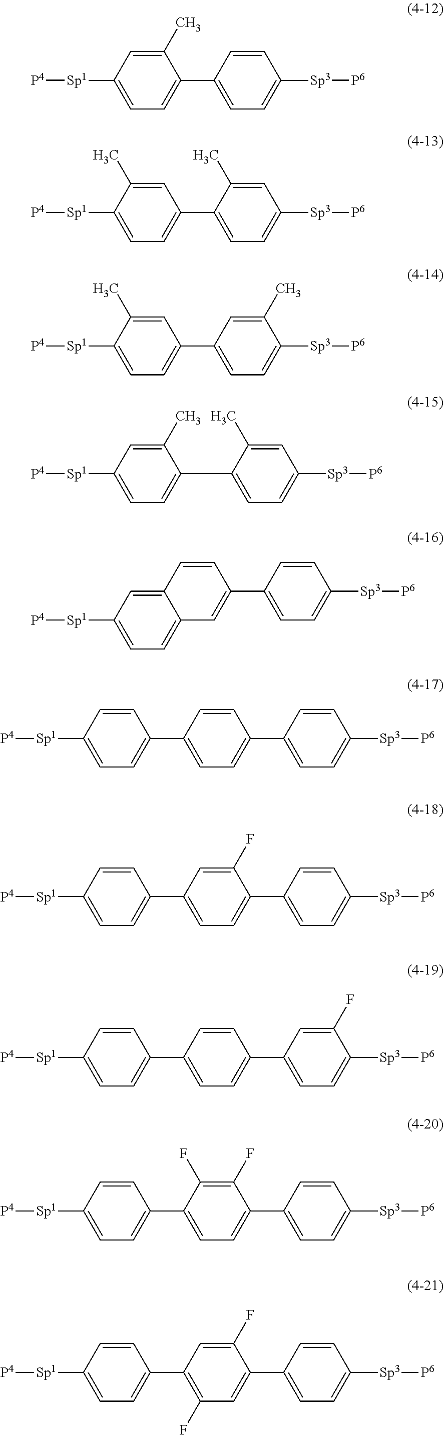

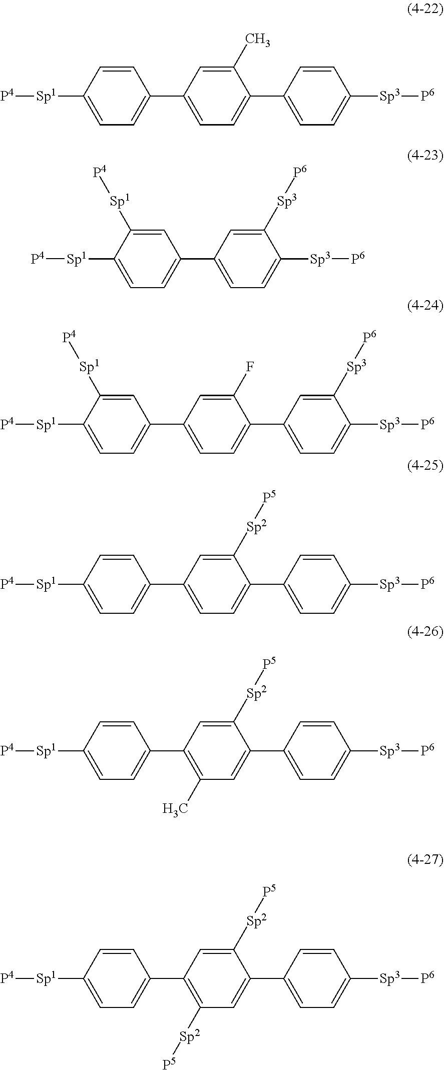

in Formula (4-1) to Formula (4-27), P⁴, P⁵, and P⁶ independently represent a group selected from the group of polymerizable groups represented by Formula (P-1) to Formula (P-3),

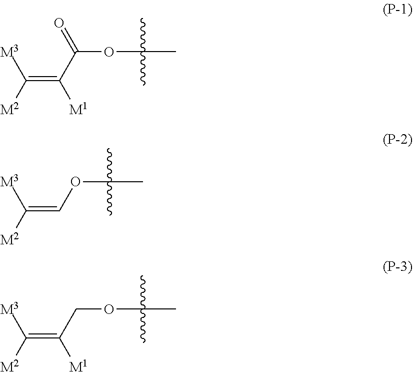

here, M¹, M², and M³ independently represent a hydrogen atom, a fluorine atom, an alkyl group having 1 to 5 carbon atoms, or an alkyl group having 1 to 5 carbon atoms in which at least one hydrogen atom is substituted with a fluorine atom or a chlorine atom; Sp¹, Sp², and Sp³ independently represent a single bond or an alkylene group having 1 to 10 carbon atoms, and in the alkylene group, at least one —CH₂— is optionally substituted with —O—, —COO—, —OCO—, or —OCOO—, at least one —CH₂CH₂— is optionally substituted with —CH═CH— or —C≡C—, and in these groups, at least one hydrogen atom is optionally substituted with a fluorine atom or a chlorine atom.

[18] The liquid crystal display element according to any one of [15] to [17],

wherein a proportion of the second additive in the liquid crystal composition is in a range of 0.03 parts by weight to 10 parts by weight when a total amount of the liquid crystalline compound is 100 parts by weight.

[19] A liquid crystal display element in which the liquid crystal composition in the liquid crystal display element according to any one of [1] to [18], and an electrode are provided between a pair of substrates, and when linearly polarized light is exposed, an alignment control monomer in the liquid crystal composition reacts.
[20] The liquid crystal display element according to [1] to [19],

wherein an operation mode of the liquid crystal display element is a TN mode, an ECB mode, an OCB mode, an IPS mode, an FFS mode, or an FPA mode, and a drive method of the liquid crystal display element is an active matrix method.

[21] The liquid crystal display element according to [1] to [19],

wherein an operation mode of the liquid crystal display element is an IPS mode or an FFS mode, and a drive method of the liquid crystal display element is an active matrix method.

[22] A use of the liquid crystal composition in the liquid crystal display element according to any of [1] to [18] in a liquid crystal display element.
[23] A liquid crystal composition in the liquid crystal display element according to any one of [1] to [18].
[24] A use of a compound represented by Formula (A) in the liquid crystal display element according to [1] or [2] or a compound represented by Formula (A-1) to Formula (A-3) in the liquid crystal display element according to [3] as a monomer for forming an alignment control layer.

The present invention also includes the following items. (a) The composition that further includes at least one additive such as an optically active compound, an antioxidant, a UV absorber, a dye, an antifoaming agent, a polymerizable compound, a polymerization initiator, a polymerization inhibitor, and a polar compound. (b) An AM element containing the composition. (c) A polymer sustained alignment (PSA) type AM element containing the composition that further contains a polymerizable compound. (d) A polymer sustained alignment (PSA) AM element which contains the composition and in which a polymerizable compound in the composition is polymerized. (e) An element which contains the composition and has a PC, TN, STN, ECB, OCB, IPS, VA, FFS, or FPA mode. (f) A transmissive type element containing the composition. (g) A use of the composition as a composition having a nematic phase. (h) A use as an optically active composition by adding an optically active compound to the composition.

A compound including an aromatic ester which is contained in a liquid crystal composition used for the liquid crystal display element of the present invention and which causes photo-Fries rearrangement will be described. The compound including an aromatic ester which causes photo-Fries rearrangement refers to a compound which absorbs UV light and in which radical cleavage of aromatic ester moieties results in rearrangement to hydroxy ketone and indicates compounds represented by Formula (A) and Formula (A-1) to Formula (A-3) in the present invention, and preferably, compounds represented by Formula (A-1), Formula (A-2) and Formula (A-3), and more preferably a compound represented by Formula (A-1).

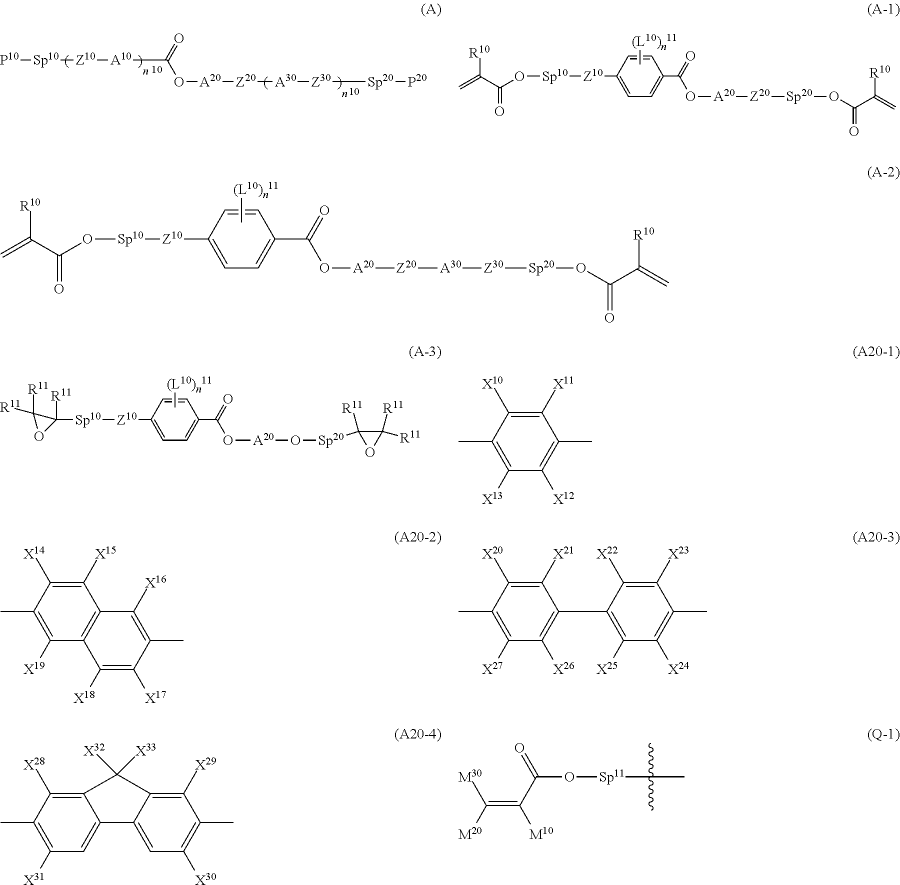

In Formula (A), and Formula (A-1) to Formula (A-3),

P¹⁰ and P²⁰ independently represent a polymerizable group, preferably an acryloyloxy group, a methacryloyloxy group, a fluoroacrylate group, a vinyl group, a vinyloxy group, or an epoxy group.

Sp¹⁰ and Sp²⁰ independently represent a single bond or an alkylene group having 1 to 12 carbon atoms, and at least one hydrogen atom in the alkylene group is optionally substituted with a fluorine atom or a hydroxy group, at least one —CH₂— is optionally substituted with —O—, —COO—, —OCO— or Formula (Q-1), and at least one —CH₂—CH₂— is optionally substituted with —CH═CH— or —C≡C—;

in Formula (Q-1), M¹⁰, M²⁰, and M³⁰ independently represent a hydrogen atom, a fluorine atom, an alkyl group having 1 to 5 carbon atoms, or an alkyl group having 1 to 5 carbon atoms in which at least one hydrogen atom is substituted with a fluorine atom or a chlorine atom; Sp¹¹ is a single bond or an alkylene group having 1 to 12 carbon atoms, at least one hydrogen atom in the alkylene group is optionally substituted with a fluorine atom or a hydroxy group, at least one —CH₂— is optionally substituted with —O—, —COO—, or —OCO—, and at least one —CH₂—CH₂— is optionally substituted with —CH═CH— or —C≡C—;

Z¹⁰, Z²⁰, and Z³⁰ independently represent

a single bond, —COO—, —OCO—, —OCO—CH₂CH₂—, —CH₂CH₂—COO—, —CH₂O—, —OCH₂—, —CF₂O—, —OCF₂—, —CONH—, —NHCO—, —(CH₂)₄—, —CH₂CH₂— or —CF₂CF₂—, preferably,

a single bond, —COO—, —OCO—, —OCO—CH₂CH₂—, —CH₂CH₂—COO—, —CH₂O—, —OCH₂—, —CF₂O—, —OCF₂— or —CH₂CH₂—.

A¹⁰ and A³⁰ independently represent

1,4-phenylene, 1,4-cyclohexylene, pyridine-2,5-diyl, pyrimidine-2,5-diyl, naphthalene-2,6-diyl, naphthalene-1,5-diyl, tetrahydronaphthalene-2,6-diyl, fluorene-2,7-diyl, biphenylene-4,4′-diyl or 1,3-dioxane-2,5-diyl, and in 1,4-phenylene, any hydrogen atom is optionally substituted with a fluorine atom, a chlorine atom, a cyano group, a hydroxy group, a formyl group, an acetoxy group, an acetyl group, a trifluoroacetyl group, a difluoromethyl group, a trifluoromethyl group, an alkyl group having 1 to 5 carbon atoms, an alkoxy having 1 to 5 carbon atoms, or P¹⁰—Sp¹⁰—Z¹⁰—, and in fluorene-2,7-diyl, any hydrogen atom is optionally substituted with a fluorine atom, or an alkyl group having 1 to 5 carbon atoms, and in biphenylene-4,4′-diyl, any hydrogen atom is optionally substituted with a fluorine atom, a difluoromethyl group, a trifluoromethyl group, an alkyl group having 1 to 5 carbon atoms, or an alkoxy having 1 to 5 carbon atoms, preferably,

1,4-phenylene, 1,4-cyclohexylene, naphthalene-2,6-diyl, naphthalene-1,5-diyl, fluorene-2,7-diyl, or biphenylene-4,4′-diyl, and in 1,4-phenylene, any hydrogen atom is optionally substituted with a fluorine atom, a cyano group, a hydroxy group, an acetoxy group, an acetyl group, a trifluoroacetyl group, a difluoromethyl group, a trifluoromethyl group, an alkyl group having 1 to 5 carbon atoms, or an alkoxy having 1 to 5 carbon atoms, and in fluorene-2,7-diyl, any hydrogen atom is optionally substituted with a fluorine atom or an alkyl group having 1 to 5 carbon atoms, and in biphenylene-4,4′-diyl, any hydrogen atom is optionally substituted with a fluorine atom, a difluoromethyl group, a trifluoromethyl group, an alkyl group having 1 to 5 carbon atoms, or an alkoxy having 1 to 5 carbon atoms.

A²⁰ independently represent 1,4-phenylene represented by Formula (A20-1), pyridine-2,5-diyl, or pyrimidine-2,5-diyl, naphthalene-2,6-diyl represented by Formula (A20-2) or naphthalene-1,5-diyl, biphenylene-4,4′-diyl represented by Formula (A20-3) or fluorene-2,7-diyl represented by Formula (A20-4), preferably, 1,4-phenylene represented by Formula (A20-1), naphthalene-2,6-diyl represented by Formula (A20-2), biphenylene-4,4′-diyl represented by Formula (A20-3), or fluorene-2,7-diyl represented by Formula (A20-4), and more preferably 1,4-phenylene represented by Formula (A20-1), biphenylene-4,4′-diyl represented by Formula (A20-3), or fluorene-2,7-diyl represented by Formula (A20-4).

In 1,4-phenylene represented by Formula (A20-1), X¹⁰, X¹¹, X¹² and X¹³ each are independently optionally substituted with a hydrogen atom, a fluorine atom, a chlorine atom, a cyano group, a hydroxy group, a formyl group, an acetoxy group, an acetyl group, a trifluoroacetyl group, a difluoromethyl group, a trifluoromethyl group, an alkyl group having 1 to 5 carbon atoms, or an alkoxy having 1 to 5 carbon atoms, and at least one of X¹⁰ and X¹¹ is a hydrogen atom, and preferably are optionally substituted with a hydrogen atom, a fluorine atom, a chlorine atom, a cyano group, a hydroxy group, a formyl group, an acetoxy group, an acetyl group, a trifluoroacetyl group, a difluoromethyl group, a trifluoromethyl group, an alkyl group having 1 to 5 carbon atoms, or an alkoxy having 1 to 5 carbon atoms, and at least one of X¹⁰ and X¹¹ is a hydrogen atom, and more preferably, optionally substituted with a hydrogen atom, a fluorine atom, a hydroxy group, a difluoromethyl group, a trifluoromethyl group, an alkyl group having 1 to 5 carbon atoms, or an alkoxy having 1 to 5 carbon atoms, and at least one of X¹⁰ and X¹¹ is a hydrogen atom.

In naphthalene-2,6-diyl represented by Formula (A20-2), X¹⁴, X¹⁵, X¹⁶, X¹⁷, X¹⁸ and X¹⁹ each are independently optionally substituted with a hydrogen atom, a fluorine atom, an alkyl group having 1 to 5 carbon atoms, or an alkoxy having 1 to 5 carbon atoms, and at least one of X¹⁴ and X¹⁹ is a hydrogen atom.

In biphenylene-4,4′-diyl represented by Formula (A20-3), X²⁰, X²¹, X²², X²³, X²⁴, X²⁵, X²⁶ and X²⁷ each are independently optionally substituted with a hydrogen atom, a fluorine atom, a difluoromethyl group, a trifluoromethyl group, an alkyl group having 1 to 5 carbon atoms, or an alkoxy having 1 to 5 carbon atoms, and at least one of X²⁰ and X²⁷ is a hydrogen atom.

In fluorene-2,7-diyl represented by Formula (A20-4), X²⁸, X²⁹, X³⁰, X³¹, X³² and X³³ each are independently optionally substituted with a hydrogen atom, a fluorine atom, or an alkyl group having 1 to 5 carbon atoms, and at least one of X²⁸ and X³¹ is a hydrogen atom.

n¹⁰ is independently an integer of 0 to 3

In Formula (A-1) to Formula (A-3),

R¹⁰ represents a hydrogen atom, a fluorine atom, or a methyl group, preferably a hydrogen atom or a methyl group.

R¹¹ represents a hydrogen atom or a methyl group, preferably a hydrogen atom.

L¹⁰ is independently optionally substituted with a hydrogen atom, a fluorine atom, a difluoromethyl group, a trifluoromethyl group, an alkyl group having 1 to 5 carbon atoms, or an alkoxy having 1 to 5 carbon atoms, and preferably optionally substituted with a hydrogen atom, a fluorine atom, a trifluoromethyl group, an alkyl group having 1 to 5 carbon atoms, or an alkoxy having 1 to 5 carbon atoms.

n¹¹ independently represent an integer of 0 to 4, preferably an integer of 0 to 2 and more preferably 0 or 1.

In a compound including an aromatic ester and a polymerizable group, when UV light is exposed, an aromatic ester moiety is photolyzed, radicals are formed, and photo-Fries rearrangement occurs. In the photo-Fries rearrangement, the aromatic ester moiety is photolyzed when a polarized light direction of polarized ultraviolet light and a long axis direction of the aromatic ester moiety are the same direction. After the photolysis, they are recombined and hydroxyl groups are generated in molecules according to tautomerization. It is thought that this hydroxyl group causes an interaction at a substrate interface and the alignment control monomer is easily adsorbed to the side of the substrate interface with anisotropy. In addition, since the compound has a polymerizable group, it is fixed by polymerization. This property can be used to prepare a thin film that can align liquid crystal molecules. In order to prepare this thin film, UV light to be exposed is suitably linearly polarized light. First, an alignment control monomer in a range of 0.1 parts by weight to 10 parts by weight is added to the liquid crystal composition when a total amount of the liquid crystalline compound is 100 parts by weight, and the composition is heated in order to dissolve the alignment control monomer. The composition is injected into an element having no alignment film. Next, linearly polarized light is exposed while the element is heated, and thus the alignment control monomer is subjected to photo-Fries rearrangement and polymerized. The alignment control monomer subjected to photo-Fries rearrangement is arranged in a certain direction, and the thin film formed after polymerization has a function as a liquid crystal alignment film.

The composition used in the present invention will be described in the following order. First, the configuration of the composition will be described. Second, main characteristics of component compounds and main effects of the compounds on the composition and the element will be described. Third, combinations of components in the composition, and preferable proportions of the components and the basis thereof will be described. Fourth, preferable forms of the component compounds will be described. Fifth, preferable component compounds will be shown. Sixth, additives that may be added to the composition will be described. Seventh, a method of synthesizing component compounds will be described. Eighth, applications of the composition will be described. Ninth, a method of producing an element will be described.

First, the configuration of the composition will be described. The composition contains a plurality of liquid crystalline compounds. The composition may contain an additive. Examples of the additive include an optically active compound, an antioxidant, a UV absorber, a dye, an antifoaming agent, a polymerizable compound, a polymerization initiator, a polymerization inhibitor, and a polar compound. The compositions are classified into a composition A and a composition B in consideration of the liquid crystalline compound. The composition A may further contain other liquid crystalline compounds and other additives in addition to a liquid crystalline compound selected from among Compound (1) and Compound (2) and a first additive. “Other liquid crystalline compounds” are liquid crystalline compounds different from Compound (1) and Compound (2). Other additives are compounds different from the first additive. The other liquid crystalline compounds and the other additives are mixed into the composition in order to additionally adjust characteristics.

The composition B is substantially composed of only a liquid crystalline compound selected from among Compound (1) and Compound (2) and a first additive. The term “substantially” means that the composition may contain an additive but does not contain other liquid crystalline compounds. The composition B has a smaller number of components than the composition A. In order to reduce costs, the composition B is preferable to the composition A. In order to additionally adjust characteristics by mixing in other liquid crystalline compounds, the composition A is preferable to the composition B.

Second, main characteristics of component compounds and main effects of the compounds on the composition and the element will be described. Main characteristics of component compounds are summarized in Table 2 based on the effects of the present invention. In the symbols in Table 2, L means large or high, M means medium, and S means small or low. Symbols L, M, and S are classifications based on qualitative comparison between component compounds, and the symbol 0 (zero) means that the dielectric anisotropy is very small.

TABLE 2
Characteristics of compounds

| Characteristics | Compound (1) | Compound (2) | Compound (3) |
|---|---|---|---|
| Upper limit | S to L | S to M | S to M |
| temperature | | | |
| Viscosity | M to L | S to M | L |
| Optical anisotropy | S to L | S to L | M to L |
| Dielectric anisotropy | M to L | 0 | L |
| Specific resistance | L | L | L |

1) a value of dielectric anisotropy is negative, and the symbol indicates a magnitude of an absolute value

When component compounds are mixed into the composition, the main effects of the component compound on characteristics of the composition are as follows. The alignment control monomer is a first additive. The compound is arranged at a molecular level in a certain direction when Fries rearrangement occurs due to polarized light. Therefore, a thin film prepared using the alignment control monomer causes liquid crystal molecules to be aligned as in an alignment film of such as a polyimide. Compound (1) as a first component increases the dielectric anisotropy. Compound (2) as a second component lowers the viscosity or increases the upper limit temperature. Compound (3) as a third component increases a dielectric constant in a short axis direction.

Third, combinations of components in the composition and preferable proportions of component compounds and the basis thereof will be described. Preferable combinations of components in the composition include a combination of a first component and an additive, a combination of a first component, a second component, and an additive, a combination of a first component, a third component, and an additive, and a combination of a first component, a second component, a third component, and an additive. A more preferable combination is a combination of a first component, a second component, and an additive.

A preferable proportion of the first additive is about 0.1 parts by weight or more in order to align liquid crystal molecules and about 10 parts by weight or less in order to prevent display defects of the element when a total amount of the liquid crystalline compound is 100 parts by weight. A more preferable proportion is in a range of about 0.3 parts by weight to about 6 parts by weight. A particularly preferable proportion is in a range of about 0.5 parts by weight to about 4 parts by weight.

A preferable proportion of the first component is about 10 weight % or more in order to increase the dielectric anisotropy and about 85 weight % or less in order to lower the lower limit temperature or in order to lower the viscosity with respect to a total amount of the liquid crystalline compound. A more preferable proportion is in a range of about 15 weight % to about 80 weight %. A particularly preferable proportion is in a range of about 20 weight % to about 75 weight %.

A preferable proportion of the second component is about 10 weight % or more in order to increase the upper limit temperature or in order to lower the viscosity with respect to a total amount of the liquid crystalline compound and about 85 weight % or less in order to increase the dielectric anisotropy. A more preferable proportion is in a range of about 15 weight % to about 80 weight %. A particularly preferable proportion is in a range of about 20 weight % to about 75 weight %.

A preferable proportion of the third component is about 3 weight % or more in order to increase a dielectric constant in a short axis direction, and about 25 weight % or less in order to lower the lower limit temperature with respect to a total amount of the liquid crystalline compound. A more preferable proportion is in a range of about 5 weight % to about 20 weight %. A particularly preferable proportion is in a range of about 5 weight % to about 15 weight %.

The second additive may be added to the composition in order to adapt the composition to a polymer sustained alignment type element. A preferable proportion of the additive is about 0.03 parts by weight or more in order to align liquid crystal molecules and about 10 parts by weight or less in order to prevent display defects of the element when a total amount of the liquid crystalline compound is 100 parts by weight. A more preferable proportion is in a range of about 0.1 parts by weight to about 2 parts by weight. A particularly preferable proportion is in a range of about 0.2 parts by weight to about 1.0 part by weight.

Fourth, preferable forms of the component compounds will be described. In Formula (1), Formula (2), and Formula (3), R¹ represents an alkyl group having 1 to 12 carbon atoms, an alkoxy group having 1 to 12 carbon atoms, or an alkenyl group having 2 to 12 carbon atoms. Preferably, R¹ is an alkyl group having 1 to 12 carbon atoms in order to improve stability with respect to UV light or heat. R² and R³ independently represent an alkyl group having 1 to 12 carbon atoms, an alkoxy group having 1 to 12 carbon atoms, an alkenyl group having 2 to 12 carbon atoms, or an alkenyl group having 2 to 12 carbon atoms in which at least one hydrogen atom is substituted with a fluorine atom or a chlorine atom. Preferably, R² or R³ is an alkenyl group having 2 to 12 carbon atoms in order to lower the viscosity and an alkyl group having 1 to 12 carbon atoms in order to improve stability with respect to UV light or heat. R⁴ and R⁵ independently represent an alkyl group having 1 to 12 carbon atoms, an alkoxy group having 1 to 12 carbon atoms, an alkenyl group having 2 to 12 carbon atoms, or an alkenyloxy group having 2 to 12 carbon atoms. Preferably, R⁴ or R⁵ is an alkyl group having 1 to 12 carbon atoms in order to improve stability with respect to UV light or heat and an alkoxy group having 1 to 12 carbon atoms in order to increase a dielectric constant in a short axis direction.

Preferably, the alkyl group is a methyl, ethyl, propyl, butyl, pentyl, hexyl, heptyl or octyl group. More preferably, the alkyl group is a methyl, ethyl, propyl, butyl or pentyl group in order to lower the viscosity.

Preferably, the alkoxy group is a methoxy, ethoxy, propoxy, butoxy, pentyloxy, hexyloxy, or heptyloxy group. More preferably, the alkoxy group is a methoxy or ethoxy group in order to lower the viscosity.

Preferably, the alkenyl group is a vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, or 5-hexenyl group. More preferably, the alkenyl group is a vinyl, 1-propenyl, 3-butenyl, or 3-pentenyl group in order to lower the viscosity. In these alkenyl groups, a preferable configuration of —CH═CH— depends on the position of the double bond. In order to lower the viscosity or the like, the trans type is preferable in the alkenyl group such as 1-propenyl, 1-butenyl, 1-pentenyl, 1-hexenyl, 3-pentenyl, and 3-hexenyl. The cis type is preferable in the alkenyl group such as 2-butenyl, 2-pentenyl, and 2-hexenyl. In these alkenyl groups, a linear alkenyl group is preferable to a branched alkenyl group.

Preferably, the alkenyloxy group is a vinyloxy, allyloxy, 3-butenyloxy, 3-pentenyloxy, or 4-pentenyloxy group. More preferably, the alkenyloxy group is an allyloxy or 3-butenyloxy group in order to lower the viscosity.

Preferable examples of an alkyl group in which at least one hydrogen atom is substituted with a fluorine atom or a chlorine atom include fluoromethyl, 2-fluoroethyl, 3-fluoropropyl, 4-fluorobutyl, 5-fluoropentyl, 6-fluorohexyl, 7-fluoroheptyl and 8-fluorooctyl. More preferable examples include 2-fluoroethyl, 3-fluoropropyl, 4-fluorobutyl, and 5-fluoropentyl in order to increase the dielectric anisotropy.

Preferable examples of an alkenyl group in which at least one hydrogen atom is substituted with a fluorine atom or a chlorine atom include 2,2-difluorovinyl, 3,3-difluoro-2-propenyl, 4,4-difluoro-3-butenyl, 5,5-difluoro-4-pentenyl and 6,6-difluoro-5-hexenyl. More preferable examples include 2,2-difluorovinyl and 4,4-difluoro-3-butenyl in order to lower the viscosity.

The ring A represents 1,4-cyclohexylene, 1,4-phenylene, 2-fluoro-1,4-phenylene, 2,3-difluoro-1,4-phenylene, 2,6-difluoro-1,4-phenylene, pyrimidine-2,5-diyl, 1,3-dioxane-2,5-diyl, or tetrahydropyran-2,5-diyl. Preferably, the ring A is 1,4-phenylene or 2-fluoro-1,4-phenylene in order to increase the optical anisotropy. Tetrahydropyran-2,5-diyl is

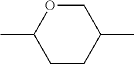

or

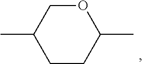

and preferably

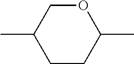

The ring B and the ring C independently represent 1,4-cyclohexylene, 1,4-phenylene, 2-fluoro-1,4-phenylene, or 2,5-difluoro-1,4-phenylene. Preferably, the ring B or the ring C is 1,4-cyclohexylene in order to lower the viscosity or 1,4-phenylene in order to increase the optical anisotropy. The ring D and the ring F independently represent 1,4-cyclohexylene, 1,4-cyclohexenylene, tetrahydropyran-2,5-diyl, 1,4-phenylene, 1,4-phenylene in which at least one hydrogen atom is substituted with a fluorine atom or a chlorine atom, naphthalene-2,6-diyl, naphthalene-2,6-diyl in which at least one hydrogen atom is substituted with a fluorine atom or a chlorine atom, chroman-2,6-diyl, or chroman-2,6-diyl in which at least one hydrogen atom is substituted with a fluorine atom or a chlorine atom. Preferably, the ring D or the ring F is 1,4-cyclohexylene in order to lower the viscosity, tetrahydropyran-2,5-diyl in order to increase a dielectric constant in a short axis direction, and 1,4-phenylene in order to increase the optical anisotropy. The ring E represents 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl, or 7,8-difluorochroman-2,6-diyl. Preferably, the ring E is 2,3-difluoro-1,4-phenylene in order to increase a dielectric constant in a short axis direction.

Z¹ represents a single bond, an ethylene group, a carbonyloxy group, a difluoromethyleneoxy group, —CH═CF—CF₂O— or —CF═CF—CF₂O—. Preferably, Z¹ is a single bond in order to lower the viscosity, and a difluoromethyleneoxy group in order to increase the dielectric anisotropy. Z² represents a single bond, an ethylene group, or a carbonyloxy group. Preferably, Z² is a single bond in order to lower the viscosity. Z³ and Z⁴ independently represent a single bond, an ethylene group, a carbonyloxy group, or a methyleneoxy group. Preferably, Z³ or Z⁴ is a single bond in order to lower the viscosity and a methyleneoxy group in order to increase a dielectric constant in a short axis direction.

X¹ and X² independently represent a hydrogen atom or a fluorine atom. Preferably, X¹ or X² is a fluorine atom in order to increase the dielectric anisotropy.

Y¹ represents a fluorine atom, a chlorine atom, an alkyl group having 1 to 12 carbon atoms in which at least one hydrogen atom is substituted with a fluorine atom or a chlorine atom, an alkoxy group having 1 to 12 carbon atoms in which at least one hydrogen atom is substituted with a fluorine atom or a chlorine atom, or an alkenyloxy group having 2 to 12 carbon atoms in which at least one hydrogen atom is substituted with a fluorine atom or a chlorine atom. Preferably, Y¹ is a fluorine atom in order to lower the lower limit temperature.

Preferable examples of an alkyl group in which at least one hydrogen atom is substituted with a fluorine atom or a chlorine atom include a trifluoromethyl group. Preferable examples of an alkoxy group in which at least one hydrogen atom is substituted with a fluorine atom or a chlorine atom include a trifluoromethoxy group. Preferable examples of an alkenyloxy group in which at least one hydrogen atom is substituted with a fluorine atom or a chlorine atom include a trifluorovinyloxy group.

a is 1, 2, 3, or 4. Preferably, a is 2 in order to lower the lower limit temperature, and 3 in order to increase the dielectric anisotropy. b is 1, 2, or 3. Preferably, b is 1 in order to lower the viscosity and 2 or 3 in order to increase the upper limit temperature. c is 1, 2, or 3, d is 0 or 1, and a sum of c and d is 3 or less. Preferably, c is 1 in order to lower the viscosity and 2 or 3 in order to increase the upper limit temperature. Preferably, d is 0 in order to lower the viscosity and 1 in order to lower the lower limit temperature.

In Formula (3), P¹, P², and P³ independently represent a polymerizable group. Preferably, P¹, P², or P³ is a polymerizable group selected from the group of groups represented by Formula (P-1) to Formula (P-5). More preferably, P¹, P², or P³ is a group represented by Formula (P-1), Formula (P-2), or Formula (P-3). Particularly preferably, P¹, P², or P³ is a group represented by Formula (P-1) or Formula (P-2). Most preferably, P¹, P², or P³ is a group represented by Formula (P-1). A preferable group represented by Formula (P-1) is —OCO—CH═CH₂ or —OCO—C(CH₃)═CH₂. Wavy lines in Formula (P-1) to Formula (P-5) indicate binding sites.

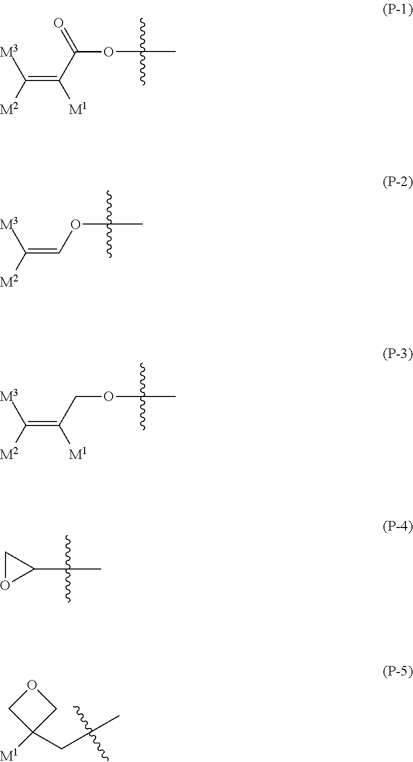

In Formula (P-1) to Formula (P-5), M¹, M², and M³ independently represent a hydrogen atom, a fluorine atom, an alkyl group having 1 to 5 carbon atoms, or an alkyl group having 1 to 5 carbon atoms in which at least one hydrogen atom is substituted with a fluorine atom or a chlorine atom. Preferably, M¹, M², or M³ is a hydrogen atom or a methyl group in order to improve the reactivity. More preferably, M¹ is a hydrogen atom or a methyl group, and more preferably, M² or M³ is a hydrogen atom.

Sp¹, Sp², and Sp³ independently represent a single bond or an alkylene group having 1 to 10 carbon atoms, and in the alkylene group, at least one —CH₂— is optionally substituted with —O—, —COO—, —OCO—, or —OCOO—, at least one —CH₂—CH₂— is optionally substituted with —CH═CH— or —C≡C—, and in these groups, at least one hydrogen atom is optionally substituted with a fluorine atom or a chlorine atom. Preferably, Sp¹, Sp², or Sp³ is a single bond, —CH₂—CH₂—, —CH₂O—, —OCH₂—, —COO—, —OCO—, —CO—CH═CH—, or —CH═CH—CO—. More preferably, Sp¹, Sp², or Sp³ is a single bond.

The ring F³ and the ring I independently represent cyclohexyl, cyclohexenyl, phenyl, 1-naphthyl, 2-naphthyl, tetrahydropyran-2-yl, 1,3-dioxane-2-yl, pyrimidin-2-yl, or pyridin-2-yl, and in these rings, at least one hydrogen atom is optionally substituted with a fluorine atom, a chlorine atom, an alkyl group having 1 to 12 carbon atoms, an alkoxy group having 1 to 12 carbon atoms, or an alkyl group having 1 to 12 carbon atoms in which at least one hydrogen atom is substituted with a fluorine atom or a chlorine atom. Preferably, the ring F³ or the ring I is a phenyl group. The ring G represents 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl, or pyridine-2,5-diyl, and in these rings, at least one hydrogen atom is optionally substituted with a fluorine atom, a chlorine atom, an alkyl group having 1 to 12 carbon atoms, an alkoxy group having 1 to 12 carbon atoms, or an alkyl group having 1 to 12 carbon atoms in which at least one hydrogen atom is substituted with a fluorine atom or a chlorine atom. Preferably, the ring G is 1,4-phenylene or 2-fluoro-1,4-phenylene.

Z⁴ and Z⁵ independently represent a single bond or an alkylene group having 1 to 10 carbon atoms, and in the alkylene group, at least one —CH₂— is optionally substituted with —O—, —CO—, —COO—, or —OCO—, at least one —CH₂—CH₂— is optionally substituted with —CH═CH—, —C(CH₃)═CH—, —CH═C(CH₃)—, or —C(CH₃)═C(CH₃)—, and in these groups, at least one hydrogen atom is optionally substituted with a fluorine atom or a chlorine atom. Preferably, Z⁴ or Z⁵ is a single bond, —CH₂—CH₂—, —CH₂O—, —OCH₂—, —COO—, or —OCO—. More preferably, Z⁴ or Z⁵ is a single bond.

d is 0, 1, or 2. Preferably, d is 0 or 1. e, f, and g are independently 0, 1, 2, 3, or 4, and a sum of e, f, and g is 1 or more. Preferably, e, f, or g is 1 or 2.

Fifth, preferable component compounds will be shown. A preferable alignment control monomer will be described. An alignment control monomer preferably has at least two or more polymerizable groups. When one polymerizable group is included, since it is thought that an alignment control layer obtained after polymerization forms a flexible film, the alignment control layer is easily deformed in a temperature environment in which a liquid crystal display element is driven and an alignment control force is also easily reduced. When at least two or more polymerizable groups are included, since it is thought that a crosslinking density of an alignment control layer obtained after polymerization increases and a strong film is formed, the alignment control layer is unlikely to be deformed even in a high temperature environment. When a fluorine atom is contained in the polymerizable group, since it is thought that the polymerization reactivity also increases, this is preferable to control the mechanical strength of the alignment control layer obtained after polymerization. When a spacer is introduced between a polymerizable group and a center structure of molecule, since the compatibility with a liquid crystalline part is controlled, this is preferable and increases the compatibility with the liquid crystalline compound. Preferable alignment control monomers include Compound (A-1-1) to Compound (A-1-10), Compound (A-2-1), Compound (A-2-2), and Compound (A-3-1). In Compound (A-1-1) to Compound (A-1-10), Compound (A-2-1), Compound (A-2-2) and Compound (A-3-1), n and m are independently 2 to 6, and R¹⁰ independently represent a hydrogen atom, a methyl group, a fluorine atom or a trifluoromethyl group. The alignment control monomer may be used alone or two or more thereof may be used in combination.

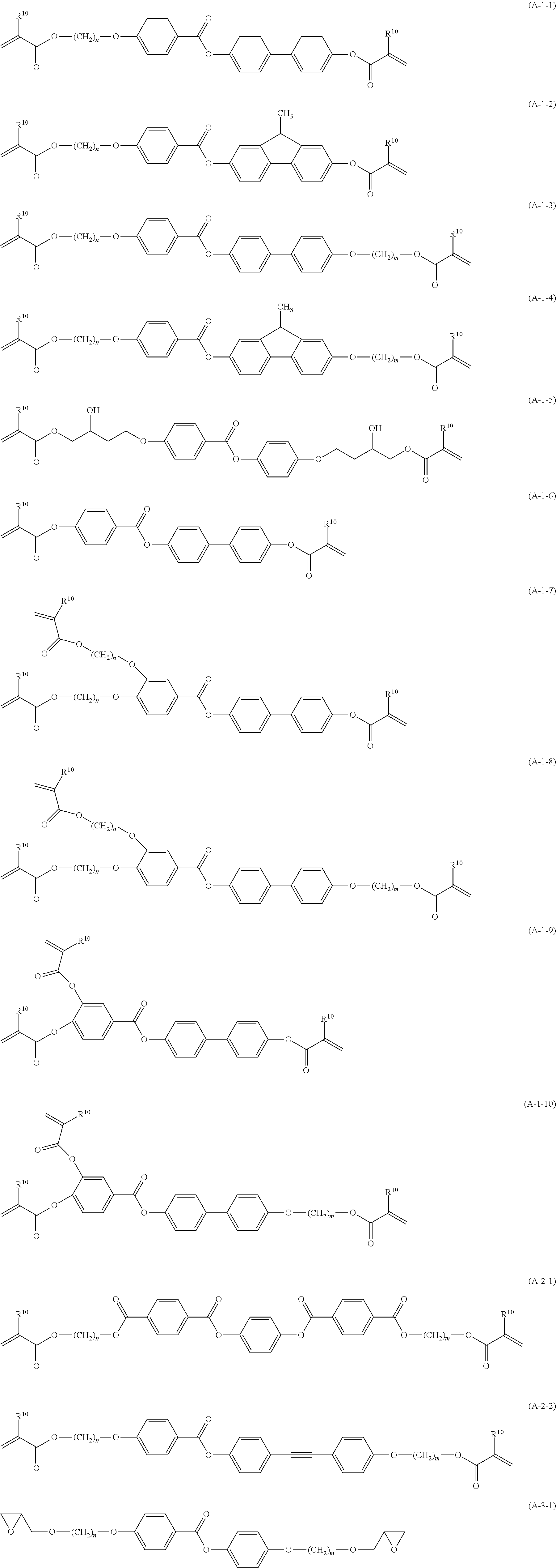

Preferably, Compound (1) is Compound (1-1) to Compound (1-35) described in Item 6. In these compounds, at least one first component is preferably Compound (1-4), Compound (1-12), Compound (1-14), Compound (1-15), Compound (1-17), Compound (1-18), Compound (1-23), Compound (1-24), Compound (1-27), Compound (1-29), or Compound (1-30). At least two first components are preferably a combination of Compound (1-12) and Compound (1-15), a combination of Compound (1-14) and Compound (1-27), a combination of Compound (1-18) and Compound (1-24), a combination of Compound (1-18) and Compound (1-29), a combination of Compound (1-24) and Compound (1-29), or a combination of Compound (1-29) and Compound (1-30).

Preferably, Compound (2) is Compound (2-1) to Compound (2-13) described in Item 9. In these compounds, at least one second component is preferably Compound (2-1), Compound (2-3), Compound (2-5), Compound (2-6), or Compound (2-7). At least two second components are preferably a combination of Compound (2-1) and Compound (2-5), a combination of Compound (2-1) and Compound (2-6), a combination of Compound (2-1) and Compound (2-7), a combination of Compound (2-3) and Compound (2-5), a combination of Compound (2-3) and Compound (2-6), or a combination of Compound (2-3) and Compound (2-7).

Preferably, Compound (3) is Compound (3-1) to Compound (3-22) described in Item 12. In these compounds, at least one third component is preferably Compound (3-1), Compound (3-3), Compound (3-4), Compound (3-6), Compound (3-8), or Compound (3-10). At least two third components are preferably a combination of Compound (3-1) and Compound (3-6), a combination of Compound (3-3) and Compound (3-6), a combination of Compound (3-3) and Compound (3-10), a combination of Compound (3-4) and Compound (3-6), a combination of Compound (3-4) and Compound (3-8), or a combination of Compound (3-6) and Compound (3-10).

Sixth, other additives that may be added to the composition will be described. Examples of the additive include an optically active compound, an antioxidant, a UV absorber, a dye, an antifoaming agent, a polymerizable compound, a polymerization initiator, a polymerization inhibitor, and a polar compound. An optically active compound is added to the composition in order to induce a liquid crystal helical structure and impart a twist angle. Examples of such a compound include Compound (Op-1) to Compound (Op-5). A preferable proportion of the optically active compound is about 5 parts by weight or less when a total amount of the liquid crystalline compound is 100 parts by weight. A more preferable proportion is in a range of about 0.01 parts by weight to about 2 parts by weight.

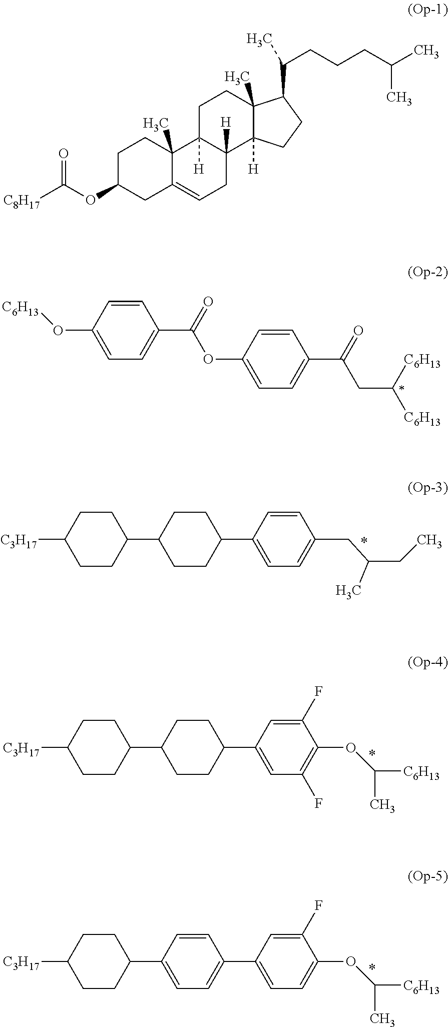

In order to prevent reduction in the specific resistance due to heating in air or to maintain a high voltage holding ratio not only at room temperature but also at a temperature close to the upper limit temperature after the element is used for a long time, an antioxidant is added to the composition. Preferable examples of the antioxidant include Compound (5) in which t is an integer of 1 to 9.

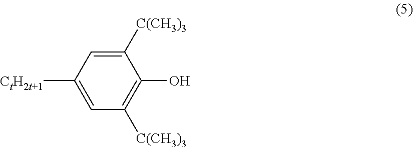

In Compound (5), preferably, t is, 1, 3, 5, 7, or 9. More preferably, t is 7. Since Compound (5) in which t is 7 has low volatility, it is effective in maintaining a high voltage holding ratio not only at room temperature but also at a temperature close to the upper limit temperature after the element is used for a long time. A preferable proportion of the antioxidant is about 50 ppm or more in order to obtain effects thereof and about 600 ppm or less in order to prevent the upper limit temperature from decreasing or the lower limit temperature from increasing. A more preferable proportion is in a range of about 100 ppm to about 300 ppm.

Preferable examples of the UV absorber include benzophenone derivatives, benzoate derivatives, and triazole derivatives. A light stabilizer such as a sterically hindered amine is preferable. A preferable proportion of such an absorber or stabilizer is about 50 ppm or more in order to obtain effects thereof and about 10,000 ppm or less in order to prevent the upper limit temperature from decreasing or the lower limit temperature from increasing. A more preferable proportion is in a range of about 100 ppm to about 10,000 ppm.

In order to adapt the composition to a guest host (GH) mode element, a dichroic dye such as an azo dye and an anthraquinone dye is added to the composition. A preferable proportion of the dye is in a range of about 0.01 weight % to about 10 weight %. In order to prevent foaming, an antifoaming agent such as dimethyl silicone oil and methylphenyl silicone oil is added to the composition. A preferable proportion of the antifoaming agent is about 1 ppm or more in order to obtain effects thereof and about 1,000 ppm or less in order to prevent display defects. A more preferable proportion is in a range of about 1 ppm to about 500 ppm.

In order to adapt the composition to a polymer sustained alignment (PSA) type element, a polymerizable compound different from the alignment control monomer is added to the composition. Preferable examples of the polymerizable compound include compounds having a polymerizable group such as an acrylate, a methacrylate, a vinyl compound, a vinyloxy compound, a propenyl ether, an epoxy compound (oxirane, oxetane), and a vinyl ketone. More preferable examples include acrylate or methacrylate derivatives. A preferable proportion of the polymerizable compound is about 0.05 parts by weight or more in order to obtain effects thereof and about 10 parts by weight or less in order to prevent display defects when a total amount of the liquid crystalline compound is 100 parts by weight. A more preferable proportion is in a range of about 0.1 parts by weight to about 2 parts by weight. The polymerizable compound is polymerized when UV light is exposed. Polymerization may be performed in the presence of an initiator such as a photopolymerization initiator. Appropriate conditions for polymerization, an appropriate type of an initiator, and an appropriate amount are known to those skilled in the art and described in the literature. For example, the photoinitiator Omnirad 651 (registered trademark; IGM Resins), Omnirad 184 (registered trademark; IGM Resins), or Omnirad 1173 (registered trademark; IGM Resins) is appropriate for radical polymerization. A preferable proportion of the photopolymerization initiator is in a range of about 0.1 parts by weight to about 5 parts by weight based on the weight of the polymerizable compound. A more preferable proportion is in a range of about 1 part by weight to about 3 parts by weight.

A polymerization inhibitor may be added in order to prevent polymerization when the polymerizable compound is stored. The polymerizable compound is generally added to the composition without removing the polymerization inhibitor. Examples of the polymerization inhibitor include hydroquinone derivatives such as hydroquinone and methylhydroquinone and 4-tert-butyl catechol, 4-methoxyphenol, and phenothiazine.

The polar compound is an organic compound having polarity. Here, a compound having an ionic bond is not included. Atoms such as oxygen, sulfur, and nitrogen are more electrically negative and tend to have a partially negative charge. Carbon and hydrogen are neutral but they tend to have a partially positive charge. The polarity occurs when partial charges are not uniformly distributed among different types of atoms in the compound. For example, the polar compound has at least one of partial structures such as —OH, —COOH, —SH, —NH₂, >NH, >N—.

Seventh, a method of synthesizing component compounds will be described. Such compounds can be synthesized by known methods. Synthesis methods are exemplified. Compound (1-1) is synthesized by a method described in Published Japanese Translation No. H2-503441 of the PCT International Publication. Compound (2-5) is synthesized by a method described in Japanese Unexamined Patent Application Publication No. S57-165328. Compound (3-18) is synthesized by a method described in Japanese Unexamined Patent Application Publication No. H7-101900. An antioxidant is commercially available. A compound in which n in Formula (5) is 1 is commercially available from Aldrich (Sigma-Aldrich Corporation). Compound (5) in which n is 7 and the like are synthesized by the method described in U.S. Pat. No. 3,660,505. Alignment control monomers having an aromatic ester group and a polymerizable group are synthesized according to methods described in PCT International Publication No. WO 1995/22586, Japanese Unexamined Patent Application Publication No. 2005-206579, PCT International Publication No. WO 2006/049111, Macromolecules, 26, 1244-1247 (1993), Japanese Unexamined Patent Application Publication No. 2003-238491, Japanese Unexamined Patent Application Publication No. 2000-178233, Japanese Unexamined Patent Application Publication No. 2012-1623, and Japanese Unexamined Patent Application Publication No. 2011-227187. An alignment control monomer having an α-fluoro acrylate group is synthesized according to the method described in Japanese Unexamined Patent Application Publication No. 2005-112850. An alignment control monomer having an α-trifluoromethyl acrylate group is synthesized according to the method described in Japanese Unexamined Patent Application Publication No. 2004-175728. An alignment control monomer having a tolan structure is synthesized according to PCT International Publication No. WO 2001/053248.

Compounds of which synthesis methods are not described can be synthesized by the methods described in a book such as Organic Syntheses (John Wiley & Sons, Inc.), Organic Reactions (John Wiley & Sons, Inc.), Comprehensive Organic Synthesis (Pergamon Press), and New Course of Experimental Chemistry (Maruzen). The composition is prepared using the compounds obtained in this manner according to a known method. For example, component compounds are mixed and then dissolved by heating.

Eighth, applications of the composition will be described. Most compositions have a lower limit temperature of about −10° C. or lower, an upper limit temperature of about 70° C. or higher, and an optical anisotropy in a range of about 0.07 to about 0.20. A composition having an optical anisotropy in a range of about 0.08 to about 0.25 may be prepared by controlling proportions of component compounds or mixing in other liquid crystalline compounds. In addition, a composition having an optical anisotropy in a range of about 0.10 to about 0.30 may be prepared by the method. An element containing the composition has a high voltage holding ratio. The composition is suitable for an AM element. The composition is particularly suitable for a transmissive type AM element. The composition can be used as a composition having a nematic phase and can be used as an optically active composition by adding an optically active compound.

The composition can be used for an AM element and also can be used for a PM element. The composition can be used for AM elements and PM elements having modes such as PC, TN, STN, ECB, OCB, IPS, FFS, VA, and FPA. The composition is particularly preferably used for an AM element having a VA, OCB, or IPS mode or an FFS mode. In an AM element having an IPS mode or FFS mode, when no voltage is applied, liquid crystal molecules are arranged parallel or perpendicular to a glass substrate. Such an element may be of a reflective type, a transmissive type or a semi-transmissive type. The composition is preferably used for a transmissive type element. The composition can be used for a non-crystalline silicon-TFT element or a polycrystal silicon-TFT element. The composition can be used for a nematic curvilinear aligned phase (NCAP) type element produced by microencapsulation and also can be used for a polymer dispersed (PD) type element in which a three-dimensional network polymer is formed in a composition.

Ninth, a method of producing an element will be described. In a first process, an alignment control monomer is added to a liquid crystal composition, and the composition is heated at a temperature higher than an upper limit temperature and dissolved. In a second process, the composition is injected to a liquid crystal display element. In a third process, polarized UV light is exposed while the liquid crystal composition is heated at a temperature higher than the upper limit temperature. The alignment control monomer undergoes photo-Fries rearrangement due to linearly polarized UV light and polymerization also proceeds simultaneously. A preferable integrated light quantity (J/cm²) is 0.1 to 20 J/cm² when linearly polarized UV light reaches the surface of the element. A preferable range of the integrated light quantity is 0.1 to 15 J/cm² and a more preferable range is 0.1 to 12 J/cm². The integrated light quantity (J/cm²) can be determined by illuminance (unit: mW/cm²) of UV light×exposure time (unit: sec). Temperature conditions when linearly polarized UV light is exposed are preferably set in the same manner as in the above heat treatment temperature. Since a time for which linearly polarized UV light is exposed is calculated from a lamp illuminance, it is preferable that light be exposed with an illuminance as high as possible in consideration of production efficiency. A polymer composed of an alignment control monomer is formed as a thin film on and fixed to the substrate. Since the compound is aligned in a certain direction at a molecular level, the thin film has a function as a liquid crystal alignment film. According to the method, it is possible to produce a liquid crystal display element having no alignment film of such as a polyimide.

### EXAMPLES

The present invention will be described in further detail with reference to examples. The present invention is not limited to such examples. The present invention includes a mixture of a composition of Example 1 and a composition of Example 2. The present invention also includes a mixture in which at least two of compositions of examples were mixed. The synthesized compound was identified by a method such as NMR analysis. The characteristics of the compound, the composition, and the element were measured by methods described below.

NMR analysis: DRX-500 (commercially available from Bruker BioSpin) was used for measurement. In ¹H-NMR measurement, a sample was dissolved in a deuterated solvent such as CDCl₃, and measurement was performed under conditions (room temperature, 500 MHz, and a cumulative number of 16 measurements). Tetramethyl silane was used as an internal reference. In ¹⁹F-NMR measurement, CFCl₃ was used as an internal reference, and a cumulative number of 24 measurements were performed. In description of nuclear magnetic resonance spectrums, s indicates a singlet, d indicates a doublet, t indicates a triplet, q indicates a quartet, quin indicates a quintet, sex indicates a sextet, m indicates a multiplet, and br indicates broad.

Gas chromatography analysis: A GC-14B type gas chromatograph (commercially available from Shimadzu Corporation) was used for measurement. A carrier gas was helium (2 mL/min). A sample vaporization chamber was set to 280° C., and detector (FID) was set to 300° C. A capillary column DB-1 (commercially available from Agilent Technologies Inc.) (with a length of 30 m, an inner diameter of 0.32 mm, a film thickness of 0.25 m w; a fixed liquid phase was dimethyl polysiloxane; nonpolar) was used for separation of component compounds. The column was left at 200° C. for 2 minutes and then heated to 280° C. at a rate of 5° C./min. The sample was prepared in an acetone solution (0.1 weight %) and then 1 μL thereof was injected into the sample vaporization chamber. As a recorder, C-R5A type Chromatopac (commercially available from Shimadzu Corporation) or a product equivalent thereto was used. In the obtained gas chromatogram, retention times of peaks corresponding to component compounds and areas of peaks were shown.

Regarding a solvent for diluting the sample, chloroform, hexane, or the like may be used. In order to separate component compounds, the following capillary columns may be used. HP-1 (commercially available from Agilent Technologies Inc.) (with a length of 30 m, an inner diameter of 0.32 mm, and a film thickness of 0.25 μm), Rtx-1 (commercially available from Restek Corporation) (with a length of 30 m, an inner diameter of 0.32 mm, and a film thickness of 0.25 μm), and BP-1 (commercially available from SGE International Pty. Ltd.) (with a length of 30 m, an inner diameter of 0.32 mm, and a film thickness of 0.25 μm) may be used. In order to prevent peaks of compounds from overlapping, a capillary column CBPi-M50-025 (commercially available from Shimadzu Corporation) (with a length of 50 m, an inner diameter of 0.25 mm, and a film thickness of 0.25 μm) may be used.

A proportion of the liquid crystalline compound contained in the composition may be calculated by the following method. A mixture of liquid crystalline compounds was detected through gas chromatography (FID). An area ratio of peaks in the gas chromatogram corresponded to a ratio (weight ratio) of liquid crystalline compounds. When the capillary column described above was used, a correction coefficient of each liquid crystalline compound may be considered as 1. Therefore, a proportion (weight %) of the liquid crystalline compound was able to be calculated from the area ratio of peaks.

Measurement sample: When characteristics of the composition and the element were measured, the composition was directly used as a sample. When a characteristic of a compound was measured, the compound (15 weight %) was mixed into a mother liquid crystal (85 weight %) to prepare a measurement sample. A characteristic value of the compound was calculated by extrapolation from the value obtained according to measurement. (extrapolated value)={(measured value of sample)−0.85×(measured value of mother liquid crystal)}/0.15. When a smectic phase (or a crystal) was precipitated at this proportion at 25° C., a ratio between the compound and the mother liquid crystal was changed in the order of 10 weight %:90 weight %, 5 weight %:95 weight %, and 1 weight %:99 weight %. Values of the upper limit temperature, optical anisotropy, viscosity, and dielectric anisotropy of the compound were determined by this extrapolation.

The following mother liquid crystals were used. Proportions of component compounds are indicated by weight %.

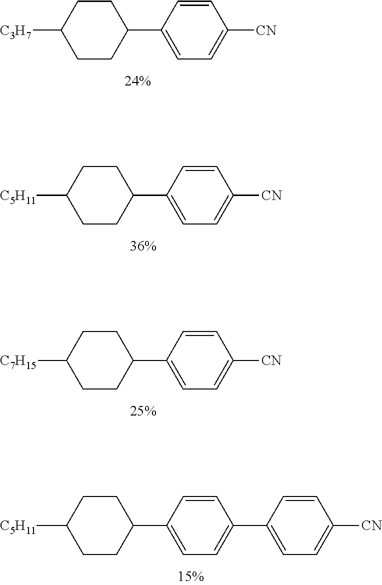

Measurement method: Characteristics were measured by the following method. Most of these were methods described in JEITA standards (JEITA⋅ED-2521B) discussed and established by Japan Electronics and Information Technology Industries Association (hereinafter referred to as JEITA) or modified methods thereof. A thin film transistor (TFT) was not attached to a TN element used for measurement.

(1) Upper limit temperature (NI; ° C.) of nematic phase: A sample was placed on a hot plate of a melting point measurement device including a polarizing microscope and heated at a rate of 1° C./min. A temperature at which a part of the sample changed from a nematic phase to an isotropic liquid was measured. The upper limit temperature of the nematic phase may be abbreviated as an “upper limit temperature.”
(2) Lower limit temperature (T_{C}; ° C.) of nematic phase: A sample having a nematic phase was put into a glass bottle and stored in a freezer at 0° C., −10° C., −20° C., −30° C., and −40° C. for 10 days, and a liquid crystal phase was then observed. For example, when the sample remained in a nematic phase at −20° C. and changed to a crystal or a smectic phase at −30° C., T_{C} is described as <−20° C. The lower limit temperature of the nematic phase may be abbreviated as a “lower limit temperature.”
(3) Viscosity (bulk viscosity; η; measured at 20° C.; mPa·s): An E type rotational viscometer (commercially available from Tokyo Keiki Co., Ltd.) was used for measurement.
(4) Viscosity (rotational viscosity; yl; measured at 25° C.; mPa·s): Measurement was performed according to a method described in M. Imai et al., Molecular Crystals and Liquid Crystals, Vol. 259, 37 (1995). The sample was inserted into a TN element in which a twist angle was 0° and an interval (cell gap) between two glass substrates was 5 μm. A voltage in a range of 16 V to 19.5 V was gradually applied to the element at intervals of 0.5 V. After no voltage was applied for 0.2 seconds, application was repeated under conditions of one square wave (rectangular pulse; 0.2 seconds) and no voltage application (2 seconds). A peak current and a peak time of a transient current generated by this application were measured. A value of the rotational viscosity was obtained from these measured values and Calculation Formula (8) on page 40 in the paper (M. Imai). A value of dielectric anisotropy necessary for this calculation was measured in Section (6) using the element for which the rotational viscosity was measured.
(5) Optical anisotropy (refractive index anisotropy; Δn; measured at 25° C.): Measurement was performed by an Abbe refractometer in which a polarizing plate was attached to an eyepiece using light with a wavelength of 589 nm. A surface of a main prism was rubbed in one direction, and the sample was then added dropwise onto the main prism. A refractive index n∥ was measured when a direction of polarized light was parallel to a rubbing direction. A refractive index n⊥ was measured when a direction of polarized light was perpendicular to a rubbing direction. A value of optical anisotropy was calculated from the formula Δn=n∥−n⊥.
(6) Dielectric anisotropy (Δε; measured at 25° C.): The sample was inserted into a TN element in which an interval (cell gap) between two glass substrates was 9 μm and a twist angle was 80 degrees. A sine wave (10 V, 1 kHz) was applied to the element and after 2 seconds, a dielectric constant (ε∥) in a long axis direction of liquid crystal molecules was measured. A sine wave (0.5 V, 1 kHz) was applied to the element, and after 2 seconds, a dielectric constant (ε⊥) in a short axis direction of liquid crystal molecules was measured. A value of dielectric anisotropy was calculated from the formula Δε=ε∥−ε⊥.
(7) Threshold voltage (Vth; measured at 25° C.; V): An LCD5100 type luminance meter (commercially available from Otsuka Electronics Co., Ltd.) was used for measurement. A light source was a halogen lamp. The sample was inserted into a TN element in a normally white mode in which an interval (cell gap) between two glass substrates was 0.45/Δn (μm) and a twist angle was 80 degrees. A voltage (32 Hz, square wave) applied to the element was gradually increased by 0.02 V from 0 V to 10 V. In this case, light was emitted to the element in a vertical direction and a quantity of light that had passed through the element was measured. A voltage-transmittance curve in which the transmittance was 100% when the quantity of light was a maximum and the transmittance was 0% when the quantity of light was a minimum was created. A threshold voltage was a voltage when the transmittance was 90%.
(8) Voltage holding ratio (VHR-1; measured at 25° C.; %): A TN element used for measurement had a polyimide alignment film and had an interval (cell gap) between two glass substrates of 5 μm. The element was sealed using an adhesive that was cured with UV light after the sample was inserted. A pulse voltage (at 5 V for 60 microseconds) was applied to the TN element for charging. An attenuating voltage was measured for 16.7 milliseconds by a high-speed voltmeter, and an area A between a voltage curve in a unit cycle and the horizontal axis was obtained. An area B was an area when the voltage was not attenuated. A voltage holding ratio was expressed as a percentage of the area A with respect to the area B.
(9) Voltage holding ratio (VHR-2; measured at 80° C.; %): A voltage holding ratio was measured in the same procedure as in the above method except that the voltage holding ratio was measured at 80° C. instead of 25° C. The obtained value was expressed as VHR-2.
(10) Voltage holding ratio (VHR-3; measured at 25° C.; %): After UV light was exposed, a voltage holding ratio was measured, and stability with respect to UV light was evaluated. A TN element used for measurement had a polyimide alignment film and a cell gap of 5 μm. The sample was injected into the element and light was exposed for 20 minutes. A light source was an super high pressure mercury lamp USH-500D (commercially available from Ushio Inc) and an interval between the element and the light source was 20 cm. In VHR-3 measurement, an attenuating voltage was measured for 16.7 milliseconds. A composition having a large VHR-3 had high stability with respect to UV light. VHR-3 is preferably 90% or more and more preferably 95% or more.
(11) Voltage holding ratio (VHR-4; measured at 25° C.; %): A TN element into which the sample was injected was heated in a constant temperature chamber at 80° C. for 500 hours and a voltage holding ratio was then measured, and stability with respect to heat was evaluated. In VHR-4 measurement, an attenuating voltage was measured for 16.7 milliseconds. A composition having a large VHR-4 had high stability with respect to heat.
(12) Response time (T; measured at 25° C.; ms): An LCD5100 type luminance meter (commercially available from Otsuka Electronics Co., Ltd.) was used for measurement. A light source was a halogen lamp. A low pass filter was set at 5 kHz. The sample was inserted into a TN element in a normally white mode in which an interval (cell gap) between two glass substrates was 5.0 m and a twist angle was 80 degrees. A square wave (60 Hz, 5 V, 0.5 seconds) was applied to the element. In this case, light was emitted to the element in a vertical direction and a quantity of light that had passed through the element was measured. The transmittance was 100% when the quantity of light was a maximum, and the transmittance was 0% when the quantity of light was a minimum. A rise time (τr; millisecond) was a time required for the transmittance to change from 90% to 10%. A fall time (τf; millisecond) was a time for the transmittance to change from 10% to 90%. A response time was a sum of the rise time and the fall time obtained in this manner.
(13) Elastic constant (K; measured at 25° C.; pN): An HP4284A type LCR meter (commercially available from Yokogawa-Hewlett-Packard Company) was used for measurement. The sample was inserted into a horizontally aligned element in which an interval (cell gap) between two glass substrates was 20 μm. A charge of 0 V to 20 V was applied to the element, and an electrostatic capacitance and an applied voltage were measured. These measured values of the electrostatic capacitance (C) and the applied voltage (V) were fitted using Formula (2.98) and Formula (2.101) on page 75 in “Liquid Crystal Device Handbook” (commercially available from Nikkan Kogyo Shimbun, Ltd.), and values of K11 and K33 were obtained from Formula (2.99). Next, in Formula (3.18) on page 171, K22 was calculated using the values of K11 and K33 obtained above. An elastic constant was expressed as an average value of K11, K22, and K33 obtained in this manner.
(14) Specific resistance (p; measured at 25° C.; Ωcm): 1.0 mL of a sample was injected into a container including an electrode. A DC voltage (10 V) was applied to the container and a direct current was measured after 10 seconds. A specific resistance was calculated from the following formula. (Specific resistance)={(voltage)×(electric capacitance of container)}/{(direct current)×(dielectric constant of vacuum)}.
(15) Helical pitch (P; measured at room temperature; μm): A helical pitch was measured using a wedge method. Page 196 in “Liquid Crystal Handbook” (published in 2000, Maruzen) was referred to. The sample was injected into a wedge cell and left at room temperature for 2 hours and a disclination line interval (d2−d1) was then observed under a polarizing microscope (commercially available from Nikon Corporation, product name MM40/60 series). A helical pitch (P) was calculated from the following formula in which an angle of the wedge cell was expressed as θ. P=2×(d2−d1)×tan θ.

Compounds in examples are indicated by symbols based on definitions in the following Table 3. In Table 3, the configuration related to 1,4-cyclohexylene is trans. A number in a number in parentheses after a symbol indicates corresponds to a number of the compound. The symbol (−) refers to other liquid crystalline compounds. A proportion (percentage) of the liquid crystalline compound is a weight percentage (weight %) based on the weight of the liquid crystal composition. Finally, characteristic values of the composition are summarized.

TABLE 3
Method of representing compound using symbols
R-(A₁)-Z₁ . . . Zₙ-(Aₙ)-R′

| 1) Left terminal group R— | symbols |
|---|---|
| CₙH₂ₙ₊₁— | n— |
| CₙH₂ₙ₊₁O— | nO— |
| CₘH₂ₘ₊₁OCₙH₂ₙ— | mOn— |
| CH₂═CH— | V— |
| CₙH₂ₙ₊₁—CH═CH— | nV— |
| CH₂═CH—CₙH₂ₙ— | Vn— |
| CₘH₂ₘ₊₁—CH═CH—CₙH₂ₙ— | mVn— |
| CF₂═CH— | VFF— |
| CF₂═CH—CₙH₂ₙ— | VFFn— |
| F—CₙH₂ₙ— | Fn— |
| 2) Right terminal group —R′ | symbols |
| —CₙH₂ₙ₊₁ | —n |
| —OCₙH₂ₙ₊₁ | —On |
| —CH═CH₂ | —V |
| —CH═CH—CₙH₂ₙ₊₁ | —Vn |
| —CₙH₂ₙ—CH═CH₂ | —nV |
| —CₙH₂ₙ—CH═CH—CₘH₂ₘ₊₁ | —nVm |
| —CH═CF₂ | —VFF |
| —COOCH₃ | —EMe |
| —F | —F |
| —Cl | —CL |
| —OCF₃ | —OCF3 |
| —CF₃ | —CF3 |
| —CN | —C |
| —CF═CH—CF₃ | —FVCF3 |
| 3) Linking group —Zₙ— | symbols |
| —C₂H₄— | 2 |
| —COO— | E |
| —CH═CH— | V |
| —C≡C— | T |
| —CF₂O— | X |
| —OCF₂— | x |
| —CH₂O— | 10 |
| —CF═CF— | VFF |
| —CH═CF— | VF |
| 4) Ring structure —Aₙ— | symbols |
| 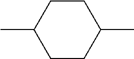 | H |
| 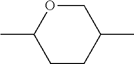 | Dh |
| 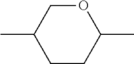 | dh |
| 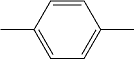 | B |
| 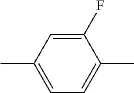 | B(F) |
| 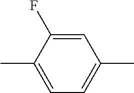 | B(2F) |
| 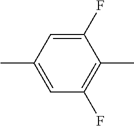 | B(F,F) |
| 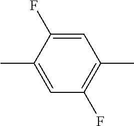 | B(2F,5F) |
| 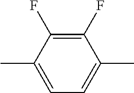 | B(2F,3F) |
| 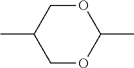 | G |
| 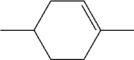 | ch |
| 5) Representation examples | |
| Example 1 | 3—BB(F,F)XB(F,F)—F |
| | 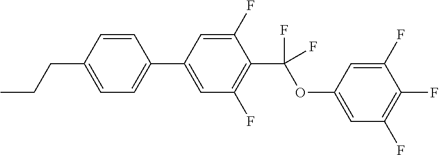 [SMILES: CCCc1ccc(-c2cc(F)c(C(F)(F)Oc3cc(F)c(F)c(F)c3)c(F)c2)cc1] |
| Example 2 | 3—HH—V |
| | 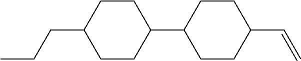 [SMILES: C=CC1CCC(C2CCC(CCC)CC2)CC1] |
| Example 3 | 3—BB(F)B(F,F)—F |
| | 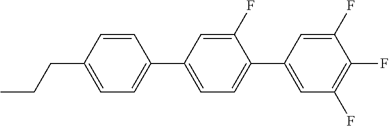 [SMILES: CCCc1ccc(-c2ccc(-c3cc(F)c(F)c(F)c3)c(F)c2)cc1] |
| Example 4 | 3—HBB(2F,3F)—O2 |
| | 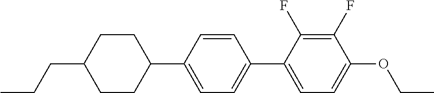 [SMILES: CCCC1CCC(c2ccc(-c3ccc(OCC)c(F)c3F)cc2)CC1] |

### Examples of Elements

### 1. Materials

A composition in which an alignment control monomer was added was injected into an element having no alignment film. After linearly polarized light was exposed, alignment of liquid crystal molecules in the element was checked. First, materials will be described. Additives were excluded in the materials, and liquid crystal compositions were compositions such as Composition (M1) to Composition (M20), and a first additive was appropriately selected from among alignment control monomers as will be described below. The compositions are as follows.

### [Composition (M1)]

| | | |
|---|---|---|
| 3-HHXB(F, F)-F | (1-4) | 6% |
| 3-BB(F, F)XB(F, F)-F | (1-18) | 13% |
| 3-HHBB(F, F)-F | (1-19) | 4% |
| 4-HHBB(F, F)-F | (1-19) | 5% |
| 3-HBBXB(F, F)-F | (1-23) | 3% |
| 3-BB(F)B(F, F)XB(F)-F | (1-28) | 2% |
| 4-BB(F)B(F, F)XB(F, F)-F | (1-29) | 8% |
| 5-BB(F)B(F, F)XB(F, F)-F | (1-29) | 7% |
| 3-HH-V | (2-1) | 44% |
| V-HHB-1 | (2-5) | 6% |
| 2-BB(F)B-3 | (2-8) | 2% |

NI = 79.8° C.; Tc<−30° C.; Δn = 0.106; Δε = 8.5; Vth = 1.45 V; η = 11.6 mPa • s; γl = 60.0 mPa • s.

### [Composition (M2)]

| | | |
|---|---|---|
| 5-HXB(F, F)-F | (1-1) | 3% |
| 3-HHXB(F, F)-F | (1-4) | 3% |
| 3-HHXB(F, F)-CF3 | (1-5) | 3% |
| 3-HGB(F, F)-F | (1-6) | 3% |
| 3-HB(F)B(F, F)-F | (1-9) | 5% |
| 3-BB(F, F)XB(F, F)-F | (1-18) | 6% |
| 3-HHBB(F, F)-F | (1-19) | 6% |
| 5-BB(F)B(F, F)XB(F)B(F, F)-F | (1-31) | 2% |
| 3-BB(2F, 3F)XB(F, F)-F | (1-32) | 4% |
| 3-B(2F, 3F)BXB(F, F)-F | (1-33) | 5% |
| 3-HHB(F, F)XB(F, F)-F | (1) | 4% |
| 3-HB-CL | (1) | 3% |
| 3-HHB-OCF3 | (1) | 3% |
| 3-HH-V | (2-1) | 22% |
| 3-HH-V1 | (2-1) | 10% |
| 5-HB-O2 | (2-2) | 5% |
| 3-HHEH-3 | (2-4) | 3% |
| 3-HBB-2 | (2-6) | 7% |
| 5-B(F)BB-3 | (2-7) | 3% |

NI = 71.2° C.; Tc<−20° C.; Δn = 0.099; Δε = 6.1; Vth = 1.74 V; η = 13.2 mPa • s; γl = 59.3 mPa • s.

### [Composition (M3)]

| | | |
|---|---|---|
| 5-HXB(F, F)-F | (1-1) | 6% |
| 3-HHXB(F, F)-F | (1-4) | 6% |
| V-HB(F)B(F, F)-F | (1-9) | 5% |
| 3-HHB(F)B(F, F)-F | (1-20) | 7% |
| 2-BB(F)B(F, F)XB(F)-F | (1-29) | 3% |
| 3-BB(F)B(F, F)XB(F)-F | (1-29) | 3% |
| 4-BB(F)B(F, F)XB(F)-F | (1-29) | 4% |
| 5-HB-CL | (1) | 5% |
| 2-HH-5 | (2-1) | 8% |
| 3-HH-V | (2-1) | 10% |
| 3-HH-V1 | (2-1) | 7% |
| 4-HH-V | (2-1) | 10% |
| 4-HH-V1 | (2-1) | 8% |
| 5-HB-O2 | (2-2) | 7% |
| 4-HHEH-3 | (2-4) | 3% |
| 1-BB(F)B-2 V | (2-8) | 3% |
| 1O1-HBBH-3 | (—) | 5% |

NI = 78.5° C.; Tc<−20° C.; Δn = 0.095; Δε = 3.4; Vth = 1.50 V; η = 8.4 mPa • s; γl = 54.2 mPa • s.

### [Composition (M4)]

| | | |
|---|---|---|
| 3-HHEB(F, F)-F | (1-3) | 5% |
| 3-HHXB(F, F)-F | (1-4) | 7% |
| 5-HBEB(F, F)-F | (1-10) | 5% |
| 3-BB(F, F)XB(F, F)-F | (1-18) | 10% |
| 2-HHB(F)B(F, F)-F | (1-20) | 3% |
| 3-HB(2F, 3F)BXB(F, F)-F | (1-34) | 3% |
| 3-BB(2F, 3F)BXB(F, F)-F | (1-35) | 2% |
| 5-HHB(F, F)XB(F, F)-F | (1) | 6% |
| 2-HH-3 | (2-1) | 8% |
| 3-HH-V | (2-1) | 20% |
| 3-HH-V1 | (2-1) | 7% |
| 4-HH-V | (2-1) | 6% |
| 5-HB-O2 | (2-2) | 5% |
| V2-B2BB-1 | (2-9) | 3% |
| 3-HHEBH-3 | (2-11) | 5% |
| 3-HHEBH-5 | (2-11) | 5% |

NI = 90.3° C.; Tc<−20° C.; Δn = 0.089; Δε = 5.5; Vth = 1.65 V; η = 13.6 mPa • s; γl = 60.1 mPa • s.

### [Composition (M5)]

| | | |
|---|---|---|
| 3-BB(F, F)XB(F, F)-F | (1-18) | 12% |
| 3-HHBB(F, F)-F | (1-19) | 5% |
| 4-HHBB(F, F)-F | (1-19) | 4% |
| 3-HBBXB(F, F)-F | (1-23) | 3% |
| 3-BB(F)B(F, F)XB(F)-F | (1-28) | 3% |
| 3-BB(F)B(F, F)XB(F, F)-F | (1-29) | 3% |
| 4-BB(F)B(F, F)XB(F, F)-F | (1-29) | 5% |
| 5-BB(F)B(F, F)XB(F, F)-F | (1-29) | 4% |
| 2-HH-3 | (2-1) | 6% |
| 3-HH-5 | (2-1) | 6% |
| 3-HH-V | (2-1) | 25% |
| 3-HH-VFF | (2-1) | 6% |
| 5-HB-O2 | (2-2) | 7% |
| V-HHB-1 | (2-5) | 6% |
| V-HBB-2 | (2-6) | 5% |

NI = 78.3° C.; Tc<−20° C.; Δn = 0.107; Δε = 7.0; Vth = 1.55 V; η = 11.6 mPa • s; γl = 55.6 mPa • s.

### [Composition (M6)]

| | | |
|---|---|---|
| 3-HHXB(F, F)-F | (1-4) | 3% |
| 3-BBXB(F, F)-F | (1-17) | 3% |
| 3-BB(F, F)XB(F, F)-F | (1-18) | 8% |
| 3-HHBB(F, F)-F | (1-19) | 5% |
| 4-HHBB(F, F)-F | (1-19) | 4% |
| 3-BB(F)B(F, F)XB(F, F)-F | (1-29) | 3% |
| 4-BB(F)B(F, F)XB(F, F)-F | (1-29) | 6% |
| 5-BB(F)B(F, F)XB(F, F)-F | (1-29) | 5% |
| 3-HH-V | (2-1) | 30% |
| 3-HH-V1 | (2-1) | 5% |
| 3-HHB-O1 | (2-5) | 2% |
| V-HHB-1 | (2-5) | 5% |
| 2-BB(F)B-3 | (2-8) | 6% |
| F3-HH-V | (—) | 15% |

NI = 80.4° C.;
Tc <− 20° C.;
Δn = 0.106;
Δε = 5.8;
Vth = 1.40 V;
η = 11.6 mPa · s;
γ1 = 61.0 mPa · s.

### [Composition (M7)]

| | | |
|---|---|---|
| 3-HGB(F, F)-F | (1-6) | 3% |
| 5-GHB(F, F)-F | (1-7) | 4% |
| 3-GB(F, F)XB(F, F)-F | (1-14) | 5% |
| 3-BB(F)B(F, F)-CF3 | (1-16) | 2% |
| 3-HHBB(F, F)-F | (1-19) | 4% |
| 3-GBB(F)B(F, F)-F | (1-22) | 2% |
| 2-dhBB(F, F)XB(F, F)-F | (1-25) | 4% |
| 3-GB(F)B(F, F)XB(F, F)-F | (1-27) | 3% |
| 3-HGB(F, F)XB(F, F)-F | (1) | 5% |
| 7-HB(F, F)-F | (1) | 3% |
| 2-HH-3 | (2-1) | 14% |
| 2-HH-5 | (2-1) | 4% |
| 3-HH-V | (2-1) | 26% |
| 1V2-HH-3 | (2-1) | 5% |
| 1V2-BB-1 | (2-3) | 3% |
| 2-BB(F)B-3 | (2-8) | 3% |
| 3-HB(F)HH-2 | (2-10) | 4% |
| 5-HBB(F)B-2 | (2-13) | 6% |

NI = 78.4° C.;
Tc <− 20° C.;
Δn = 0.094;
Δε = 5.6;
Vth = 1.45 V;
η = 11.5 mPa · s;
γ1 = 61.7 mPa · s.

### [Composition (M8)]

| | | |
|---|---|---|
| 3-HBB(F, F)-F | (1-8) | 5% |
| 5-HBB(F, F)-F | (1-8) | 4% |
| 3-BB(F)B(F, F)-F | (1-15) | 3% |
| 3-BB(F)B(F, F)XB(F, F)-F | (1-29) | 3% |
| 4-BB(F)B(F, F)XB(F, F)-F | (1-29) | 5% |
| 3-BB(F, F)XB(F)B(F, F)-F | (1-30) | 3% |
| 5-BB(F)B(F, F)XB(F)B(F, F)-F | (1-31) | 4% |
| 3-HH2BB(F, F)-F | (1) | 3% |
| 4-HH2BB(F, F)-F | (1) | 3% |
| 2-HH-5 | (2-1) | 8% |
| 3-HH-V | (2-1) | 25% |
| 3-HH-V1 | (2-1) | 7% |
| 4-HH-V1 | (2-1) | 6% |
| 5-HB-O2 | (2-2) | 5% |
| 7-HB-1 | (2-2) | 5% |
| VFF-HHB-O1 | (2-5) | 8% |
| VFF-HHB-1 | (2-5) | 3% |

NI = 80.0° C.;
Tc <− 20° C.;
Δn = 0.101;
Δε = 4.6;
Vth = 1.71 V;
η = 11.0 mPa · s;
γ1 = 47.2 mPa · s.

### [Composition (M9)]

| | | |
|---|---|---|
| 3-HHB(F, F)-F | (1-2) | 8% |
| 3-GB(F)B(F)-F | (1-11) | 2% |
| 3-GB(F)B(F, F)-F | (1-12) | 3% |
| 3-BB(F, F)XB(F, F)-F | (1-18) | 8% |
| 3-GB(F)B(F, F)XB(F, F)-F | (1-27) | 6% |
| 5-GB(F)B(F, F)XB(F, F)-F | (1-27) | 5% |
| 3-HH-V | (2-1) | 30% |
| 3-HH-V1 | (2-1) | 10% |
| 1V2-HH-3 | (2-1) | 8% |
| 3-HH-VFF | (2-1) | 8% |
| V2-BB-1 | (2-3) | 2% |
| 5-HB(F)BH-3 | (2-12) | 5% |
| 5-HBBH-3 | (2) | 5% |

NI = 78.6° C.;
Tc <− 20° C.;
Δn = 0.088;
Δε = 5.6;
Vth = 1.85 V;
η = 13.9 mPa · s;
γ1 = 66.9 mPa · s.

### [Composition (M10)]

| | | |
|---|---|---|
| 3-HHEB(F, F)-F | (1-3) | 4% |
| 5-HHEB(F, F)-F | (1-3) | 3% |
| 3-HBEB(F, F)-F | (1-10) | 3% |
| 5-HBEB(F, F)-F | (1-10) | 3% |
| 3-BB(F)B(F, F)-F | (1-15) | 3% |
| 3-GB(F)B(F, F)XB(F, F)-F | (1-27) | 5% |
| 4-GB(F)B(F, F)XB(F, F)-F | (1-27) | 5% |
| 5-HB-CL | (1) | 5% |
| 3-HHB-OCF3 | (1) | 4% |
| 3-HHB(F, F)XB(F, F)-F | (1) | 5% |
| 5-HHB(F, F)XB(F, F)-F | (1) | 3% |
| 3-HGB(F, F)XB(F, F)-F | (1) | 5% |
| 2-HH-5 | (2-1) | 3% |
| 3-HH-5 | (2-1) | 5% |
| 3-HH-V | (2-1) | 24% |
| 4-HH-V | (2-1) | 5% |
| 1V2-HH-3 | (2-1) | 5% |
| 3 -HHEH-3 | (2-4) | 5% |
| 5-B(F)BB-2 | (2-7) | 3% |
| 5-B(F)BB-3 | (2-7) | 2% |

NI = 82.9° C.;
Tc <− 20° C.;
Δn = 0.093;
Δε = 6.9;
Vth = 1.50 V;
η = 16.3 mPa · s;
γ1 = 65.2 mPa · s.

### [Composition (M11)]

| | | |
|---|---|---|
| 3-HHXB(F, F)-F | (1-4) | 9% |
| 3-HBB(F, F)-F | (1-8) | 3% |
| 3-BB(F)B(F, F)-F | (1-15) | 4% |
| 3-BB(F)B(F, F)-CF3 | (1-16) | 4% |
| 3-BB(F, F)XB(F, F)-F | (1-18) | 5% |
| 3-GBB(F)B(F, F)-F | (1-22) | 3% |
| 4-GBB(F)B(F, F)-F | (1-22) | 4% |
| 3-HH-V | (2-1) | 25% |
| 3-HH-V1 | (2-1) | 10% |
| 5-HB-O2 | (2-2) | 10% |
| 7-HB-1 | (2-2) | 5% |
| V2-BB-1 | (2-3) | 3% |
| 3-HHB-1 | (2-5) | 4% |
| 1V-HBB-2 | (2-6) | 5% |
| 5-HBB(F)B-2 | (2-13) | 6% |

NI = 79.6° C.;
Tc <− 20° C.;
Δn = 0.111;
Δε = 4.7;
Vth = 1.86 V;
η = 9.7 mPa · s;
γ1 = 49.9 mPa · s.

### [Composition (M12)]

| | | |
|---|---|---|
| 3-BB(F, F)XB(F, F)-F | (1-18) | 14% |
| 5-BB(F)B(F, F)XB(F, F)-F | (1-29) | 7% |
| 7-HB(F, F)-F | (1) | 6% |
| 2-HH-5 | (2-1) | 5% |
| 3-HH-V | (2-1) | 30% |
| 3-HH-V1 | (2-1) | 3% |
| 3-HH-VFF | (2-1) | 10% |
| 3-HHB-1 | (2-5) | 4% |
| 3-HHB-3 | (2-5) | 5% |
| 3-HHB-O1 | (2-5) | 3% |
| 1-BB(F)B-2V | (2-8) | 3% |
| 3-HHEBH-3 | (2-11) | 3% |
| 3-HHEBH-4 | (2-11) | 4% |
| 3-HHEBH-5 | (2-11) | 3% |

NI = 83.0° C.;
Tc <− 20° C.;
Δn = 0.086;
Δε = 3.8;
Vth = 1.94 V;
η = 7.5 mPa · s;
γ1 = 51.5 mPa · s.

### [Composition (M13)]

| | | |
|---|---|---|
| 3-HBB(F, F)-F | (1-8) | 5% |
| 5-HBB(F, F)-F | (1-8) | 4% |
| 3-BB(F)B(F, F)-F | (1-15) | 3% |
| 3-BB(F)B(F, F)XB(F, F)-F | (1-29) | 3% |
| 4-BB(F)B(F, F)XB(F, F)-F | (1-29) | 5% |
| 3-BB(F, F)XB(F)B(F, F)-F | (1-30) | 3% |
| 5-BB(F)B(F, F)XB(F)B(F, F)-F | (1-31) | 4% |
| 3-HH2BB(F, F)-F | (1) | 3% |
| 4-HH2BB(F, F)-F | (1) | 3% |
| 2-HH-5 | (2-1) | 8% |
| 3-HH-V | (2-1) | 28% |
| 4-HH-V1 | (2-1) | 7% |
| 5-HB-O2 | (2-2) | 2% |
| 7-HB-1 | (2-2) | 5% |
| VFF-HHB-O1 | (2-5) | 8% |
| VFF-HHB-1 | (2-5) | 3% |
| 2-BB(2F, 3F)B-3 | (3-9) | 4% |
| 3-HBB(2F, 3F)-O2 | (3-10) | 2% |

NI = 81.9° C.;
Tc <− 20° C.;
Δn = 0.109;
Δε = 4.8;
Vth = 1.75 V;
η = 13.3 mPa · s;
γ1 = 57.4 mPa · s.

### [Composition (M14)]

| | | |
|---|---|---|
| 3-HHEB(F, F)-F | (1-3) | 4% |
| 3-HBEB(F, F)-F | (1-10) | 3% |
| 5-HBEB(F, F)-F | (1-10) | 3% |
| 3-BB(F)B(F, F)-F | (1-15) | 3% |
| 3-HBBXB(F, F)-F | (1-23) | 6% |
| 4-GBB(F, F)XB(F, F)-F | (1-26) | 2% |
| 5-GBB(F, F)XB(F, F)-F | (1-26) | 2% |
| 3-GB(F)B(F, F)XB(F, F)-F | (1-27) | 5% |
| 4-GB(F)B(F, F)XB(F, F)-F | (1-27) | 5% |
| 5-HHB(F, F)XB(F, F)-F | (1) | 3% |
| 5-HEB(F, F)-F | (1) | 3% |
| 5-HB-CL | (1) | 2% |
| 3-HHB-OCF3 | (1) | 4% |
| 3-HH-5 | (2-1) | 4% |
| 3-HH-V | (2-1) | 21% |
| 3-HH-V1 | (2-1) | 3% |
| 4-HH-V | (2-1) | 4% |
| 1V2-HH-3 | (2-1) | 6% |
| 5-B(F)BB-2 | (2-7) | 3% |
| 5-B(F)BB-3 | (2-7) | 2% |
| 3-HB(2F, 3F)-O2 | (3-1) | 3% |
| 3-BB(2F, 3F)-O2 | (3-4) | 2% |
| 3-HHB(2F, 3F)-O2 | (3-6) | 4% |
| F3-HH-V | (—) | 3% |

NI = 78.2° C.;
Tc <− 20° C.;
Δn = 0.101;
Δε = 6.7;
Vth = 1.45 V;
η = 17.8 mPa · s;
γ1 = 67.8 mPa · s.

### [Composition (M15)]

| | | |
|---|---|---|
| 3-HHB(F, F)-F | (1-2) | 10% |
| 3-HHXB(F, F)-F | (1-4) | 2% |
| 3-GHB(F, F)-F | (1-7) | 5% |
| 3-BB(F)B(F, F)-F | (1-15) | 6% |
| 3-BB(F, F)XB(F, F)-F | (1-18) | 14% |
| 4-BB(F)B(F, F)XB(F, F)-F | (1-29) | 10% |
| 5-BB(F)B(F, F)XB(F, F)-F | (1-29) | 6% |
| 2-HH-3 | (2-1) | 5% |
| 3-HH-4 | (2-1) | 11% |
| 3-HH-O1 | (2-1) | 5% |
| 5-HB-O2 | (2-2) | 8% |
| 3-HHB-1 | (2-5) | 6% |
| 3-HHB-3 | (2-5) | 6% |
| 3-HHB-O1 | (2-5) | 6% |

NI = 77.6° C.;
Tc <− 20° C.;
Δn = 0.109;
Δε = 10.6;
Vth = 1.34 V;
η = 22.6 mPa · s;
γ1 = 92.4 mPa · s.

### [Composition (M16)]

| | | |
|---|---|---|
| 3-HBB-F | (1) | 3% |
| 3-BB(F, F)XB(F)-OCF3 | (1) | 3% |
| 3-HHB(F)-F | (1) | 3% |
| 3-HGB(F, F)-F | (1-6) | 3% |
| 5-GHB(F, F)-F | (1-7) | 3% |
| 3-HBB(F, F)-F | (1-8) | 4% |
| 3-BB(F, F)XB(F, F)-F | (1-18) | 5% |
| 3-HHBB(F, F)-F | (1-19) | 5% |
| 3-HBBX(F, F)-F | (1-23) | 5% |
| 3-BBVFFXB(F, F)-F | (1-37) | 8% |
| 3-HH-V | (2-1) | 39% |
| 1-HH-V1 | (2-1) | 3% |
| 1-HH-2V1 | (2-1) | 4% |
| 3-HHEH-5 | (2-4) | 3% |
| 1-BB(F)B-2V | (2-8) | 3% |
| 3-HHEBH-3 | (2-11) | 3% |
| 5-HBB(F)B-2 | (2-13) | 3% |

NI = 85.2° C.;
Tc <− 20° C.;
Δn = 0.102;
Δε = 4.1;
γ1 = 43.0 mPa · s.

### [Composition (M17)]

| | | |
|---|---|---|
| 3-HHBB(F)-F | (1) | 3% |
| 2-HHEB(F, F)-F | (1-3) | 3% |
| 5-BB(F)B(F, F)-F | (1-15) | 7% |
| 3-HHB(F)B(F, F)-F | (1-20) | 3% |
| 3-GB(F)B(F, F)XB(F, F)-F | (1-27) | 3% |
| 3-BB(F, F)XB(F)B(F, F)-F | (1-30) | 3% |
| 3-HHVFFXB(F, F)-F | (1-38) | 5% |
| 3-BBVFFXB(F, F)-F | (1-37) | 5% |
| 3-HBBVFFXB(F, F)-F | (1-39) | 3% |
| 2-HH-5 | (2-1) | 5% |
| 3-HH-V | (2-1) | 20% |
| 5-HH-V | (2-1) | 12% |
| 3-HH-V1 | (2-1) | 4% |
| 4-HH-V1 | (2-1) | 5% |
| 2-HH-2V1 | (2-1) | 3% |
| 1-BB-3 | (2-3) | 3% |
| V2-BB(F)B-1 | (2-8) | 5% |
| V2-B(F)BB-1 | (2-7) | 5% |
| 3-HB(F)HH-5 | (2-10) | 3% |

NI = 85.8° C.;
Tc <− 20° C.;
Δn = 0.115;
Δε = 4.2;
γ1 = 41.4 mPa · s.

### [Composition (M18)]

| | | |
|---|---|---|
| 3-BB(F)XB(F)B(F, F)-F | (1) | 5% |
| 3-HGB(F, F)-F | (1-6) | 3% |
| 5-GHB(F, F)-F | (1-7) | 4% |
| 3-GB(F, F)XB(F, F)-F | (1-14) | 5% |
| 3-HHBB(F, F)-F | (1-19) | 4% |
| 2-dhBB(F, F)XB(F, F)-F | (1-25) | 4% |
| 3-GB(F)B(F, F)XB(F, F)-F | (1-27) | 3% |
| 3-HGB(F, F)XB(F, F)-F | (1) | 5% |
| 7-HB(F, F)-F | (1) | 3% |
| 2-HH-3 | (2-1) | 14% |
| 2-HH-5 | (2-1) | 4% |
| 3-HH-V | (2-1) | 26% |
| 1V2-HH-3 | (2-1) | 5% |
| 1V2-BB-1 | (2-3) | 3% |
| 2-BB(F)B-3 | (2-8) | 3% |
| 3-HB(F)HH-2 | (2-10) | 4% |
| 5-HBB(F)B-2 | (2-13) | 5% |

NI = 78.4° C.;
Tc <− 20° C.;
Δn = 0.094;
Δε = 5.6;
Vth = 1.45 V;
η = 11.5 mPa · s;
γ1 = 61.7 mPa · s.

### [Composition (M19)]

| | | |
|---|---|---|
| 3-HBB(F, F)-F | (1-8) | 5% |
| 5-HBB(F, F)-F | (1-8) | 4% |
| 3-BB(F)B(F, F)XB(F, F)-F | (1-29) | 3% |
| 4-BB(F)B(F, F)XB(F, F)-F | (1-29) | 5% |
| 3-BB(F, F)XB(F)B(F, F)-F | (1-30) | 10% |
| 3-HH2BB(F, F)-F | (1) | 3% |
| 4-HH2BB(F, F)-F | (1) | 3% |
| 2-HH-5 | (2-1) | 4% |
| 3-HH-V | (2-1) | 25% |
| 3-HH-V1 | (2-1) | 10% |
| 4-HH-V1 | (2-1) | 7% |
| 5-HB-O2 | (2-2) | 5% |
| 7-HB-1 | (2-2) | 5% |
| VFF-HHB-O1 | (2-5) | 8% |
| VFF-HHB-1 | (2-5) | 3% |

NI = 79.3° C.;
Tc <− 20° C.;
Δn = 0.099;
Δε = 5.0;
Vth = 1.64 V;
η = 10.4 mPa · s;
γ1 = 44.7 mPa · s.

### [Composition (M20)]

| | | |
|---|---|---|
| 3-GBXB(F)B(F, F)-F | (1) | 5% |
| 3-HHB(F, F)-F | (1-2) | 7% |
| 3-GB(F)B(F)-F | (1-11) | 2% |
| 3-GB(F)B(F, F)-F | (1-12) | 3% |
| 3-BB(F, F)XB(F, F)-F | (1-18) | 7% |
| 3-GB(F)B(F, F)XB(F, F)-F | (1-27) | 4% |
| 5-GB(F)B(F, F)XB(F, F)-F | (1-27) | 5% |
| 3-HH-V | (2-1) | 30% |
| 3-HH-V1 | (2-1) | 10% |
| 1V2-HH-3 | (2-1) | 8% |
| 3-HH-VFF | (2-1) | 8% |
| V2-BB-1 | (2-3) | 2% |
| 5-HB(F)BH-3 | (2-12) | 4% |
| 5-HBBH-3 | (2) | 5% |

NI = 79.7° C.;
Tc <− 20° C.;
Δn = 0.091;
Δε = 5.7;
Vth = 1.83 V;
η = 14.9 mPa · s;
γ1 = 69.3 mPa · s.

The first additive was selected from among the following compounds.

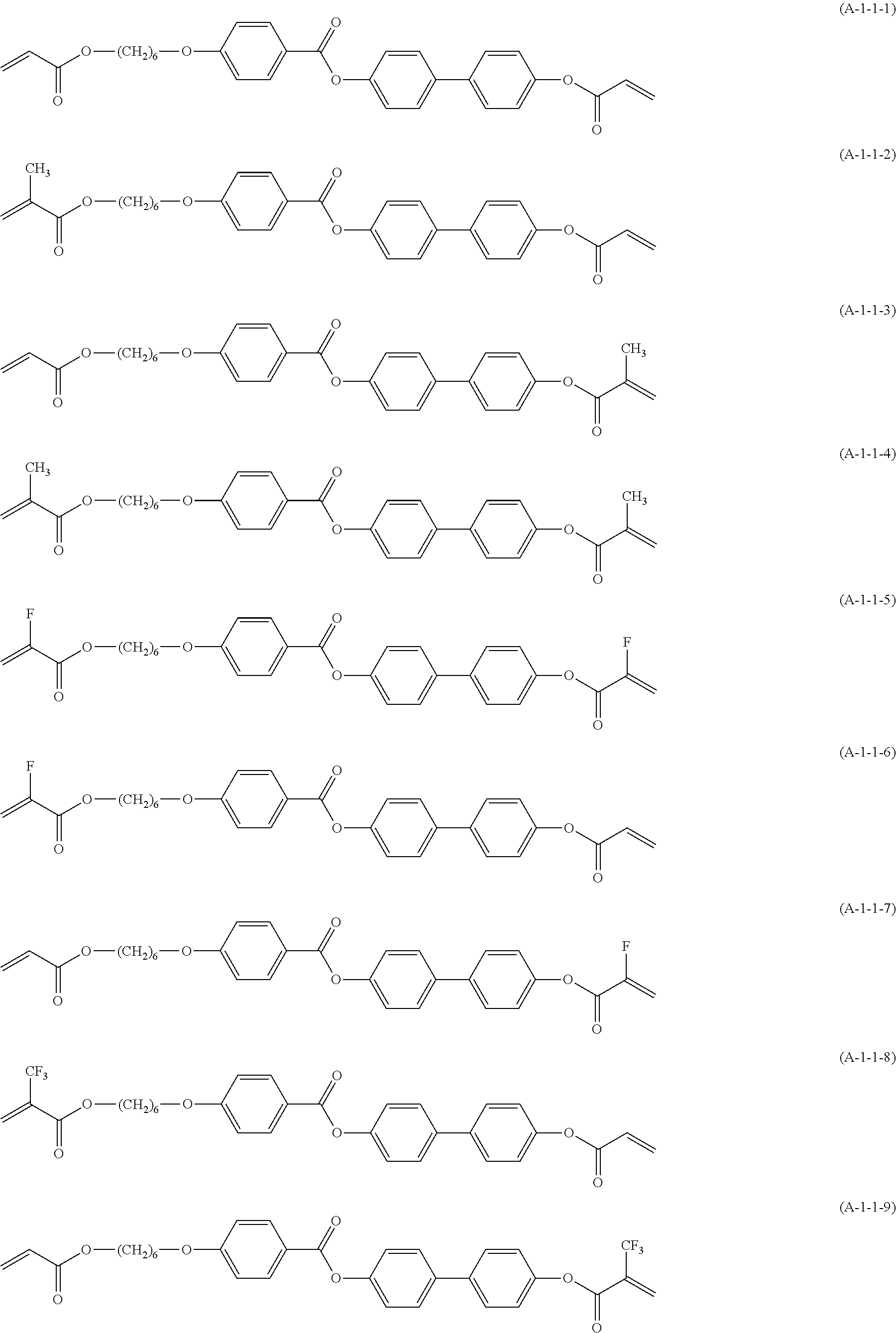

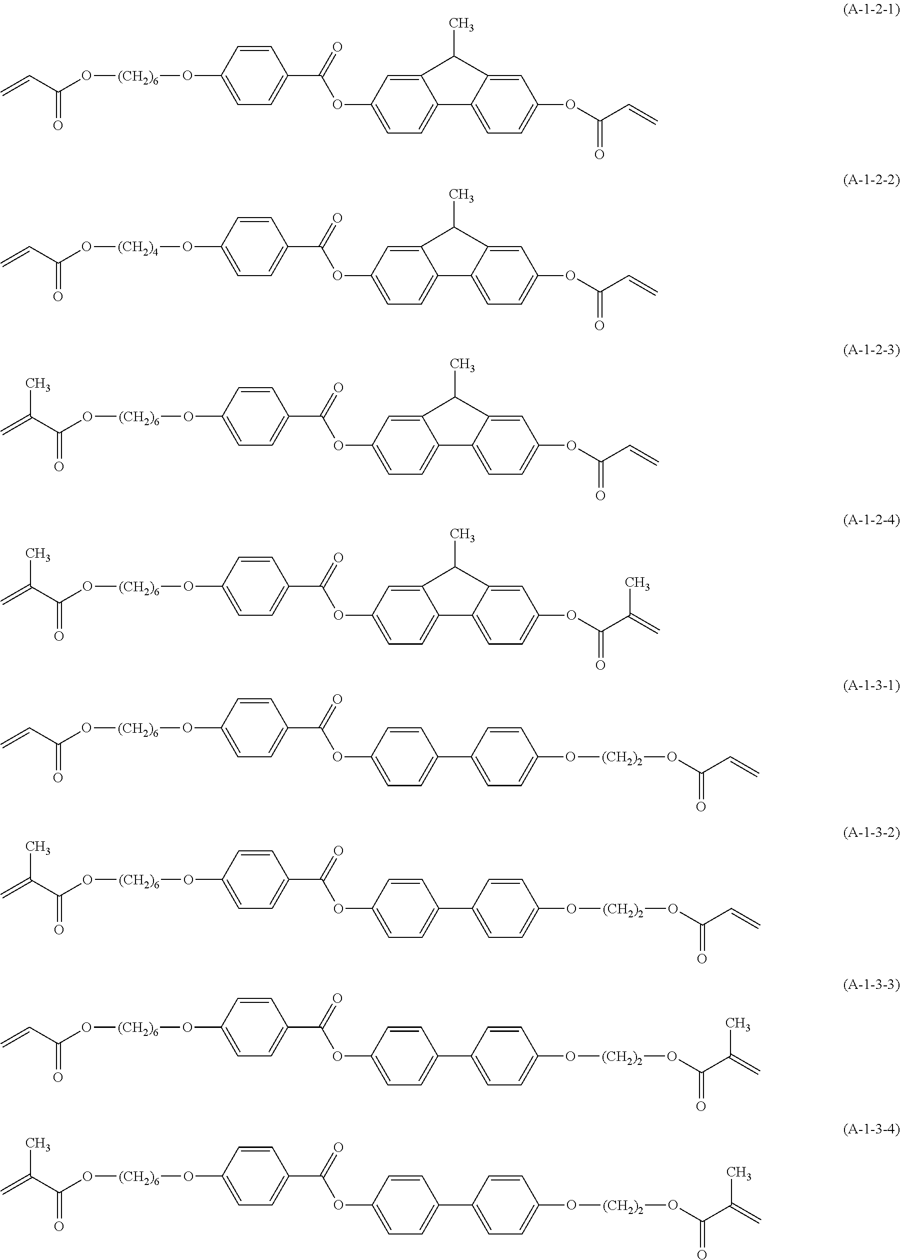

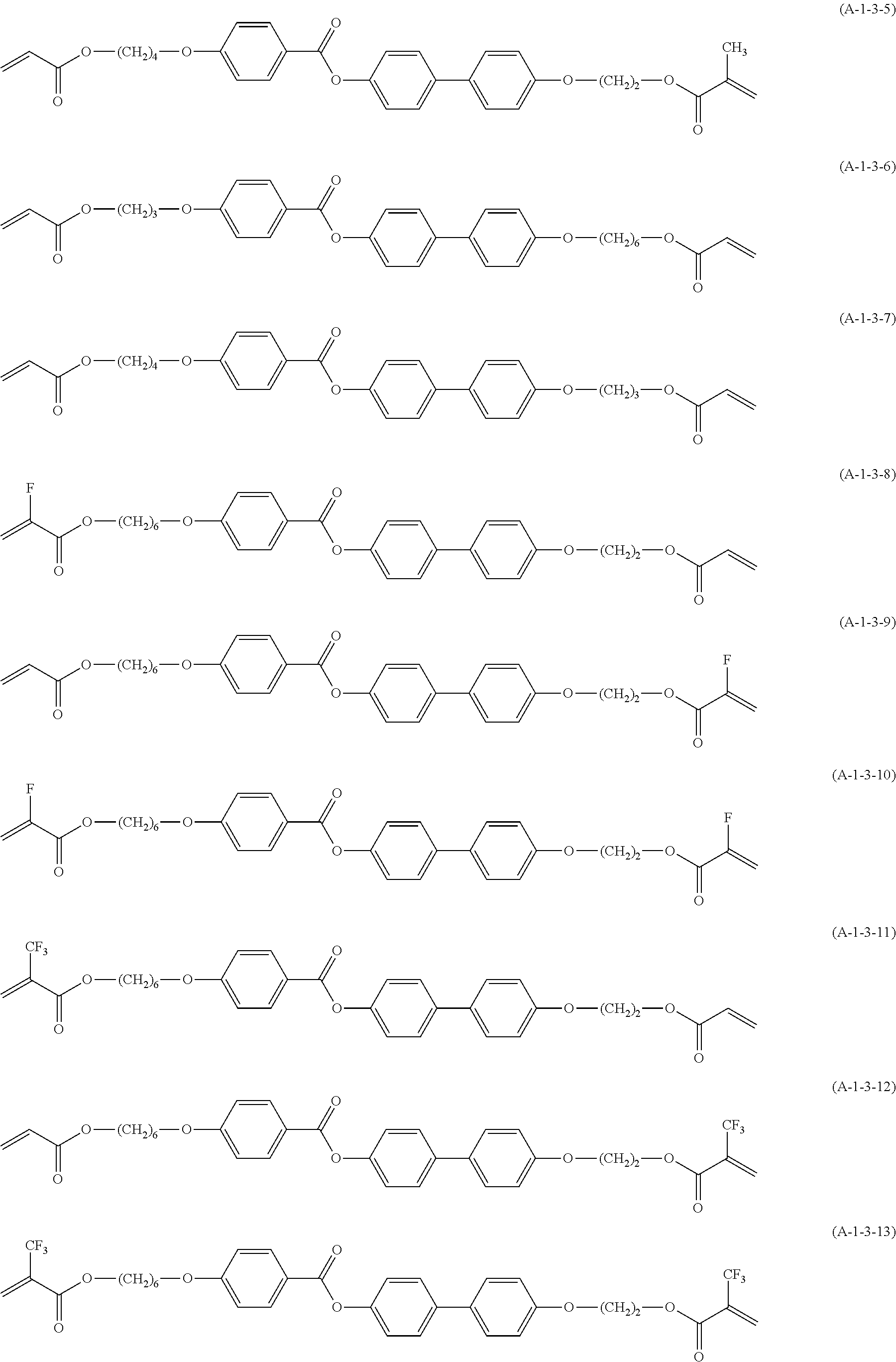

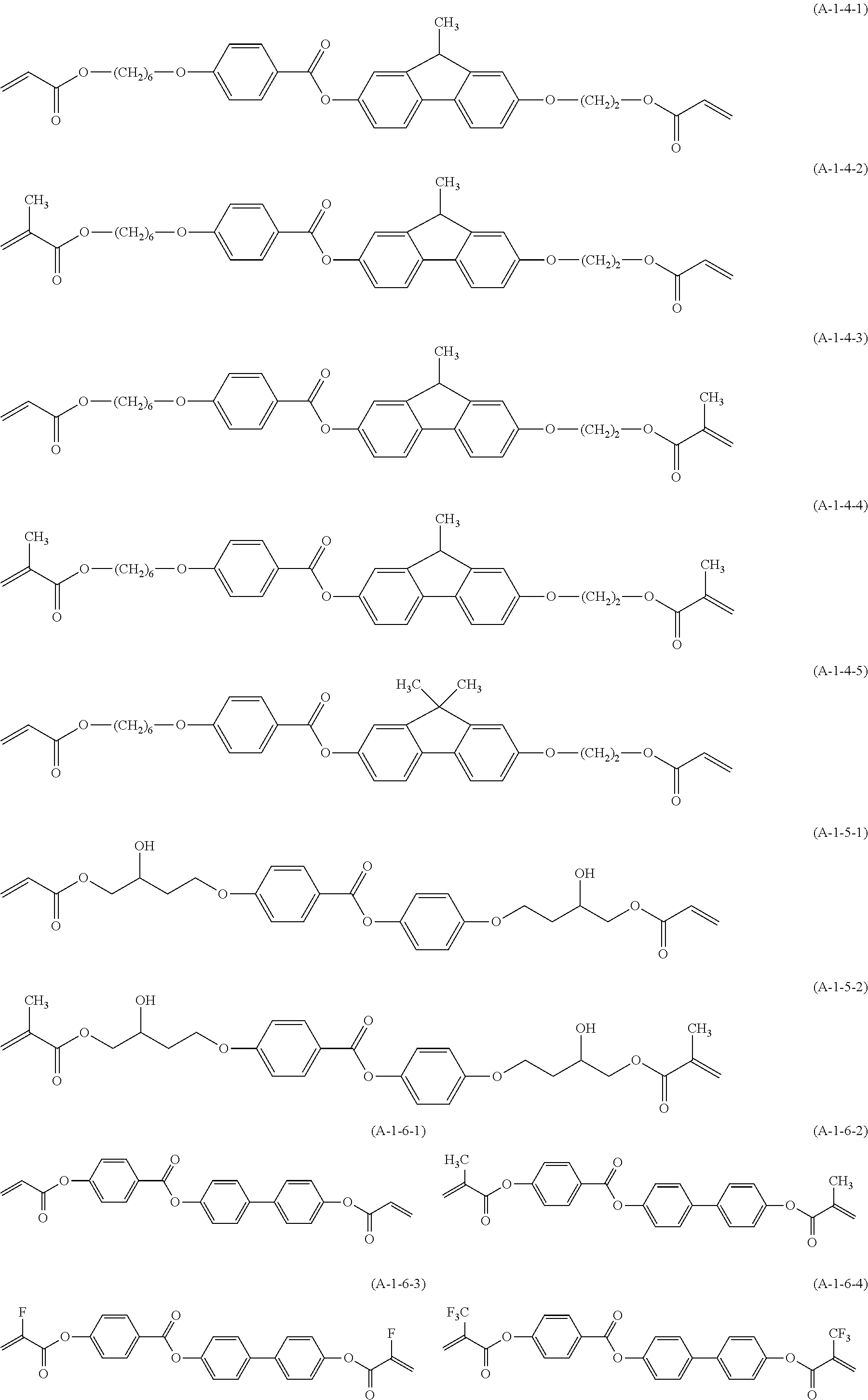

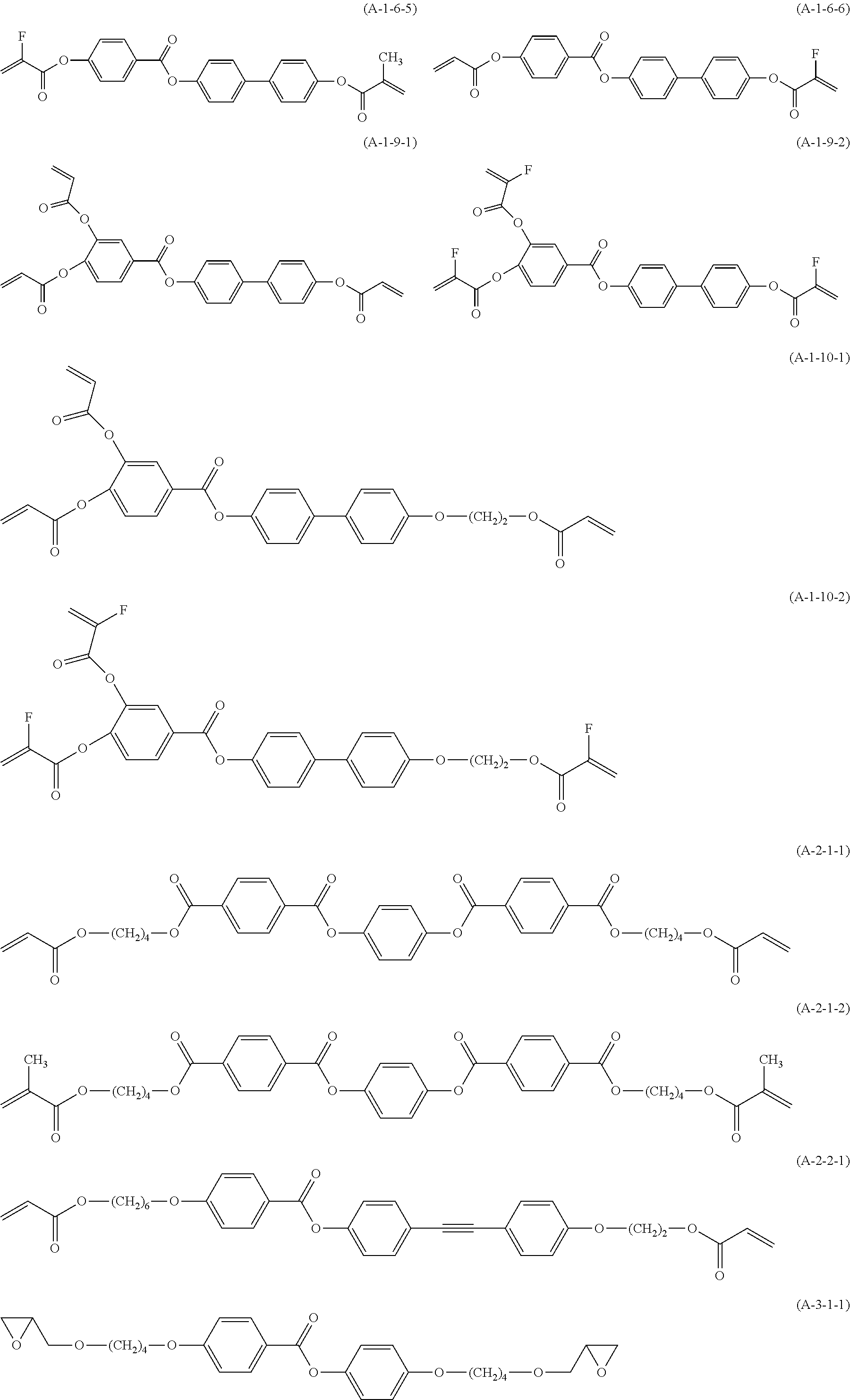

### 2. Alignment of Liquid Crystal Molecules

### <Polarized Light Exposure Conditions>

Light with an intensity of 3 mW/cm² (illuminance with a wavelength of 313 nm was measured using UV illuminance meters UIT-150 and UVD-S313 commercially available from Ushio Inc.) was exposed using a 250 W super high pressure mercury lamp (multi-light commercially available from Ushio Inc.) and a wire grid polarizing plate (ProFlux (UVT-260A) commercially available from MOXTEK).

### Example 1

Compound (A-1-1-1) was added in a proportion of 0.5 parts by weight to 100 parts by weight of Composition (M1) and Compound (5) having t=7 as an antioxidant was added in a proportion of 150 ppm. The mixture was injected into an IPS element having no alignment film at 90° C. (the upper limit temperature or higher of the nematic phase).

While the IPS element was heated at 90° C. (the upper limit temperature or higher), linearly polarized UV light (313 nm, 2.0 J/cm²) was exposed in a direction normal to the element, and thereby the element on which an alignment control layer was formed was obtained. UV light to be exposed became linearly polarized light when it passed through a polarizer. Next, the element on which the alignment control layer was formed was set in a polarizing microscope and a liquid crystal alignment state was observed. A polarizer and an analyzer of the polarizing microscope were arranged so that respective transmission axes were orthogonal to each other. First, the element was placed on a horizontal rotation stage of the polarizing microscope so that an alignment direction of liquid crystal molecules was parallel to the transmission axis of the polarizer of the polarizing microscope, that is, an angle between an alignment direction of liquid crystal molecules and the transmission axis of the polarizer of the polarizing microscope became 0 degrees. Light was emitted from below the element, that is, from the side of the polarizer, and it was observed whether there was light that had passed through the analyzer. When no light that had passed through the analyzer was observed, the alignment was determined as “favorable.” On the other hand, when light that had passed through the analyzer was observed in the same observation, the alignment was determined as “poor.” Next, the element was rotated on the horizontal rotation stage of the polarizing microscope, and an angle between the transmission axis of the polarizer of the polarizing microscope and an alignment direction of liquid crystal molecules was changed from 0 degrees. It was confirmed that an intensity of light that had passed through the analyzer increased as an angle between the transmission axis of the polarizer of the polarizing microscope and an alignment direction of liquid crystal molecules increased, and when the angle was 45 degrees, the intensity was almost a maximum. In the element obtained as described above, liquid crystal molecules were aligned in a direction substantially horizontal to the main surface of the main surface of the substrate of the element, and it was determined as “horizontal alignment.” In Example 1, since no light leakage was observed, the alignment was favorable.

### Example 2 to Example 26

As shown in the following Table 4, using Composition (M1) to Composition (M20), additives were mixed as shown in the following table. The temperature when linearly polarized UV light was exposed was set as shown in the following table. When it was observed whether there was light leakage in the same method as in Example 1, since no light leakage was observed, the alignment was favorable. Here, as a second additive, the following Compound (RM-1) to Compound (RM-3) were used.

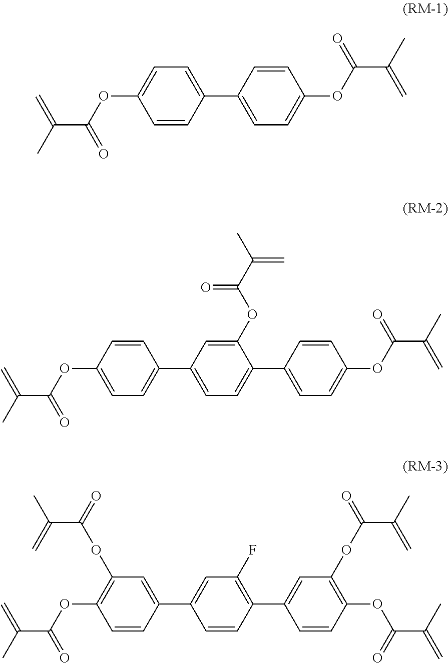

### Comparative Example 1

Only Composition (M1) was injected into an IPS element having no alignment film. When it was observed whether there was light leakage in the same method as in Example 1, since light leakage was observed, the alignment was poor.

### Comparative Example 2 to Comparative Example 4

Only a second additive (Compound (RM-1) to Compound (RM-3)) was added in a proportion of 0.3 parts by weight to 0.5 parts by weight to Composition (M1). The mixture was injected into an IPS element having no alignment film. When it was observed whether there was light leakage in the same method as in Example 1, since light leakage was observed, the alignment was poor.

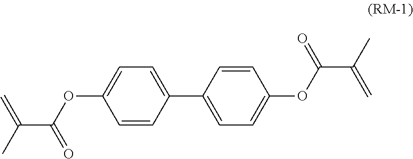 [SMILES: C=C(C)C(=O)Oc1ccc(-c2ccc(OC(=O)C(=C)C)cc2)cc1]

TABLE 4
Alignment of liquid crystal molecules

| | | | | | Amount of | | |
|---|---|---|---|---|---|---|---|
| | | | Amount of | | second | Heating | Alignment |
| | Liquid | | first additive | | additive | temperature | state of liquid |
| | crystal | | added (parts | Second | added (parts | during polarized | crystal |
| | composition | First additive | by weight) | additive | by weight) | light exposure | molecules |
| Example 2 | M2 | A-1-2-1 | 1.0 | — | — | 90° C. | Favorable and |
| | | | | | | | horizontal |
| | | | | | | | alignment |
| Example 3 | M3 | A-1-3-1 | 1.0 | — | — | 90° C. | Favorable and |
| | | | | | | | horizontal |
| | | | | | | | alignment |
| Example 4 | M4 | A-1-4-1 | 1.0 | — | — | 100 ° C. | Favorable and |
| | | | | | | | horizontal |
| | | | | | | | alignment |
| Example 5 | M5 | A-1-5-1 | 1.0 | — | — | 90° C. | Favorable and |
| | | | | | | | horizontal |
| | | | | | | | alignment |
| Example 6 | M6 | A-2-1-1 | 1.0 | — | — | 90° C. | Favorable and |
| | | | | | | | horizontal |
| | | | | | | | alignment |
| Example 7 | M7 | A-3-1-1 | 1.0 | — | — | 90° C. | Favorable and |
| | | | | | | | horizontal |
| | | | | | | | alignment |
| Example 8 | M8 | A-1-1-1 | 3.0 | — | — | 90° C. | Favorable and |
| | | | | | | | horizontal |
| | | | | | | | alignment |
| Example 9 | M9 | A-1-1-4 | 0.5 | — | — | 90° C. | Favorable and |
| | | | | | | | horizontal |
| | | | | | | | alignment |
| Example 10 | M10 | A-1-3-4 | 0.5 | — | — | 90° C. | Favorable and |
| | | | | | | | horizontal |
| | | | | | | | alignment |
| Example H | M11 | A-1-4-2 | 0.5 | — | — | 90° C. | Favorable and |
| | | | | | | | horizontal |
| | | | | | | | alignment |
| Example 12 | M12 | A-1-4-5 | 0.5 | — | — | 90° C. | Favorable and |
| | | | | | | | horizontal |
| | | | | | | | alignment |
| Example 13 | M13 | A-1-5-1 | 0.5 | — | — | 90° C. | Favorable and |
| | | | | | | | horizontal |
| | | | | | | | alignment |
| Example 14 | M14 | A-1-4-5 | 0.5 | — | — | 90° C. | Favorable and |
| | | | | | | | horizontal |
| | | | | | | | alignment |
| Example 15 | M15 | A-1-4-1 | 0.5 | — | — | 90° C. | Favorable and |
| | | | | | | | horizontal |
| | | | | | | | alignment |
| Example 16 | M1 | A-1-3-6 | 0.5 | — | — | 90° C. | Favorable and |
| | | | | | | | horizontal |
| | | | | | | | alignment |
| Example 17 | M2 | A-1-3-5 | 0.5 | — | — | 90° C. | Favorable and |
| | | | | | | | horizontal |
| | | | | | | | alignment |
| Example 18 | M3 | A-1-2-4 | 0.5 | — | — | 90° C. | Favorable and |
| | | | | | | | horizontal |
| | | | | | | | alignment |
| Example 19 | M16 | A-1-1-7 | 0.5 | — | — | 90° C. | Favorable and |
| | | | | | | | horizontal |
| | | | | | | | alignment |
| Example 20 | M17 | A-1-3-8 | 0.5 | — | — | 90° C. | Favorable and |
| | | | | | | | horizontal |
| | | | | | | | alignment |
| Example 21 | M18 | A-1-6-3 | 0.5 | — | — | 90° C. | Favorable and |
| | | | | | | | horizontal |
| | | | | | | | alignment |
| Example 22 | M19 | A-1-6-6 | 0.5 | — | — | 90° C. | Favorable and |
| | | | | | | | horizontal |
| | | | | | | | alignment |
| Example 23 | M20 | A-1-3-1 | 1.0 | RM-1 | 0.5 | 90° C. | Favorable and |
| | | | | | | | horizontal |
| | | | | | | | alignment |
| Example 24 | M1 | A-1-3-1 | 0.3 | — | — | 90° C. | Favorable and |
| | | A-2-2-1 | 0.3 | | | | horizontal |
| | | | | | | | alignment |
| Example 25 | M1 | A-1-3-1 | 0.5 | RM-2 | 0.3 | 90° C. | Favorable and |
| | | | | | | | horizontal |
| | | | | | | | alignment |
| Example 26 | M1 | A-1-3-1 | 0.5 | RM-3 | 0.3 | 90° C. | Favorable and |
| | | | | | | | horizontal |
| | | | | | | | alignment |
| Comparative | M1 | — | — | — | — | 90° C. | Poor |
| Example 1 | | | | | | | |
| Comparative | M1 | — | — | RM-1 | 0.5 | 90° C. | Poor |
| Example 2 | | | | | | | |
| Comparative | M1 | — | — | RM-2 | 0.3 | 90° C. | Poor |
| Example 3 | | | | | | | |
| Comparative | M1 | — | — | RM-3 | 0.3 | 90° C. | Poor |
| Example 4 | | | | | | | |

### 3. Compatibility Between Alignment Control Monomer and Liquid Crystal Composition

The stabilities at room temperature of the mixtures of the liquid crystal composition and the alignment control monomer of the examples and the mixtures of the liquid crystal composition and the polymerizable compound obtained in the comparative examples were evaluated. After mixing, the mixture was converted into an isotropic liquid at 100° C. and cooled to 25° C. When it was checked whether precipitation occurred at room temperature after half a day, no precipitation was observed in the mixtures of Example 1 to 26, and compatibility with any of the alignment control monomers was favorable.

In Examples 1 to 26, although the type and amount of the composition and the alignment control monomer, and a heating temperature during polarized light exposure were changed, no light leakage was observed. Similarly, the same trend was observed even if a plurality of alignment control monomers were used. These results indicate that, even if the element had no alignment film of such as a polyimide, the alignment was favorable and all liquid crystal molecules were arranged in a certain direction. On the other hand, light leakage was observed in Comparative Example 1 in which no alignment control monomer was contained and Comparative Examples 2 to 4 in which only a polymerizable compound including no aromatic ester moiety was contained. Based on the above results, it can be understood that a thin film composed of the alignment control monomer played an important role in the alignment of liquid crystal molecules. Similar effects could be expected for other alignment control monomers exemplified. Therefore, when the liquid crystal composition of the present invention was used, a liquid crystal display element having characteristics such as a wide temperature range in which an element was able to be used, a short response time, a high voltage holding ratio, a low threshold voltage, a large contrast ratio, and a long lifetime was obtained.

In addition, a liquid crystal display element containing a liquid crystal composition that had at least one of characteristics such as a high upper limit temperature of a nematic phase, a low lower limit temperature of a nematic phase, a low viscosity, appropriate optical anisotropy, large positive dielectric anisotropy, a high specific resistance, high stability with respect to UV light, and high stability with respect to heat was obtained.

### INDUSTRIAL APPLICABILITY

The liquid crystal composition of the present invention can be used for a liquid crystal monitor, a liquid crystal television, and the like.

1. A liquid crystal display element in which a liquid crystal layer is interposed between a pair of substrates that are arranged to face each other and adhered using a sealing agent,
wherein an alignment control layer for controlling the alignment of liquid crystal molecules is provided between the pair of substrates and the liquid crystal layer,
wherein the liquid crystal layer is composed of a liquid crystal composition having positive dielectric anisotropy,
wherein the liquid crystal composition contains, as a first additive, at least one alignment control monomer represented by Formula (A) including an aromatic ester that causes photo-Fries rearrangement due to light exposure, and a liquid crystalline compound, and
wherein the alignment control layer is composed of a polymer that is formed by polymerizing a compound represented by Formula (A) as an alignment control monomer: 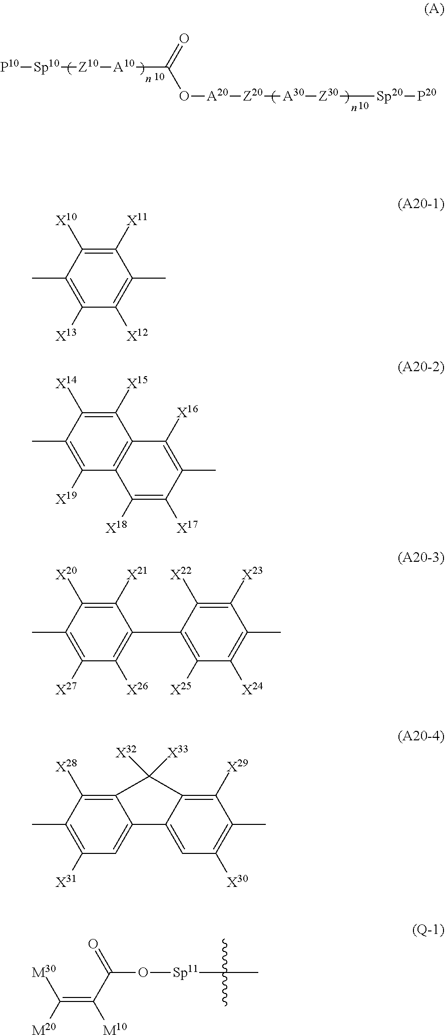
in Formula (A),
P¹⁰ and P²⁰ independently represent a polymerizable group;
Sp¹⁰ and Sp²⁰ independently represent a single bond or an alkylene group having 1 to 12 carbon atoms, and at least one hydrogen atom in the alkylene group is optionally substituted with a fluorine atom or a hydroxy group, at least one —CH₂— is optionally substituted with —O—, —COO—, —OCO— or Formula (Q-1), and at least one —CH₂—CH₂— is optionally substituted with —CH═CH— or —C≡C—;
in Formula (Q-1), M¹⁰, M²⁰, and M³⁰ independently represent a hydrogen atom, a fluorine atom, an alkyl group having 1 to 5 carbon atoms, or an alkyl group having 1 to 5 carbon atoms in which at least one hydrogen atom is substituted with a fluorine atom or a chlorine atom; Sp¹¹ is a single bond or an alkylene group having 1 to 12 carbon atoms, at least one hydrogen atom in the alkylene group is optionally substituted with a fluorine atom or a hydroxy group, at least one —CH₂— is optionally substituted with —O—, —COO—, or —OCO—, and at least one —CH₂—CH₂— is optionally substituted with —CH═CH— or —C≡C—;
Z¹⁰, Z²⁰ and Z³⁰ independently represent a single bond, —COO—, —OCO—, —OCOO—, —OCO—CH₂CH₂—, —CH₂CH₂—COO—, —CH₂O—, —OCH₂—, —CF₂O—, —OCF₂—, —C≡C—, —CONH—, —NHCO—, —(CH₂)₄—, —CH₂CH₂— or —CF₂CF₂—;
A¹⁰ and A³⁰ independently represent 1,4-phenylene, 1,4-cyclohexylene, pyridine-2,5-diyl, pyrimidine-2,5-diyl, naphthalene-2,6-diyl, naphthalene-1,5-diyl, tetrahydronaphthalene-2,6-diyl, fluorene-2,7-diyl, biphenylene-4,4′-diyl or 1,3-dioxane-2,5-diyl, and in 1,4-phenylene, any hydrogen atom is optionally substituted with a fluorine atom, a chlorine atom, a cyano group, a hydroxy group, a formyl group, an acetoxy group, an acetyl group, a trifluoroacetyl group, a difluoromethyl group, a trifluoromethyl group, an alkyl group having 1 to 5 carbon atoms, an alkoxy having 1 to 5 carbon atoms, or P¹⁰—Sp¹⁰—Z¹⁰—, and in fluorene-2,7-diyl, any hydrogen atom is optionally substituted with a fluorine atom, or an alkyl group having 1 to 5 carbon atoms,
in biphenylene-4,4′-diyl, any hydrogen atom is optionally substituted with a fluorine atom, a difluoromethyl group, a trifluoromethyl group, an alkyl group having 1 to 5 carbon atoms, or an alkoxy having 1 to 5 carbon atoms;
A²⁰ represents 1,4-phenylene represented by Formula (A20-1), pyridine-2,5-diyl, or pyrimidine-2,5-diyl, naphthalene-2,6-diyl represented by Formula (A20-2), or naphthalene-1,5-diyl, biphenylene-4,4′-diyl represented by Formula (A20-3), or fluorene-2,7-diyl represented by Formula (A20-4),
in 1,4-phenylene represented by Formula (A20-1), X¹⁰, X¹¹, X¹² and X¹³ each are independently optionally substituted with a hydrogen atom, a fluorine atom, a chlorine atom, a cyano group, a hydroxy group, a formyl group, an acetoxy group, an acetyl group, a trifluoroacetyl group, a difluoromethyl group, a trifluoromethyl group, an alkyl group having 1 to 5 carbon atoms, or an alkoxy having 1 to 5 carbon atoms, and at least one of X¹⁰ and X¹³ is a hydrogen atom,
in naphthalene-2,6-diyl represented by Formula (A20-2), X¹⁴, X¹⁵, X¹⁶, X¹⁷, X¹⁸ and X¹⁹ are each independently optionally substituted with a hydrogen atom, a fluorine atom, an alkyl group having 1 to 5 carbon atoms, or an alkoxy having 1 to 5 carbon atoms, and at least one of X¹⁴ and X¹⁹ is a hydrogen atom,
in biphenylene-4,4′-diyl represented by Formula (A20-3), X²⁰, X²¹, X²², X²³, X²⁴, X²⁵, X²⁶ and X²⁷ each are independently optionally substituted with a hydrogen atom, a fluorine atom, a difluoromethyl group, a trifluoromethyl group, an alkyl group having 1 to 5 carbon atoms, or an alkoxy having 1 to 5 carbon atoms, and at least one of X²⁰ and X²⁷ is a hydrogen atom,
in fluorene-2,7-diyl represented by Formula (A20-4), X²⁸, X²⁹, X³⁰, X³¹, X³² and X³³ each are independently optionally substituted with a hydrogen atom, a fluorine atom, or an alkyl group having 1 to 5 carbon atoms, and at least one of X²⁸ and X³¹ is a hydrogen atom; and
n¹⁰ is independently an integer of 0 to 3.

2. The liquid crystal display element according to claim 1,
wherein, in Formula (A),
P¹⁰ and P²⁰ independently represent an acryloyloxy group, a methacryloyloxy group, an α-fluoro acrylate group, a trifluoromethyl acrylate group, a vinyl group, a vinyloxy group, or an epoxy group;
Sp¹⁰ and Sp²⁰ independently represent a single bond or an alkylene group having 1 to 12 carbon atoms, at least one hydrogen atom in the alkylene group is optionally substituted with a fluorine atom or a hydroxy group, at least one —CH₂— is optionally substituted with —O—, —COO—, or —OCO—, and at least one —CH₂—CH₂— is optionally substituted with —CH═CH— or —C≡C—;
Z¹⁰, Z²⁰, and Z³⁰ independently represent a single bond, —COO—, —OCO—, —OCOO—, —OCO—CH₂CH₂—, —CH₂CH₂—COO—, —CH₂O—, —OCH₂—, —CF₂O—, —OCF₂—, —C≡C—, —CONH—, —NHCO—, —(CH₂)₄—, —CH₂CH₂—, or —CF₂CF₂—;
A¹⁰ and A³⁰ independently represent 1,4-phenylene, 1,4-cyclohexylene, naphthalene-2,6-diyl, naphthalene-1,5-diyl, fluorene-2,7-diyl, or biphenylene-4,4′-diyl, and in 1,4-phenylene, any hydrogen atom is optionally substituted with a fluorine atom, a cyano group, a hydroxy group, an acetoxy group, an acetyl group, a trifluoroacetyl group, a difluoromethyl group, a trifluoromethyl group, an alkyl group having 1 to 5 carbon atoms, an alkoxy having 1 to 5 carbon atoms, or P¹⁰—Sp¹⁰—Z¹⁰—, and in fluorene-2,7-diyl, any hydrogen atom is optionally substituted with a fluorine atom or an alkyl group having 1 to 5 carbon atoms, and in biphenylene-4,4′-diyl, any hydrogen atom is optionally substituted with a fluorine atom, a difluoromethyl group, a trifluoromethyl group, an alkyl group having 1 to 5 carbon atoms, or an alkoxy having 1 to 5 carbon atoms;
A²⁰ represents 1,4-phenylene represented by Formula (A20-1), naphthalene-2,6-diyl represented by Formula (A20-2), biphenylene-4,4′-diyl represented by Formula (A20-3) or fluorene-2,7-diyl represented by Formula (A20-4),
in 1,4-phenylene represented by Formula (A20-1), X¹⁰, X¹¹, X¹² and X¹³ each are independently optionally substituted with a hydrogen atom, a fluorine atom, a chlorine atom, a cyano group, a hydroxy group, a formyl group, an acetoxy group, an acetyl group, a trifluoroacetyl group, a difluoromethyl group, a trifluoromethyl group, an alkyl group having 1 to 5 carbon atoms, or an alkoxy having 1 to 5 carbon atoms, and at least one of X¹⁰ and X¹³ is a hydrogen atom,
in naphthalene-2,6-diyl represented by Formula (A20-2), X¹⁴, X¹⁵, X¹⁶, X¹⁷, X¹⁸ and X¹⁹ are each independently optionally substituted with a hydrogen atom, a fluorine atom, an alkyl group having 1 to 5 carbon atoms, or an alkoxy having 1 to 5 carbon atoms, and at least one of X¹⁴ and X¹⁹ is a hydrogen atom,
in biphenylene-4,4′-diyl represented by Formula (A20-3), X²⁰, X²¹, X²², X²³, X²⁴, X²⁵, X²⁶ and X²⁷ each are independently optionally substituted with a hydrogen atom, a fluorine atom, a difluoromethyl group, a trifluoromethyl group, an alkyl group having 1 to 5 carbon atoms, or an alkoxy having 1 to 5 carbon atoms, and at least one of X²⁰ and X²⁷ is a hydrogen atom,
in fluorene-2,7-diyl represented by Formula (A20-4), X²⁸, X²⁹, X³⁰, X³¹, X³² and X³³ each are independently optionally substituted with a hydrogen atom, a fluorine atom, or an alkyl group having 1 to 5 carbon atoms, and at least one of X²⁸ and X³¹ is a hydrogen atom; and
n¹⁰ is independently an integer of 0 to 3.

3. The liquid crystal display element according to claim 1,
wherein a compound represented by Formula (A-1) to Formula (A-3) is used as the alignment control monomer: 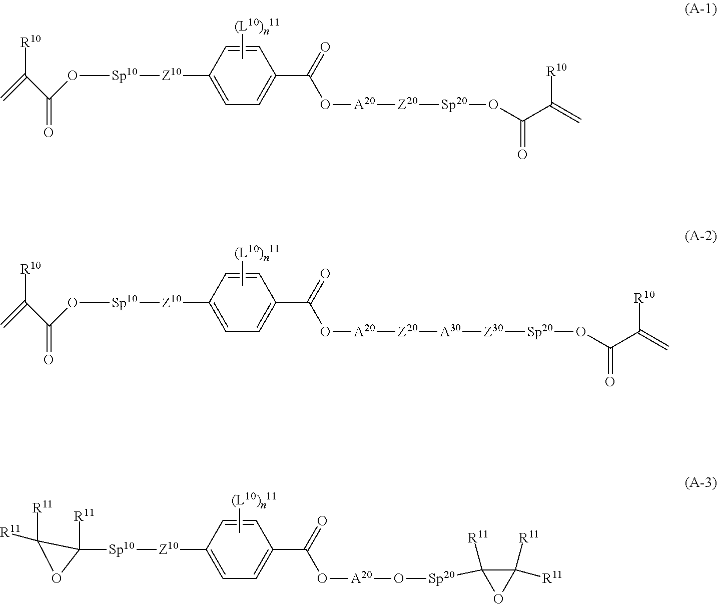
in Formula (A-1) to Formula (A-3),
R¹⁰ independently represent a hydrogen atom, a fluorine atom, a methyl group or a trifluoromethyl group;
R¹¹ independently represent a hydrogen atom or a methyl group;
Sp¹⁰ and Sp²⁰ independently represent a single bond or an alkylene group having 1 to 12 carbon atoms, at least one hydrogen atom in the alkylene group is optionally substituted with a fluorine atom or a hydroxy group, at least one —CH₂— is optionally substituted with —O—, —COO—, or —OCO—, and at least one —CH₂—CH₂— is optionally substituted with —CH═CH— or —C≡C—;
Z¹⁰, Z²⁰, and Z³⁰ independently represent a single bond, —COO—, —OCO—, —OCOO—, —OCO—CH₂CH₂—, —CH₂CH₂—COO—, —CH₂O—, —OCH₂—, —CF₂O—, —OCF₂—, —C≡C—, —CONH—, —NHCO—, —(CH₂)₄—, —CH₂CH₂—, or —CF₂CF₂—;
A²⁰ independently represent 1,4-phenylene represented by Formula (A20-1), biphenylene-4,4′-diyl represented by Formula (A20-3), or fluorene-2,7-diyl represented by Formula (A20-4),
in 1,4-phenylene represented by Formula (A20-1), X¹⁰, X¹¹, X¹² and X¹³ each are independently optionally substituted with a hydrogen atom, a fluorine atom, a hydroxy group, a difluoromethyl group, a trifluoromethyl group, an alkyl group having 1 to 5 carbon atoms, or an alkoxy having 1 to 5 carbon atoms, and at least one of X¹⁰ and X¹³ is a hydrogen atom,
in biphenylene-4,4′-diyl represented by Formula (A20-3), X²⁰, X²¹, X²², X²³, X²⁴, X²⁵, X²⁶ and X²⁷ each are independently optionally substituted with a hydrogen atom, a fluorine atom, a difluoromethyl group, a trifluoromethyl group, an alkyl group having 1 to 5 carbon atoms, or an alkoxy having 1 to 5 carbon atoms, and at least one of X²⁰ and X²⁷ is a hydrogen atom, and
in fluorene-2,7-diyl represented by Formula (A20-4), X²⁸, X²⁹, X³⁰, X³¹, X³² and X³³ each are independently optionally substituted with a hydrogen atom, a fluorine atom, or an alkyl group having 1 to 5 carbon atoms, and at least one of X²⁸ and X³¹ is a hydrogen atom;
A³⁰ independently represent 1,4-phenylene, naphthalene-2,6-diyl, naphthalene-1,5-diyl, fluorene-2,7-diyl, or biphenylene-4,4′-diyl, and in 1,4-phenylene, any hydrogen atom is optionally substituted with a fluorine atom, a hydroxy group, a difluoromethyl group, a trifluoromethyl group, an alkyl group having 1 to 5 carbon atoms, or an alkoxy having 1 to 5 carbon atoms, and in fluorene-2,7-diyl, any hydrogen atom is optionally substituted with a fluorine atom or an alkyl group having 1 to 5 carbon atoms, and in biphenylene-4,4′-diyl, any hydrogen atom is optionally substituted with a fluorine atom, a difluoromethyl group, a trifluoromethyl group, an alkyl group having 1 to 5 carbon atoms, or an alkoxy having 1 to 5 carbon atoms;
L¹⁰ independently represent a hydrogen atom, a fluorine atom, a difluoromethyl group, a trifluoromethyl group, an alkyl group having 1 to 5 carbon atoms, an alkoxy having 1 to 5 carbon atoms or P¹⁰—Sp¹⁰—Z¹⁰—;
n¹¹ independently represent an integer of 0 to 4.

4. The liquid crystal display element according to claim 1,
wherein a proportion of the alignment control monomer is in a range of 0.1 parts by weight to 10 parts by weight when a total amount of the liquid crystalline compound is 100 parts by weight.

5. The liquid crystal display element according to claim 1,
wherein at least one liquid crystalline compound selected from the group of compounds represented by Formula (1) is contained as a first component: 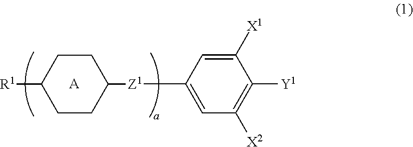
in Formula (1), R¹ represents an alkyl group having 1 to 12 carbon atoms, an alkoxy group having 1 to 12 carbon atoms or an alkenyl group having 2 to 12 carbon atoms, the ring A represents 1,4-cyclohexylene, 1,4-phenylene, 2-fluoro-1,4-phenylene, 2,3-difluoro-1,4-phenylene, 2,6-difluoro-1,4-phenylene, pyrimidine-2,5-diyl, 1,3-dioxane-2,5-diyl, or tetrahydropyran-2,5-diyl; Z¹ represents a single bond, an ethylene group, a carbonyloxy group, —CH═CF—, —CF═CF—, a difluoromethyleneoxy group, —CH═CF—CF₂O— or —CF═CF—CF₂O—; X¹ and X² independently represent a hydrogen atom or a fluorine atom; Y¹ represents a fluorine atom, a chlorine atom, an alkyl group having 1 to 12 carbon atoms in which at least one hydrogen atom is substituted with a fluorine atom or a chlorine atom, an alkoxy group having 1 to 12 carbon atoms in which at least one hydrogen atom is substituted with a fluorine atom or a chlorine atom, or an alkenyloxy group having 2 to 12 carbon atoms in which at least one hydrogen atom is substituted with a fluorine atom or a chlorine atom; and a is 1, 2, 3, or 4.

6. The liquid crystal display element according to claim 1,
wherein at least one compound selected from the group of compounds represented by Formula (1-1) to Formula (1-39) is contained as a first component: 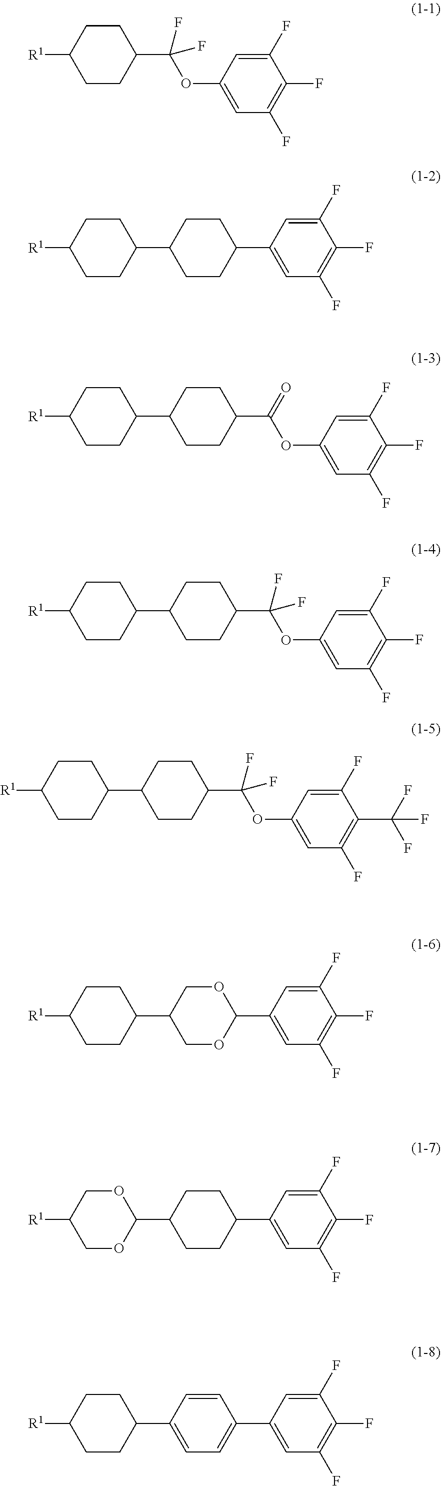 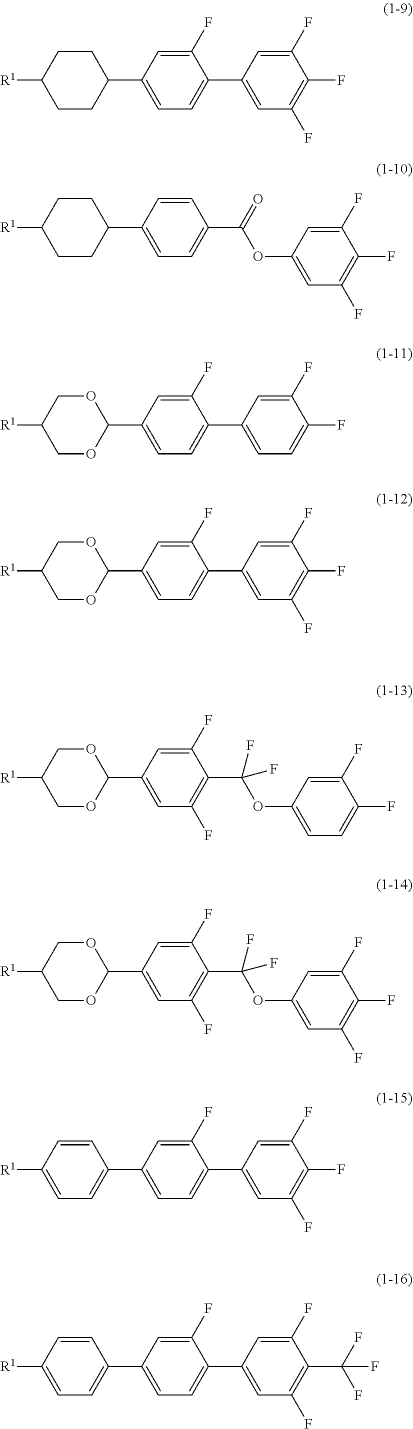 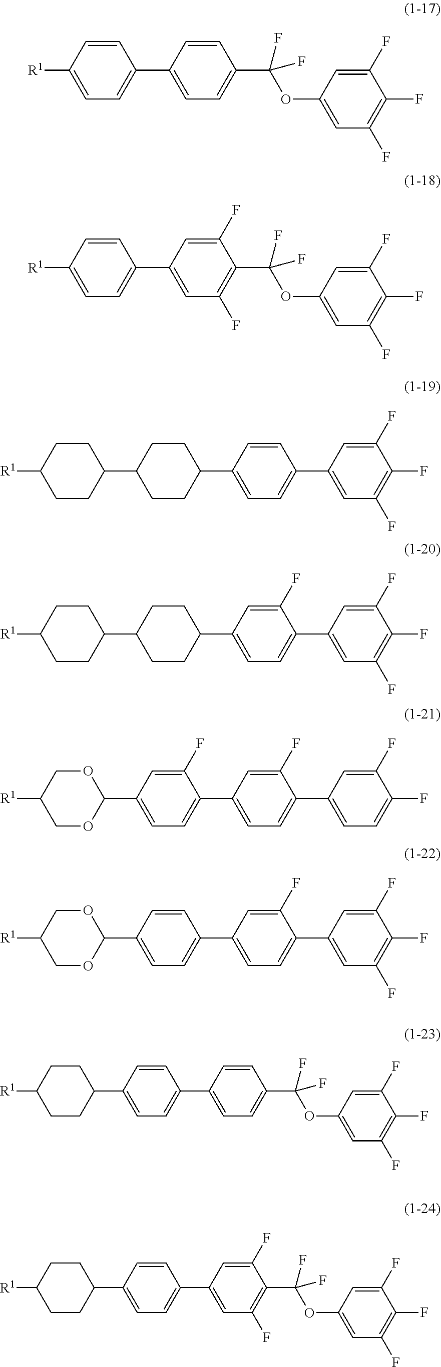 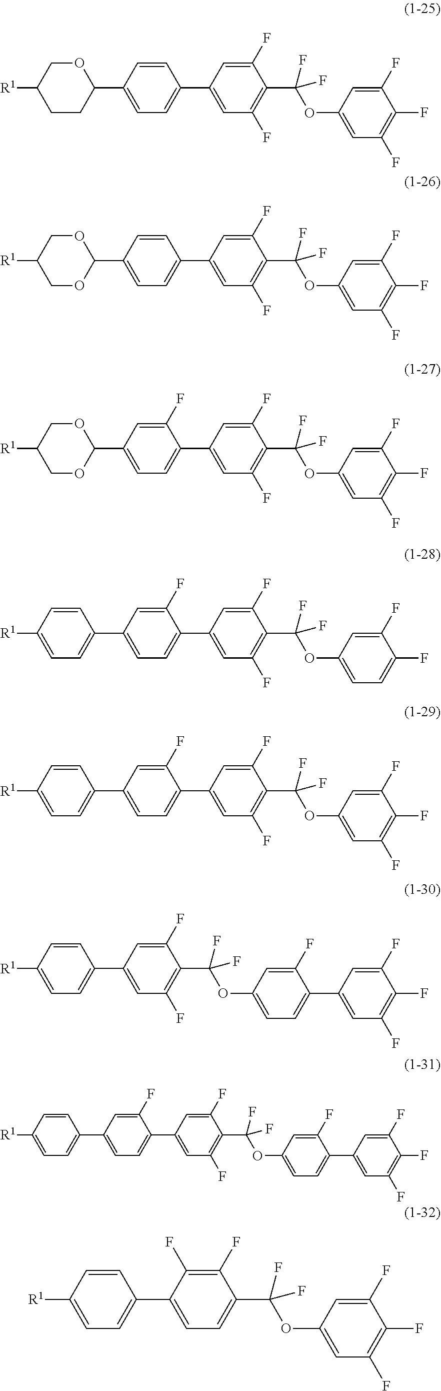 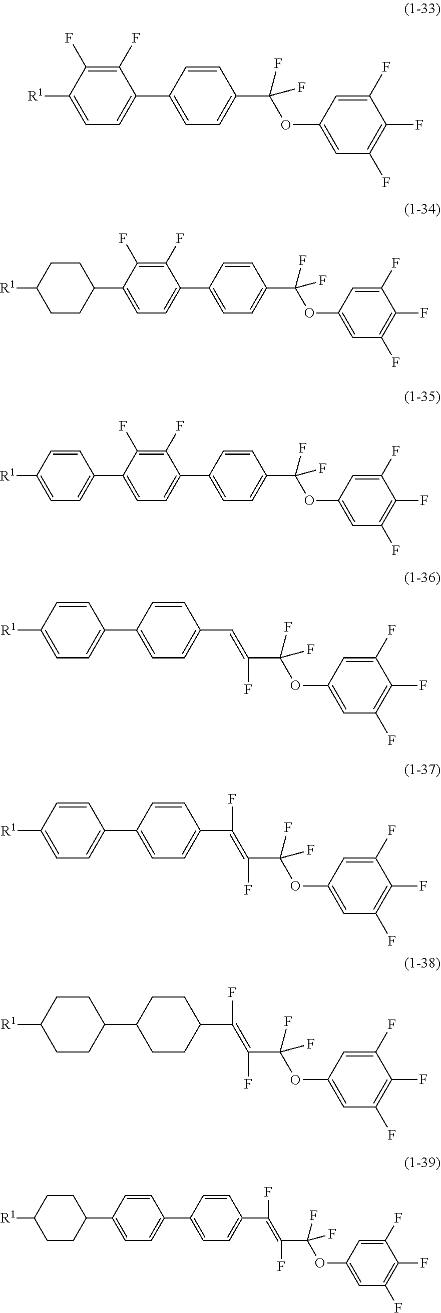
in Formula (1-1) to Formula (1-39), R¹ is an alkyl group having 1 to 12 carbon atoms, an alkoxy group having 1 to 12 carbon atoms, or an alkenyl group having 2 to 12 carbon atoms.

7. The liquid crystal display element according to claim 5,
wherein a proportion of the first component is in a range of 10 weight % to 85 weight % with respect to a total amount of the liquid crystalline compound.

8. The liquid crystal display element according to claim 1,
wherein at least one liquid crystalline compound selected from the group of compounds represented by Formula (2) is contained as a second component: 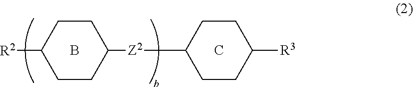
in Formula (2), R² and R³ independently represent an alkyl group having 1 to 12 carbon atoms, an alkoxy group having 1 to 12 carbon atoms, an alkenyl group having 2 to 12 carbon atoms, or an alkenyl group having 2 to 12 carbon atoms in which at least one hydrogen atom is substituted with a fluorine atom or a chlorine atom; the ring B and the ring C independently represent 1,4-cyclohexylene, 1,4-phenylene, 2-fluoro-1,4-phenylene, or 2,5-difluoro-1,4-phenylene; Z² represents a single bond, an ethylene group, or a carbonyloxy group; and b is 1, 2, or 3.

9. The liquid crystal display element according to claim 1,
wherein at least one compound selected from the group of compounds represented by Formula (2-1) to Formula (2-13) is contained as a second component: 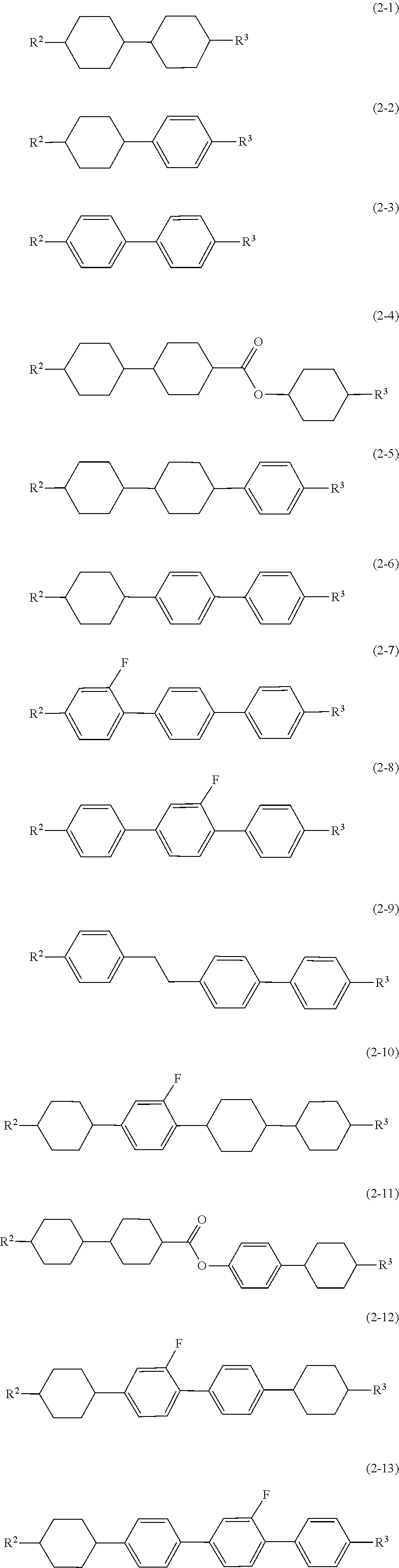
in Formula (2-1) to Formula (2-13), R² and R³ independently represent an alkyl group having 1 to 12 carbon atoms, an alkoxy group having 1 to 12 carbon atoms, an alkenyl group having 2 to 12 carbon atoms, or an alkenyl group having 2 to 12 carbon atoms in which at least one hydrogen atom is substituted with a fluorine atom or a chlorine atom

10. The liquid crystal display element according to claim 8,
wherein a proportion of the second component is in a range of 10 weight % to 85 weight % with respect to a total amount of the liquid crystalline compound.

11. The liquid crystal display element according to claim 1,
wherein at least one liquid crystalline compound selected from the group of compounds represented by Formula (3) is contained as a third component: 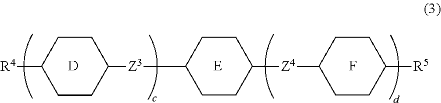
in Formula (3), R⁴ and R⁵ independently represent an alkyl group having 1 to 12 carbon atoms, an alkoxy group having 1 to 12 carbon atoms, an alkenyl group having 2 to 12 carbon atoms, or an alkenyloxy group having 2 to 12 carbon atoms; the ring D and the ring F independently represent 1,4-cyclohexylene, 1,4-cyclohexenylene, tetrahydropyran-2,5-diyl, 1,4-phenylene, 1,4-phenylene in which at least one hydrogen atom is substituted with a fluorine atom or a chlorine atom, naphthalene-2,6-diyl, naphthalene-2,6-diyl in which at least one hydrogen atom is substituted with a fluorine atom or a chlorine atom, chroman-2,6-diyl, or chroman-2,6-diyl in which at least one hydrogen atom is substituted with a fluorine atom or a chlorine atom; the ring E represents 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl, or 7,8-difluorochroman-2,6-diyl; Z³ and Z⁴ independently represent a single bond, an ethylene group, a carbonyloxy group, or a methyleneoxy group; c is 1, 2, or 3, d is 0 or 1; and a sum of c and d is 3 or less.

12. The liquid crystal display element according to claim 1,
wherein at least one compound selected from the group of compounds represented by Formula (3-1) to Formula (3-22) is contained as a third component: 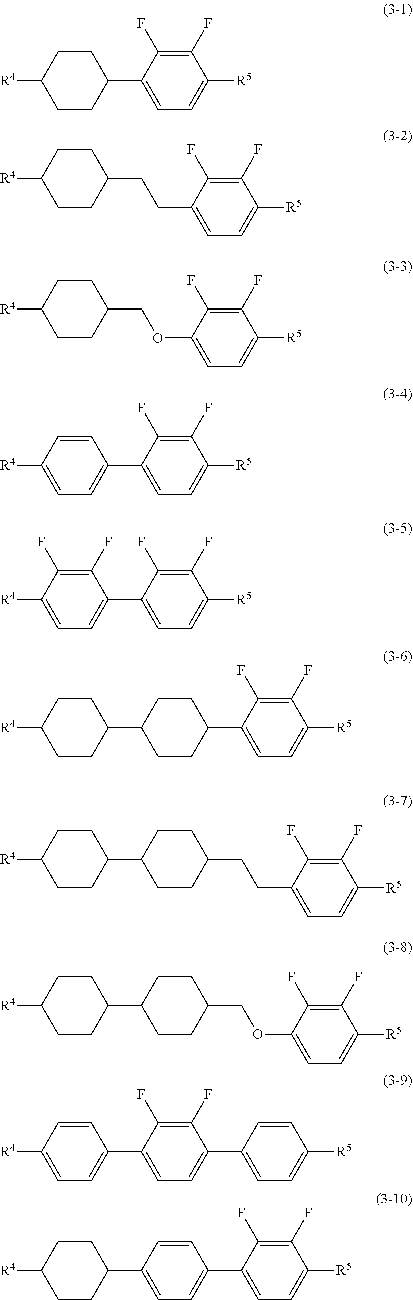 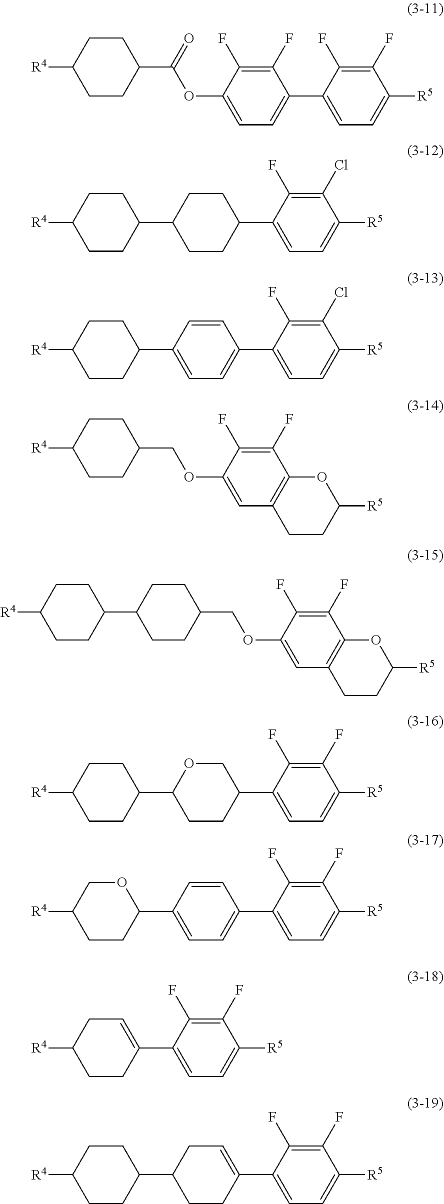 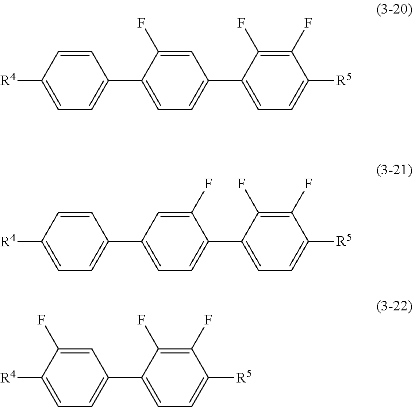
in Formula (3-1) to Formula (3-22), R⁴ and R⁵ independently represent an alkyl group having 1 to 12 carbon atoms, an alkoxy group having 1 to 12 carbon atoms, an alkenyl group having 2 to 12 carbon atoms, or an alkenyloxy group having 2 to 12 carbon atoms.

13. The liquid crystal display element according to claim 11,
wherein a proportion of the third component is in a range of 3 weight % to 25 weight % with respect to a total amount of the liquid crystalline compound.

14. The liquid crystal display element according to claim 1,
wherein an upper limit temperature of a nematic phase is 70° C. or higher, the optical anisotropy (measured at 25° C.) at a wavelength of 589 nm is 0.07 or more, and the dielectric anisotropy (measured at 25° C.) at a frequency of 1 kHz is 2 or more.

15. The liquid crystal display element according to claim 1,
wherein the liquid crystal composition further contains, as a second additive, at least one compound selected from the group of polymerizable compounds represented by Formula (4): 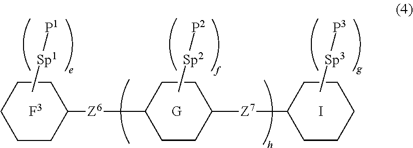
in Formula (4), the ring F³ and the ring I independently represent cyclohexyl, cyclohexenyl, phenyl, 1-naphthyl, 2-naphthyl, tetrahydropyran-2-yl, 1,3-dioxane-2-yl, pyrimidin-2-yl, or pyridin-2-yl, and in these rings, at least one hydrogen atom is optionally substituted with a fluorine atom, a chlorine atom, an alkyl group having 1 to 12 carbon atoms, an alkoxy group having 1 to 12 carbon atoms, or an alkyl group having 1 to 12 carbon atoms in which at least one hydrogen atom is substituted with a fluorine atom or a chlorine atom; the ring G represents 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl, or pyridine-2,5-diyl, and in these rings, at least one hydrogen atom is optionally substituted with a fluorine atom, a chlorine atom, an alkyl group having 1 to 12 carbon atoms, an alkoxy group having 1 to 12 carbon atoms, or an alkyl group having 1 to 12 carbon atoms in which at least one hydrogen atom is substituted with a fluorine atom or a chlorine atom; Z⁶ and Z⁷ independently represent a single bond or an alkylene group having 1 to 10 carbon atoms, and in the alkylene group, at least one —CH₂— is optionally substituted with —O—, —CO—, —COO—, or —OCO—, and at least one —CH₂CH₂— is optionally substituted with —CH═CH—, —C(CH₃)═CH—, —CH═C(CH₃)—, or —C(CH₃)═C(CH₃)—, and in these groups, at least one hydrogen atom is optionally substituted with a fluorine atom or a chlorine atom; P¹, P², and P³ represent a polymerizable group; Sp¹, Sp², and Sp³ independently represent a single bond or an alkylene group having 1 to 10 carbon atoms, and in the alkylene group, at least one —CH₂— is optionally substituted with —O—, —COO—, —OCO—, or —OCOO—, and at least one —CH₂CH₂— is optionally substituted with —CH═CH— or —C≡C—, and in these groups, at least one hydrogen atom is optionally substituted with a fluorine atom or a chlorine atom; h is 0, 1, or 2; e, f, and g are independently 0, 1, 2, 3, or 4, and a sum of e, f, and g is 1 or more.

16. The liquid crystal display element according to claim 15,
wherein, in Formula (4) in the liquid crystal composition, P¹, P², and P³ are independently a group selected from the group of polymerizable groups represented by Formula (P-1) to Formula (P-5): 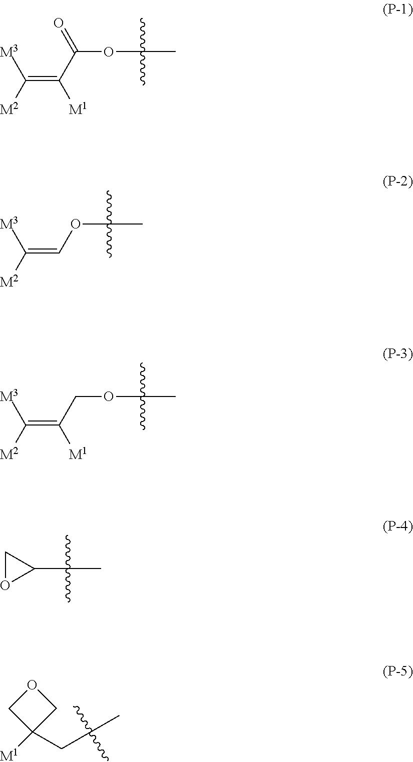
in Formula (P-1) to Formula (P-5), M¹, M², and M³ independently represent a hydrogen atom, a fluorine atom, an alkyl group having 1 to 5 carbon atoms, or an alkyl group having 1 to 5 carbon atoms in which at least one hydrogen atom is substituted with a fluorine atom or a chlorine atom.

17. The liquid crystal display element according to claim 1,
wherein at least one compound selected from the group of polymerizable compounds represented by Formula (4-1) to Formula (4-27) is contained as a second additive in the liquid crystal composition: 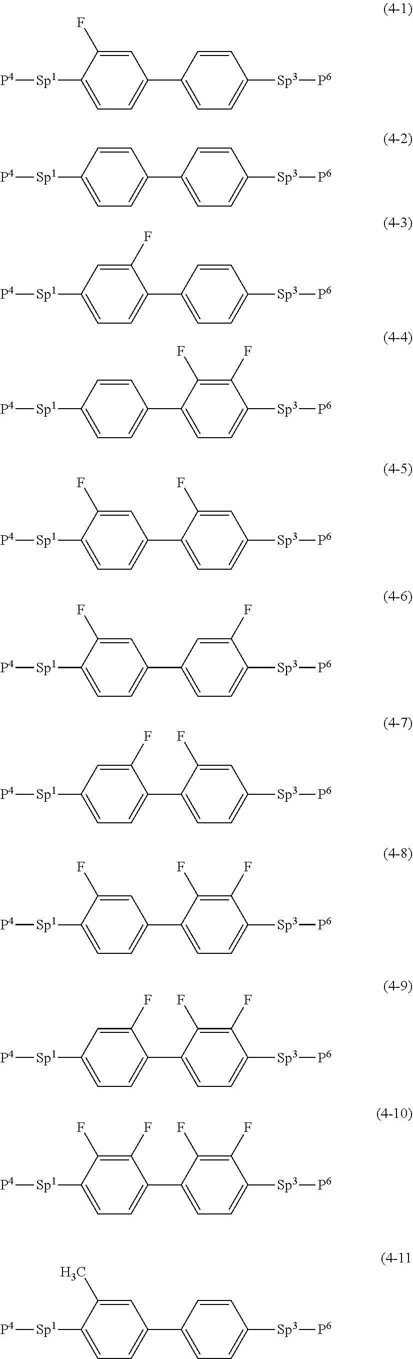 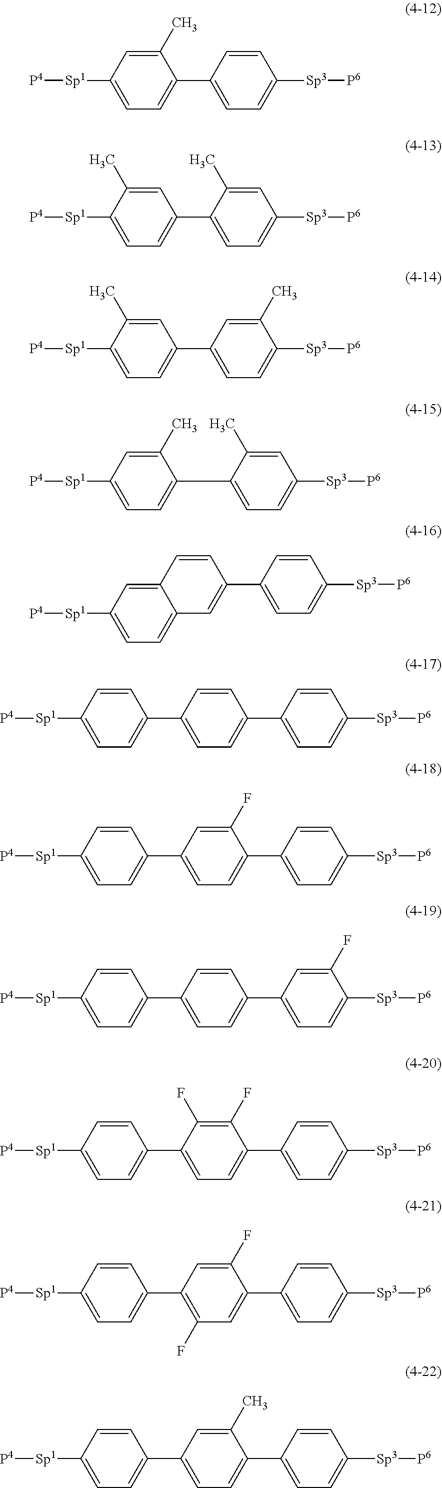 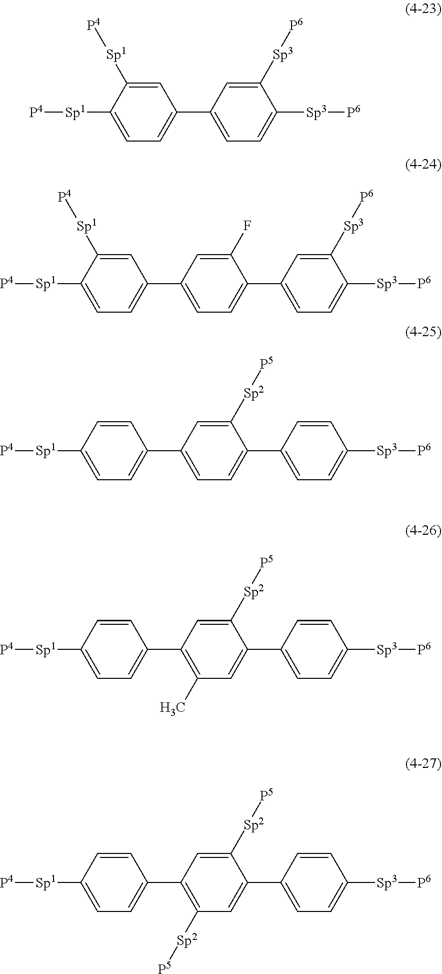
in Formula (4-1) to Formula (4-27), P⁴, P⁵, and P⁶ independently represent a group selected from the group of polymerizable groups represented by Formula (P-1) to Formula (P-3), 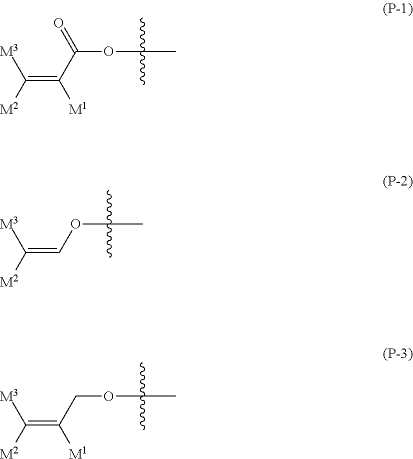
here, M¹, M², and M³ independently represent a hydrogen atom, a fluorine atom, an alkyl group having 1 to 5 carbon atoms, or an alkyl group having 1 to 5 carbon atoms in which at least one hydrogen atom is substituted with a fluorine atom or a chlorine atom; Sp¹, Sp², and Sp³ independently represent a single bond or an alkylene group having 1 to 10 carbon atoms, and in the alkylene group, at least one —CH₂— is optionally substituted with —O—, —COO—, —OCO—, or —OCOO—, at least one —CH₂CH₂— is optionally substituted with —CH═CH— or —C≡C—, and in these groups, at least one hydrogen atom is optionally substituted with a fluorine atom or a chlorine atom.

18. The liquid crystal display element according to claim 15,
wherein a proportion of the second additive in the liquid crystal composition is in a range of 0.03 parts by weight to 10 parts by weight when a total amount of the liquid crystalline compound is 100 parts by weight.

19. A liquid crystal display element in which the liquid crystal composition in the liquid crystal display element according to claim 1, and an electrode are provided between a pair of substrates, and when linearly polarized light is exposed, the alignment control monomer in the liquid crystal composition reacts.

20. The liquid crystal display element according to claim 1,
wherein an operation mode of the liquid crystal display element is a TN mode, an ECB mode, an OCB mode, an IPS mode, an FFS mode, or an FPA mode, and a drive method of the liquid crystal display element is an active matrix method.

21. The liquid crystal display element according to claim 1,
wherein an operation mode of the liquid crystal display element is an IPS mode or an FFS mode, and a drive method of the liquid crystal display element is an active matrix method.

22. (canceled)

23. A liquid crystal composition, which is the liquid composition in the liquid crystal display element according to claim 1.

24. (canceled)
